(19) United States
(12) Patent Application Publication
(10) Pub. No.: US 2026/0140346 A1
(43) Pub. Date: May 21, 2026

(54) IMAGING LENS AND IMAGING APPARATUS

(71) Applicant: FUJIFILM Corporation, Tokyo (JP)

(72) Inventors: Takuya TANAKA, Saitama-shi (JP); Shunsuke MIYAGISHIMA, Saitama-shi (JP)

(73) Assignee: FUJIFILM Corporation, Tokyo (JP)

(21) Appl. No.: 19/442,653

(22) Filed: Jan. 7, 2026

Related U.S. Application Data
(63) Continuation of application No. PCT/JP2024/020567, filed on Jun. 5, 2024.

(30) Foreign Application Priority Data
Jul. 12, 2023 (JP) 2023-114758

(51) Int. Cl. G02B 9/64

(52) U.S. Cl. CPC G02B 9/64

(57) ABSTRACT

An imaging lens consists of, in order from an object side to an image side, a first lens group having a positive refractive power, a second lens group, and a third lens group. During focusing, a spacing between the first lens group and the second lens group changes, and a spacing between the second lens group and the third lens group changes. The imaging lens satisfies a predetermined conditional expression.

### CROSS-REFERENCE TO RELATED APPLICATIONS

This application is a continuation application of International Application No. PCT/JP2024/020567, filed on Jun. 5, 2024, which claims priority from Japanese Patent Application No. 2023-114758, filed on Jul. 12, 2023. The entire disclosure of each of the above applications is incorporated herein by reference.

### BACKGROUND

### Technical Field

The technology of the present disclosure relates to an imaging lens and an imaging apparatus.

### Related Art

In the related art, an imaging lens that is usable in an imaging apparatus such as a digital camera is known as disclosed in JP2022-167114A.

### SUMMARY

There is a demand for an imaging lens that has a small F-number, that has a small size, and that maintains favorable optical performance. These requirement levels are increasing year by year.

An object of the present disclosure is to provide an imaging lens that has a small F-number, that has a small size, and that maintains favorable optical performance, and an imaging apparatus comprising the imaging lens.

According to one aspect of the present disclosure, there is provided an imaging lens consisting of, in order from an object side to an image side, a first lens group having a positive refractive power, a second lens group, and a third lens group, in which, during focusing, a spacing between the first lens group and the second lens group changes, and a spacing between the second lens group and the third lens group changes, and Conditional Expressions (1) and (2) are satisfied, which are represented by 2<FNo×(TL/f)<3.5 (1), and 0.45<TL/f<0.6 (2). Symbols in the above conditional expressions are defined as follows. An open F-number in a state where an infinite distance object is in focus is denoted by FNo. A sum of a distance on an optical axis from a lens surface of the first lens group closest to the object side to a lens surface of the third lens group closest to the image side and a back focal length of a whole system at an air conversion distance in a state where the infinite distance object is in focus is denoted by TL. A focal length of the whole system in a state where the infinite distance object is in focus is denoted by f.

In the following description, in the imaging lens according to the above aspect, a group consisting of a portion of the whole system that is closer to the object side than a maximum air spacing on the optical axis between lens surfaces of the whole system in a state where the infinite distance object is in focus is referred to as a front partial group.

It is preferable that an aperture stop is disposed closer to the image side than an intersection between a lens surface of the first lens group closest to the image side and the optical axis, and in a case where a length of the front partial group on the optical axis is denoted by dF, and a distance on the optical axis from the lens surface of the first lens group closest to the object side to the aperture stop in a state where the infinite distance object is in focus is denoted by dL1St, the imaging lens according to the above aspect satisfies Conditional Expression (3), which is represented by 0.05<dF/dL1St<0.28 (3).

It is preferable that in a case where a length of the front partial group on the optical axis is denoted by dF, and the maximum air spacing is denoted by dAmax, the imaging lens according to the above aspect satisfies Conditional Expression (4), which is represented by 0.1<dF/dAmax<0.99 (4).

It is preferable that in a case where a length of a lens closest to the object side in the first lens group on the optical axis is denoted by dL1, a length of the front partial group on the optical axis is denoted by dF, and a refractive index of the lens closest to the object side in the first lens group at a d line is denoted by NL1, the imaging lens according to the above aspect satisfies Conditional Expressions (5) and (6), which are represented by 0.15<dL1/dF<0.65 (5), and 1.41<NL1<2.01 (6).

It is preferable that in a case where a refractive index of a lens closest to the object side in the first lens group at a d line is denoted by NL1, an Abbe number of the lens closest to the object side in the first lens group based on the d line is denoted by νL1, and a partial dispersion ratio of the lens closest to the object side in the first lens group between a g line and an F line is denoted by θL1, the imaging lens according to the above aspect satisfies Conditional Expressions (7) and (8), which are represented by 1.85<NL1+0.01×νL1<2.5 (7), and

$$0.59 < θ L 1 + 0.0025 \times vL 1 < 0.79 . \qquad ( 8 )$$

It is preferable that in a case where a maximum half angle of view in a state where the infinite distance object is in focus is denoted by w, the imaging lens according to the above aspect satisfies Conditional Expression (9), which is represented by 6.5<TL/(f×tan ω)<20 (9).

It is preferable that in a case where a length of a lens closest to the object side in the first lens group on the optical axis is denoted by dL1, and a length of the front partial group on the optical axis is denoted by dF, the imaging lens according to the above aspect satisfies Conditional Expression (5-1), which is represented by 0.19<dL1/dF<0.31 (5-1).

It is preferable that in a case where a focal length of the first lens group is denoted by f1, the imaging lens according to the above aspect satisfies Conditional Expression (10), which is represented by 0.18<f1/f<1 (10).

It is preferable that in a case where a focal length of the second lens group is denoted by f2, the imaging lens according to the above aspect satisfies Conditional Expression (11), which is represented by 0.08<|f2/f|<0.5 (11).

It is preferable that in a case where a focal length of the third lens group is denoted by f3, the imaging lens according to the above aspect satisfies Conditional Expression (12), which is represented by 0.05<|f3/f|<1 (12).

It is preferable that in a case where a lateral magnification of the second lens group in a state where the infinite distance object is in focus is denoted by β2, and a lateral magnification of the third lens group in a state where the infinite distance object is in focus is denoted by β3, the imaging lens according to the above aspect satisfies Conditional Expression (13), which is represented by 2.5<|(1−β22)×β32|<10 (13).

It is preferable that in a case where an average of refractive indices of all lenses in the second lens group at a d line is denoted by N2ave, an average of Abbe numbers of all the lenses in the second lens group based on the d line is denoted by ν2ave, and an average of partial dispersion ratios of all the lenses in the second lens group between a g line and an F line is denoted by θ2ave, the imaging lens according to the above aspect satisfies Conditional Expressions (14) and (15), which are represented by 1.85<N2ave+0.01×ν2ave<2.7 (14), and 0.59<θ2ave+0.0025×ν2ave<0.79 (15).

It is preferable that in a configuration in which the third lens group includes a vibration-proof group that moves in a direction intersecting the optical axis during image shake correction, in a case where a focal length of the vibration-proof group is denoted by fIS, the imaging lens according to the above aspect satisfies Conditional Expression (16), which is represented by −0.13<fIS/f<−0.02 (16).

It is preferable that in a configuration in which the third lens group includes a vibration-proof group that moves in a direction intersecting the optical axis during image shake correction, in a case where a lateral magnification of the vibration-proof group in a state where the infinite distance object is in focus is denoted by βIS, and a combined lateral magnification of all lenses that are closer to the image side than the vibration-proof group in a state where the infinite distance object is in focus is denoted by βISR, the imaging lens according to the above aspect satisfies Conditional Expression (17), which is represented by 1.5<|(1−βIS)×βISR|<6 (17).

It is preferable that in a configuration in which the third lens group includes a vibration-proof group that moves in a direction intersecting the optical axis during image shake correction, and the vibration-proof group includes at least one negative lens, in a case where an average of refractive indices of all negative lenses in the vibration-proof group at a d line is denoted by NaveISn, an average of Abbe numbers of all the negative lenses in the vibration-proof group based on the d line is denoted by νaveISn, and an average of partial dispersion ratios of all the negative lenses in the vibration-proof group between a g line and an F line is denoted by θaveISn, the imaging lens according to the above aspect satisfies Conditional Expressions (18), (19), and (20), which are represented by 1.6<NaveISn<2.01 (18), 16<νaveISn<65 (19), and

$$0.49 < θ aveISn < 0.72 . \qquad ( 20 )$$

It is preferable that in a case where the back focal length of the whole system at the air conversion distance in a state where the infinite distance object is in focus is denoted by Bf, and a maximum half angle of view in a state where the infinite distance object is in focus is denoted by w, the imaging lens according to the above aspect satisfies Conditional Expression (21), which is represented by 1.2<Bf/(f×tan ω)<5 (21).

It is preferable that in a configuration in which the imaging lens includes an aperture stop, in a case where a distance on the optical axis from the lens surface of the first lens group closest to the object side to the aperture stop in a state where the infinite distance object is in focus is denoted by dL1St, the imaging lens according to the above aspect satisfies Conditional Expression (22), which is represented by 0.15<dL1St/f<0.45 (22).

It is preferable that in a case where a distance on the optical axis from the lens surface of the first lens group closest to the object side to a paraxial entrance pupil position in a state where the infinite distance object is in focus is denoted by dEnp, the imaging lens according to the above aspect satisfies Conditional Expression (23), which is represented by 0.3<dEnp/f<1.5 (23).

It is preferable that in a case where a distance on the optical axis from an image plane to a paraxial exit pupil position in a state where the infinite distance object is in focus is denoted by dExp, the imaging lens according to the above aspect satisfies Conditional Expression (24), which is represented by −0.5<dExp/f<−0.1 (24). Note that a sign of dExp is defined with the image plane as a reference such that a distance on the image side is positive and a distance on the object side is negative. In addition, dExp is calculated using the air conversion distance for an optical member having no refractive power in a case where the optical member is disposed between the image plane and the paraxial exit pupil position.

It is preferable that in a case where a length of the front partial group on the optical axis is denoted by dF, and a focal length of the first lens group is denoted by f1, the imaging lens according to the above aspect satisfies Conditional Expression (25), which is represented by

$$0.02 < dF / f 1 < 0.24 . \qquad ( 25 )$$

It is preferable that in a configuration in which the imaging lens includes an aperture stop, the third lens group includes a vibration-proof group that moves in a direction intersecting the optical axis during image shake correction, in a case where a length of the vibration-proof group on the optical axis is denoted by dIS, and a distance on the optical axis from the aperture stop to the lens surface of the third lens group closest to the image side in a state where the infinite distance object is in focus is denoted by dStG3r, the imaging lens according to the above aspect satisfies Conditional Expression (26), which is represented by 0.04<dIS/dStG3r<0.45 (26).

The second lens group may be configured to have a negative refractive power. Alternatively, the second lens group may be configured to have a positive refractive power.

It is preferable that the front partial group consists of two positive lenses.

It is preferable that the number of positive lenses included in the first lens group is four or less.

It is preferable that the first lens group includes, successively in order from a position closest to the object side to the image side, a positive lens, a positive lens, a positive lens, and a negative lens.

It is preferable that the third lens group has a negative refractive power.

It is preferable that in a configuration in which the third lens group includes a vibration-proof group that moves in a direction intersecting the optical axis during image shake correction and at least one negative lens disposed closer to the image side than the vibration-proof group, in a case where an Abbe number of the negative lens disposed closer to the image side than the vibration-proof group based on a d line is denoted by νISRn, and a partial dispersion ratio of the negative lens disposed closer to the image side than the vibration-proof group between a g line and an F line is denoted by θISRn, the imaging lens according to the above aspect includes at least one negative lens that satisfies Conditional Expressions (27) and (28), which are represented by 60<νISRn<96 (27), and 0.69<θISRn<0.79 (28).

It is preferable that in a configuration in which the third lens group includes a vibration-proof group that moves in a direction intersecting the optical axis during image shake correction and a plurality of negative lenses disposed closer to the image side than the vibration-proof group, in a case where an average of refractive indices of all negative lenses disposed closer to the image side than the vibration-proof group at a d line is denoted by NaveISRN, an average of Abbe numbers of all the negative lenses disposed closer to the image side than the vibration-proof group based on the d line is denoted by νaveISRn, and an average of partial dispersion ratios of all the negative lenses disposed closer to the image side than the vibration-proof group between a g line and an F line is denoted by θaveISRn, the imaging lens according to the above aspect satisfies Conditional Expressions (29), (30), and (31), which are represented by 1.49<NaveISRn<1.8 (29), 45<νaveISRn<75 (30), and 0.5<θaveISRn<0.6 (31).

It is preferable that the third lens group includes a vibration-proof group that moves in a direction intersecting the optical axis during image shake correction, and the third lens group includes two or more cemented lenses each configured by cementing a positive lens and a negative lens in order from the object side, the cemented lenses being disposed closer to the image side than the vibration-proof group.

It is preferable that in a case where an average of specific gravities of all lenses in the second lens group is denoted by SG2, the imaging lens according to the above aspect satisfies Conditional Expression (32), which is represented by 2.7<SG2<4.5 (32).

It is preferable that in a configuration in which the third lens group includes a vibration-proof group that moves in a direction intersecting the optical axis during image shake correction, the vibration-proof group includes at least one negative lens, in a case where an average of specific gravities of all negative lenses in the vibration-proof group is denoted by SGISn, the imaging lens according to the above aspect satisfies Conditional Expression (33), which is represented by 3.4<SGISn<4.7 (33).

It is preferable that in a configuration in which the third lens group includes an aspherical lens, in a case where a paraxial curvature radius of a surface of the aspherical lens on the object side is denoted by Rcf, a paraxial curvature radius of a surface of the aspherical lens on the image side is denoted by Rcr, a curvature radius at a position of a maximum effective diameter of the surface of the aspherical lens on the object side is denoted by Ryf, and a curvature radius at a position of a maximum effective diameter of the surface of the aspherical lens on the image side is denoted by Ryr, the imaging lens according to the above aspect satisfies Conditional Expression (34), which is represented by 0.65<|(1/Rcf−1/Rcr)/(1/Ryf−1/Ryr)|<1.35 (34).

According to another aspect of the present disclosure, there is provided an imaging apparatus comprising the imaging lens according to the above aspect.

The expressions “consists of” and “consisting of” in the present specification indicate that a lens substantially not having a refractive power, an optical element other than a lens, such as a stop, a filter, and a cover glass, a mechanism part such as a lens flange, a lens barrel, an imaging element, and a camera shake correction mechanism, and the like may be included in addition to the illustrated constituents.

The expressions “group has a positive refractive power” and “group having a positive refractive power” in the present specification mean that the group as a whole has a positive refractive power. Similarly, the expressions “group has a negative refractive power” and “group having a negative refractive power” mean that the group as a whole has a negative refractive power. The terms “first lens group”, “second lens group”, “third lens group”, “front partial group”, “focusing group”, and “vibration-proof group” in the present specification are not limited to a configuration consisting of a plurality of lenses and may have a configuration consisting of only one lens.

A compound aspherical lens (a lens in which a lens (for example, a spherical lens) and a film of an aspherical shape formed on the lens are integrally formed and that functions as one aspherical lens as a whole) is not regarded as a cemented lens and is regarded as one lens. Unless otherwise noted, a sign of a refractive power and a surface shape related to a lens including an aspherical surface in a paraxial region are used. A sign of the curvature radius is defined such that a sign of the curvature radius of a surface having a convex shape facing the object side is positive, and a sign of the curvature radius of a surface having a convex shape facing the image side is negative.

The term “whole system” in the present specification means the imaging lens. The term “focal length” used in the conditional expressions means a paraxial focal length. Unless otherwise noted, the expression “distance on the optical axis” used in the conditional expressions means a geometrical distance. Unless otherwise noted, values used in the conditional expressions are values based on the d line in a state where the infinite distance object is in focus.

According to the present disclosure, it is possible to provide an imaging lens that has a small F-number, that has a small size, and that maintains favorable optical performance, and an imaging apparatus comprising the imaging lens.

### BRIEF DESCRIPTION OF THE DRAWINGS

FIG. 1 is a cross-sectional view showing a configuration of an imaging lens according to an embodiment, which corresponds to an imaging lens of Example 1.

FIG. 2 is a cross-sectional view showing a configuration and a luminous flux of the imaging lens of Example 1, and is a diagram for describing symbols of conditional expressions.

FIG. 3 is a diagram for describing a position of a maximum effective diameter.

FIG. 4 is a diagram of aberrations of the imaging lens of Example 1.

FIG. 5 is a cross-sectional view showing a configuration of an imaging lens of Example 2.

FIG. 6 is a diagram of aberrations of the imaging lens of Example 2.

FIG. 7 is a cross-sectional view showing a configuration of an imaging lens of Example 3.

FIG. 8 is a diagram of aberrations of the imaging lens of Example 3.

FIG. 9 is a cross-sectional view showing a configuration of an imaging lens of Example 4.

FIG. 10 is a diagram of aberrations of the imaging lens of Example 4.

FIG. 11 is a cross-sectional view showing a configuration of an imaging lens of Example 5.

FIG. 12 is a diagram of aberrations of the imaging lens of Example 5.

FIG. 13 is a cross-sectional view showing a configuration of an imaging lens of Example 6.

FIG. 14 is a diagram of aberrations of the imaging lens of Example 6.

FIG. 15 is a cross-sectional view showing a configuration of an imaging lens of Example 7.

FIG. 16 is a diagram of aberrations of the imaging lens of Example 7.

FIG. 17 is a cross-sectional view showing a configuration of an imaging lens of Example 8.

FIG. 18 is a diagram of aberrations of the imaging lens of Example 8.

FIG. 19 is a cross-sectional view showing a configuration of an imaging lens of Example 9.

FIG. 20 is a diagram of aberrations of the imaging lens of Example 9.

FIG. 21 is a cross-sectional view showing a configuration of an imaging lens of Example 10.

FIG. 22 is a diagram of aberrations of the imaging lens of Example 10.

FIG. 23 is a cross-sectional view showing a configuration of an imaging lens of Example 11.

FIG. 24 is a diagram of aberrations of the imaging lens of Example 11.

FIG. 25 is a cross-sectional view showing a configuration of an imaging lens of Example 12.

FIG. 26 is a diagram of aberrations of the imaging lens of Example 12.

FIG. 27 is a cross-sectional view showing a configuration of an imaging lens of Example 13.

FIG. 28 is a diagram of aberrations of the imaging lens of Example 13.

FIG. 29 is a cross-sectional view showing a configuration of an imaging lens of Example 14.

FIG. 30 is a diagram of aberrations of the imaging lens of Example 14.

FIG. 31 is a cross-sectional view showing a configuration of an imaging lens of Example 15.

FIG. 32 is a diagram of aberrations of the imaging lens of Example 15.

FIG. 33 is a cross-sectional view showing a configuration of an imaging lens of Example 16.

FIG. 34 is a diagram of aberrations of the imaging lens of Example 16.

FIG. 35 is a cross-sectional view showing a configuration of an imaging lens of Example 17.

FIG. 36 is a diagram of aberrations of the imaging lens of Example 17.

FIG. 37 is a perspective view of an imaging apparatus according to an embodiment as seen from a front side.

FIG. 38 is a perspective view of the imaging apparatus according to the embodiment as seen from a rear side.

### DETAILED DESCRIPTION

Hereinafter, an embodiment of the present disclosure will be described with reference to the drawings.

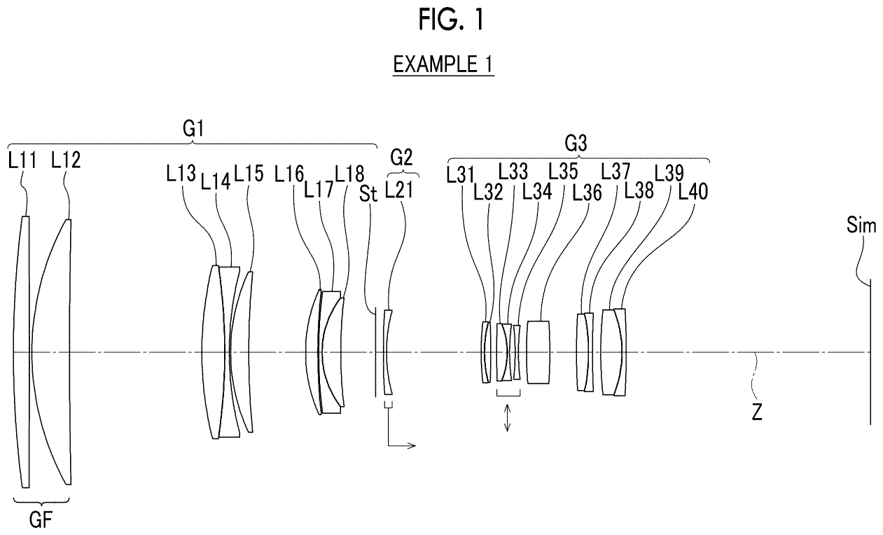

FIG. 1 shows a cross-sectional view of a configuration of an imaging lens according to an embodiment of the present disclosure. FIG. 1 shows a state where an infinite distance object is in focus, in which the left side thereof is an object side, and the right side thereof is an image side. In the present specification, an object at a distance of infinity is referred to as the infinite distance object. The example shown in FIG. 1 corresponds to an imaging lens of Example 1 to be described below.

The imaging lens of the present disclosure consists of, in order from the object side to the image side along an optical axis Z, a first lens group G1 having a positive refractive power, a second lens group G2, and a third lens group G3. By setting the sign of the refractive power of the first lens group G1 to be positive, a lens group that is closer to the image side than the first lens group G1 can be reduced in diameter, which is advantageous for reducing the whole system in size and weight.

As an example, each lens group of the imaging lens in FIG. 1 is configured as follows. The first lens group G1 consists of eight lenses L11 to L18 and an aperture stop St, in order from the object side to the image side. The second lens group G2 consists of one lens, that is, a lens L21. The third lens group G3 consists of, in order from the object side to the image side, 10 lenses, that is, lenses L31 to L40. The aperture stop St in FIG. 1 does not indicate a size or a shape, but indicates a position in an optical axis direction.

In the imaging lens of the present disclosure, during focusing, a spacing between the first lens group G1 and the second lens group G2 changes, and a spacing between the second lens group G2 and the third lens group G3 changes. In the example of FIG. 1, during focusing, the second lens group G2 moves, and the first lens group G1 and the third lens group G3 remain stationary with respect to an image plane Sim. In the present specification, a group that moves during focusing is referred to as a focusing group. In the example in FIG. 1, the focusing group consists of the second lens group G2. The parentheses and the right-pointing arrow below the second lens group G2 in FIG. 1 indicate that the focusing group is the second lens group G2 and that the focusing group moves to the image side during focusing from the infinite distance object to a nearest object.

It is preferable that the imaging lens of the present disclosure includes a vibration-proof group in addition to the focusing group. In the present specification, a group that moves in a direction intersecting the optical axis Z during image shake correction is referred to as a vibration-proof group. In the example in FIG. 1, the vibration-proof group consists of three lenses, that is, the lenses L33 to L35. The parentheses and the double arrows pointing up and down below the lenses L33 to L35 in FIG. 1 indicate that the lenses L33 to L35 constitute the vibration-proof group. As in the example of FIG. 1, the vibration-proof group may be included in the third lens group G3. This is advantageous for reducing a diameter of the vibration-proof group.

The first lens group G1 may include, successively in order from a position closest to the object side to the image side, a positive lens, a positive lens, a positive lens, and a negative lens. This is advantageous for appropriately correcting spherical aberration and axial chromatic aberration.

The number of positive lenses included in the first lens group G1 may be four or less. This is advantageous for achieving both weight reduction and appropriate correction of spherical aberration and axial chromatic aberration.

In the example of FIG. 1, among air spacings on the optical axis in the imaging lens, the maximum air spacing exists in the first lens group G1. Hereinafter, a group consisting of lenses that are closer to the object side than the maximum air spacing is referred to as a front partial group GF. That is, a group consisting of a portion of the whole system that is closer to the object side than the maximum air spacing on the optical axis between lens surfaces of the whole system in a state where the infinite distance object is in focus is referred to as the front partial group GF. In the example of FIG. 1, an air spacing between the lens L12 and the lens L13 corresponds to the maximum air spacing, and a group consisting of the lens L11 and the lens L12 corresponds to the front partial group GF.

The front partial group GF may consist of two positive lenses. This is advantageous for achieving both weight reduction and appropriate correction of spherical aberration and axial chromatic aberration.

The second lens group G2 may be configured to have a negative refractive power. In a case where the refractive power of the second lens group G2 is made negative, the refractive index of the material tends to be high, making it easier to increase the absolute value of the curvature radius, which is advantageous for weight reduction. Alternatively, the second lens group G2 may be configured to have a positive refractive power. In a case where the refractive power of the second lens group G2 is made positive, the refractive index of the material tends to be low and the Abbe number tends to be large, which is advantageous for reducing fluctuations in chromatic aberration during focusing.

The second lens group G2 may consist of one lens. This is advantageous for reducing the size and weight. In particular, in a case where the focusing group consists of the second lens group G2 and the second lens group G2 consists of one lens, this is advantageous for reducing the focusing group in size and weight, so that it is advantageous for increasing the speed of autofocus.

The third lens group G3 may be configured to have a negative refractive power. By making the refractive power of the third lens group G3 negative, the first lens group G1 can have a moderately strong positive refractive power, which is advantageous for size reduction.

The third lens group G3 may include a vibration-proof group and may further include two or more cemented lenses each configured by cementing a positive lens and a negative lens in order from the object side, the cemented lenses being disposed closer to the image side than the vibration-proof group. This is advantageous for correcting chromatic aberration while suppressing field curvature.

The third lens group G3 may include at least one aspherical lens. This is advantageous for correcting various aberrations.

The aperture stop St may be disposed closer to the image side than an intersection between a lens surface of the first lens group G1 closest to the image side and the optical axis Z. This is advantageous for reducing the size of the whole system.

Hereinafter, preferred configurations of the imaging lens of the present disclosure related to conditional expressions will be described. In the following description of the conditional expressions, in order to avoid redundancy, the same symbol is used for the same definition, and the duplicate description of the symbol is omitted. In addition, in the following description of the conditional expressions, in order to avoid redundancy, the “imaging lens of the present disclosure” is simply referred to as an “imaging lens”.

The imaging lens preferably satisfies Conditional Expression (1). Here, an open F-number in a state where the infinite distance object is in focus is denoted by FNo. A back focal length of the whole system as an air conversion distance in a state where the infinite distance object is in focus is denoted by Bf. A sum of a distance on the optical axis from a lens surface of the first lens group G1 closest to the object side to a lens surface of the third lens group G3 closest to the image side and the back focal length Bf in a state where the infinite distance object is in focus is denoted by TL. A focal length of the whole system in a state where the infinite distance object is in focus is denoted by f. By not allowing the corresponding value of Conditional Expression (1) to be equal to or less than a lower limit value thereof, there is an advantage in suppressing various aberrations. By not allowing the corresponding value of Conditional Expression (1) to be equal to or greater than an upper limit value thereof, there is an advantage in reducing the total length while reducing the F-number.

$$2 < FNo \times ( TL / f ) < 3.5 \qquad ( 1 )$$

In order to obtain more favorable characteristics, the lower limit value of Conditional Expression (1) is more preferably set to 2.1, still more preferably set to 2.2, and still more preferably set to 2.3. The upper limit value of Conditional Expression (1) is more preferably set to 3.45, still more preferably set to 3.4, still more preferably set to 3.35, still more preferably set to 3.3, and still more preferably set to 3.25.

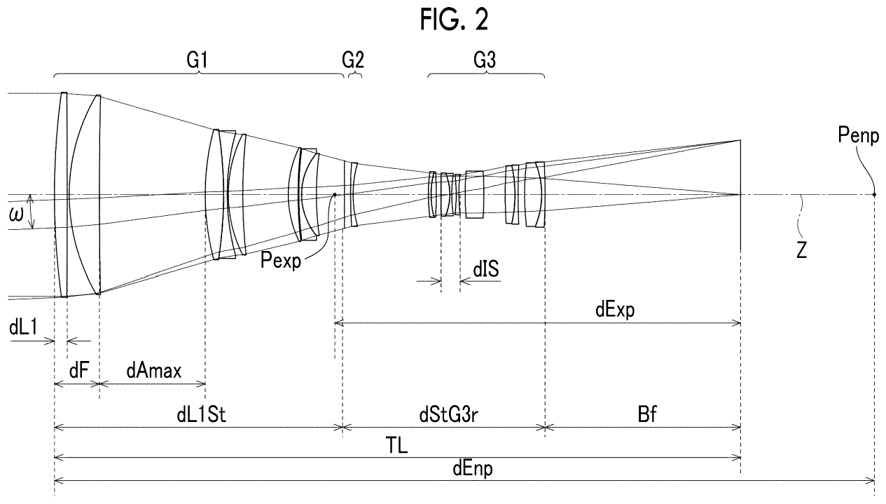

TL is the optical total length in a state where the infinite distance object is in focus. As an example, FIG. 2 shows the back focal length Bf and the optical total length TL in the imaging lens of FIG. 1. FIG. 2 shows the configuration of the imaging lens of FIG. 1 in a state where the infinite distance object is in focus, and also shows an on-axis luminous flux and a luminous flux of a maximum half angle of view w.

The imaging lens preferably satisfies Conditional Expression (2). By not allowing the corresponding value of Conditional Expression (2) to be equal to or less than a lower limit value thereof, there is an advantage in suppressing various aberrations. By not allowing the corresponding value of Conditional Expression (2) to be equal to or greater than an upper limit value thereof, there is an advantage in reducing the total length.

$$0.45 < TL / f < 0.6 \qquad ( 2 )$$

In order to obtain more favorable characteristics, the lower limit value of Conditional Expression (2) is more preferably set to 0.46, still more preferably set to 0.47, still more preferably set to 0.48, still more preferably set to 0.49, and still more preferably set to 0.5. The upper limit value of Conditional Expression (2) is more preferably set to 0.59, still more preferably set to 0.58, still more preferably set to 0.57, and still more preferably set to 0.56.

In a configuration in which the aperture stop St is disposed closer to the image side than the intersection between the lens surface of the first lens group G1 closest to the image side and the optical axis Z, the imaging lens preferably satisfies Conditional Expression (3). Here, a length of the front partial group GF on the optical axis is denoted by dF. A distance on the optical axis from the lens surface of the first lens group G1 closest to the object side to the aperture stop St in a state where the infinite distance object is in focus is denoted by dL1St. The “length of the group on the optical axis” refers to a distance on the optical axis from a surface of the group closest to the object side to a surface of the group closest to the image side, and the same applies to groups other than the front partial group GF. As an example, FIG. 2 shows the length dF and the distance dL1St in the imaging lens of FIG. 1. By not allowing the corresponding value of Conditional Expression (3) to be equal to or less than a lower limit value thereof, the refractive power of the front partial group GF is prevented from becoming excessively strong, which is advantageous for suppressing spherical aberration and axial chromatic aberration. By not allowing the corresponding value of Conditional Expression (3) to be equal to or greater than an upper limit value thereof, the number of lenses having a large diameter can be reduced, which is advantageous for reducing the whole system in size and weight.

$$0.05 < dF / dL 1 St < 0.28 \qquad ( 3 )$$

In order to obtain more favorable characteristics, the lower limit value of Conditional Expression (3) is more preferably set to 0.06, still more preferably set to 0.07, still more preferably set to 0.08, and still more preferably set to 0.09. The upper limit value of Conditional Expression (3) is more preferably set to 0.25, still more preferably set to 0.22, still more preferably set to 0.2, still more preferably set to 0.18, and still more preferably set to 0.16.

The imaging lens preferably satisfies Conditional Expression (4). Here, the maximum air spacing on the optical axis between lens surfaces of the whole system in a state where the infinite distance object is in focus is denoted by dAmax. As an example, FIG. 2 shows the maximum air spacing dAmax in the imaging lens of FIG. 1. By not allowing the corresponding value of Conditional Expression (4) to be equal to or less than a lower limit value thereof, the refractive power of the front partial group GF is prevented from becoming excessively strong, which is advantageous for suppressing spherical aberration and axial chromatic aberration. By not allowing the corresponding value of Conditional Expression (4) to be equal to or greater than an upper limit value thereof, the number of lenses having a large diameter can be reduced, which is advantageous for reducing the whole system in size and weight and is also advantageous for reducing the size of a group that is closer to the image side than the front partial group GF.

$$0.1 < dF / dA max < 0.99 \qquad ( 4 )$$

In order to obtain more favorable characteristics, the lower limit value of Conditional Expression (4) is more preferably set to 0.11, still more preferably set to 0.12, still more preferably set to 0.13, still more preferably set to 0.14, and still more preferably set to 0.15. The upper limit value of Conditional Expression (4) is more preferably set to 0.84, still more preferably set to 0.69, still more preferably set to 0.59, still more preferably set to 0.49, and still more preferably set to 0.44.

The imaging lens preferably satisfies Conditional Expression (5). Here, a length of a lens closest to the object side in the first lens group G1 on the optical axis is denoted by dL1. As an example, FIG. 2 shows the length dL1 in the imaging lens of FIG. 1. By not allowing the corresponding value of Conditional Expression (5) to be equal to or less than a lower limit value thereof, it is possible to suppress overcorrection of spherical aberration. By not allowing the corresponding value of Conditional Expression (5) to be equal to or greater than an upper limit value thereof, there is an advantage in reducing the weight of the lens closest to the object side in the first lens group G1 and reducing the weight of the whole system.

$$0.15 < dL 1 / dF < 0.65 \qquad ( 5 )$$

In order to obtain more favorable characteristics, the lower limit value of Conditional Expression (5) is more preferably set to 0.17, still more preferably set to 0.19, still more preferably set to 0.21, and still more preferably set to 0.23. The upper limit value of Conditional Expression (5) is more preferably set to 0.55, still more preferably set to 0.44, still more preferably set to 0.39, still more preferably set to 0.35, still more preferably set to 0.31, still more preferably set to 0.3, and still more preferably set to 0.29. For example, the imaging lens more preferably satisfies Conditional Expression (5-1).

$$0.19 < dL 1 / dF < 0.31 \qquad ( 5 - 1 )$$

The imaging lens preferably satisfies Conditional Expression (6). Here, a refractive index of the lens closest to the object side in the first lens group G1 at a d line is denoted by NL1. By not allowing the corresponding value of Conditional Expression (6) to be equal to or less than a lower limit value thereof, there is an advantage in reducing the weight of the lens closest to the object side in the first lens group G1 and reducing the weight of the whole system. By not allowing the corresponding value of Conditional Expression (6) to be equal to or greater than an upper limit value thereof, it is possible to suppress overcorrection of spherical aberration.

$$1.41 < NL 1 < 2.01 \qquad ( 6 )$$

In order to obtain more favorable characteristics, the lower limit value of Conditional Expression (6) is more preferably set to 1.49, still more preferably set to 1.56, still more preferably set to 1.59, and still more preferably set to 1.62. The upper limit value of Conditional Expression (6) is more preferably set to 1.91, still more preferably set to 1.86, still more preferably set to 1.81, and still more preferably set to 1.77.

The imaging lens more preferably satisfies Conditional Expressions (5) and (6) simultaneously. By satisfying Conditional Expressions (5) and (6) simultaneously, it is easy to reduce the weight of the lens closest to the object side in the first lens group G1 and reduce the weight of the whole system while appropriately correcting spherical aberration.

The imaging lens preferably satisfies Conditional Expression (7). Here, an Abbe number of the lens closest to the object side in the first lens group G1 based on the d line is denoted by νL1. By not allowing the corresponding value of Conditional Expression (7) to be equal to or less than a lower limit value thereof, it is possible to suppress undercorrection of spherical aberration. By not allowing the corresponding value of Conditional Expression (7) to be equal to or greater than an upper limit value thereof, there is an advantage in reducing the weight of the lens closest to the object side in the first lens group G1 and reducing the weight of the whole system while appropriately correcting spherical aberration and axial chromatic aberration.

$$1.85 < NL 1 + 0.01 \times vL 1 < 2.5 \qquad ( 7 )$$

In order to obtain more favorable characteristics, the lower limit value of Conditional Expression (7) is more preferably set to 1.9 and still more preferably set to 1.95. The upper limit value of Conditional Expression (7) is more preferably set to 2.35, still more preferably set to 2.21, still more preferably set to 2.09, and still more preferably set to 2.02.

The imaging lens preferably satisfies Conditional Expression (8). Here, a partial dispersion ratio of the lens closest to the object side in the first lens group G1 between a g line and an F line is denoted by θL1. By not allowing the corresponding value of Conditional Expression (8) to be equal to or less than a lower limit value thereof, there is an advantage in correcting axial chromatic aberration. By not allowing the corresponding value of Conditional Expression (8) to be equal to or greater than an upper limit value thereof, it is possible to suppress overcorrection of axial chromatic aberration.

$$0.59 < θ L 1 + 0.0025 \times vL 1 < 0.79 \qquad ( 8 )$$

In a case where refractive indexes of a certain lens with respect to the g line, the F line, and a C line are denoted by Ng, NF, and NC, respectively, and a partial dispersion ratio of the lens between the g line and the F line is denoted by θgF, θgF is defined as the following expression.

$$θ g F = ( N g - N F ) / ( N F - N C )$$

The terms “d line”, “C line”, “F line”, and “g line” described in the present specification mean emission lines, in which a wavelength of the d line is 587.56 nanometers (nm), a wavelength of the C line is 656.27 nanometers (nm), a wavelength of the F line is 486.13 nanometers (nm), and a wavelength of the g line is 435.84 nanometers (nm).

In order to obtain more favorable characteristics, the lower limit value of Conditional Expression (8) is more preferably set to 0.62 and still more preferably set to 0.65. The upper limit value of Conditional Expression (8) is more preferably set to 0.76, still more preferably set to 0.73, still more preferably set to 0.71, and still more preferably set to 0.69.

The imaging lens more preferably satisfies Conditional Expressions (7) and (8) simultaneously. By satisfying Conditional Expressions (7) and (8) simultaneously, it is easy to reduce the weight of the lens closest to the object side in the first lens group G1 and reduce the weight of the whole system while appropriately correcting spherical aberration and axial chromatic aberration.

The imaging lens preferably satisfies Conditional Expression (9). Here, the maximum half angle of view in a state where the infinite distance object is in focus is denoted by ω. As an example, FIG. 2 shows the maximum half angle of view w in the imaging lens of FIG. 1. In Conditional Expression (9), tan is a tangent, and the same applies to other conditional expressions. By not allowing the corresponding value of Conditional Expression (9) to be equal to or less than a lower limit value thereof, the on-axis luminous flux can be gradually converged toward the image plane Sim, which is advantageous for suppressing axial chromatic aberration that occurs in a case of converging the luminous flux. By not allowing the corresponding value of Conditional Expression (9) to be equal to or greater than an upper limit value thereof, there is an advantage in shortening the total length.

$$6.5 < TL / ( f \times tan ω ) < 20 \qquad ( 9 )$$

In order to obtain more favorable characteristics, the lower limit value of Conditional Expression (9) is more preferably set to 7 and still more preferably set to 7.5. The upper limit value of Conditional Expression (9) is more preferably set to 16.5, still more preferably set to 13, still more preferably set to 12, still more preferably set to 11, and still more preferably set to 10.

In a case where a focal length of the first lens group G1 is denoted by f1, the imaging lens preferably satisfies Conditional Expression (10). By not allowing the corresponding value of Conditional Expression (10) to be equal to or less than a lower limit value thereof, the refractive power of the first lens group G1 is prevented from becoming excessively strong, which is advantageous for suppressing aberrations. By not allowing the corresponding value of Conditional Expression (10) to be equal to or greater than an upper limit value thereof, the refractive power of the first lens group G1 is prevented from becoming excessively weak, which is advantageous for size reduction.

$$0.18 < f 1 / f < 1 \qquad ( 10 )$$

In order to obtain more favorable characteristics, the lower limit value of Conditional Expression (10) is more preferably set to 0.21, still more preferably set to 0.24, still more preferably set to 0.27, and still more preferably set to 0.3. The upper limit value of Conditional Expression (10) is more preferably set to 0.85, still more preferably set to 0.7, still more preferably set to 0.55, and still more preferably set to 0.4.

In a case where a focal length of the second lens group G2 is denoted by f2, the imaging lens preferably satisfies Conditional Expression (11). By not allowing the corresponding value of Conditional Expression (11) to be equal to or less than a lower limit value thereof, the refractive power of the second lens group G2 is prevented from becoming excessively strong, which is advantageous for suppressing aberrations. By not allowing the corresponding value of Conditional Expression (11) to be equal to or greater than an upper limit value thereof, the refractive power of the second lens group G2 is prevented from becoming excessively weak, and the amount of movement of the second lens group G2 during focusing can be reduced, which is advantageous for size reduction.

$$0.08 < \vert f 2 / f \vert < 0. 5 \qquad ( 11 )$$

In order to obtain more favorable characteristics, the lower limit value of Conditional Expression (11) is more preferably set to 0.11, still more preferably set to 0.14, and still more preferably set to 0.17. The upper limit value of Conditional Expression (11) is more preferably set to 0.47, still more preferably set to 0.44, still more preferably set to 0.41, and still more preferably set to 0.38.

In a case where a focal length of the third lens group G3 is denoted by f3, the imaging lens preferably satisfies Conditional Expression (12). By not allowing the corresponding value of Conditional Expression (12) to be equal to or less than a lower limit value thereof, the refractive power of the third lens group G3 is prevented from becoming excessively strong, which is advantageous for suppressing aberrations. By not allowing the corresponding value of Conditional Expression (12) to be equal to or greater than an upper limit value thereof, the refractive power of the third lens group G3 is prevented from becoming excessively weak, which is advantageous for size reduction.

$$0.05 < \vert f 3 / f \vert < 1 \qquad ( 12 )$$

In order to obtain more favorable characteristics, the lower limit value of Conditional Expression (12) is more preferably set to 0.1 and still more preferably set to 0.15. The upper limit value of Conditional Expression (12) is more preferably set to 0.9, still more preferably set to 0.8, still more preferably set to 0.71, and still more preferably set to 0.6.

The imaging lens preferably satisfies Conditional Expression (13). Here, a lateral magnification of the second lens group G2 in a state where the infinite distance object is in focus is denoted by β2. A lateral magnification of the third lens group G3 in a state where the infinite distance object is in focus is denoted by β3. By not allowing the corresponding value of Conditional Expression (13) to be equal to or less than a lower limit value thereof, a ratio of the amount of movement of the image plane position to the unit amount of movement of the focusing group is prevented from becoming excessively small, and thus the amount of movement of the focusing group during focusing is prevented from becoming excessively large. As a result, it is advantageous for achieving both high performance and size reduction. By not allowing the corresponding value of Conditional Expression (13) to be equal to or greater than an upper limit value thereof, the ratio of the amount of movement of the image plane position to the unit amount of movement of the focusing group is prevented from becoming excessively large, which is advantageous for achieving both manufacturing suitability and size reduction.

$$2.5 < \vert ( 1 - {β2}^{2} ) \times β {3}^{2} \vert < 10 \qquad ( 13 )$$

In order to obtain more favorable characteristics, the lower limit value of Conditional Expression (13) is more preferably set to 3, still more preferably set to 3.5, still more preferably set to 4, and still more preferably set to 4.5. The upper limit value of Conditional Expression (13) is more preferably set to 9.5, still more preferably set to 9, and still more preferably set to 8.5.

The imaging lens preferably satisfies Conditional Expression (14). Here, an average of refractive indices of all lenses in the second lens group G2 at the d line is denoted by N2ave. An average of Abbe numbers of all the lenses in the second lens group G2 based on the d line is denoted by ν2ave. By not allowing the corresponding value of Conditional Expression (14) to be equal to or less than a lower limit value thereof, the refractive power of the second lens group G2 is prevented from becoming excessively weak, and thus the amount of movement of the second lens group G2 during focusing is prevented from becoming excessively large, which is advantageous for size reduction. By not allowing the corresponding value of Conditional Expression (14) to be equal to or greater than an upper limit value thereof, the refractive power of the second lens group G2 is prevented from becoming excessively strong, which is advantageous for suppressing fluctuations in aberration during focusing.

$$1.85 < N 2 a v e + 0.01 \times v 2 a v e < 2.7 \qquad ( 14 )$$

In order to obtain more favorable characteristics, the lower limit value of Conditional Expression (14) is more preferably set to 1.9, still more preferably set to 1.95, and still more preferably set to 2. The upper limit value of Conditional Expression (14) is more preferably set to 2.6, still more preferably set to 2.5, and still more preferably set to 2.4.

The imaging lens preferably satisfies Conditional Expression (15). Here, an average of partial dispersion ratios of all the lenses in the second lens group G2 between the g line and the F line is denoted by θ2ave. By satisfying Conditional Expression (15), there is an advantage in suppressing fluctuations in chromatic aberration during focusing.

$$0.59 < θ2ave + 0.0025 \times v 2 a v e < 0.79 \qquad ( 15 )$$

In order to obtain more favorable characteristics, the lower limit value of Conditional Expression (15) is more preferably set to 0.62 and still more preferably set to 0.65. The upper limit value of Conditional Expression (15) is more preferably set to 0.76, still more preferably set to 0.73, still more preferably set to 0.71, and still more preferably set to 0.69.

The imaging lens more preferably satisfies Conditional Expressions (14) and (15) simultaneously. Satisfying Conditional Expressions (14) and (15) simultaneously is advantageous for suppressing fluctuations in aberration during focusing and reducing the size of the whole system.

In a configuration in which the third lens group G3 includes a vibration-proof group, the imaging lens preferably satisfies Conditional Expression (16). Here, a focal length of the vibration-proof group is denoted by fIS. By not allowing the corresponding value of Conditional Expression (16) to be equal to or less than a lower limit value thereof, the refractive power of the vibration-proof group is prevented from becoming excessively weak, and thus the amount of movement of the vibration-proof group during image shake correction is prevented from becoming excessively large, which is advantageous for size reduction. By not allowing the corresponding value of Conditional Expression (16) to be equal to or greater than an upper limit value thereof, the refractive power of the vibration-proof group is prevented from becoming excessively strong, which is advantageous for correcting various aberrations.

$$- 0.13 < fIS / f < - 0.02 \qquad ( 16 )$$

In order to obtain more favorable characteristics, the lower limit value of Conditional Expression (16) is more preferably set to −0.12, still more preferably set to −0.11, still more preferably set to −0.1, still more preferably set to −0.09, and still more preferably set to −0.08. The upper limit value of Conditional Expression (16) is more preferably set to −0.03 and still more preferably set to −0.04.

In a configuration in which the third lens group G3 includes a vibration-proof group, the imaging lens preferably satisfies Conditional Expression (17). Here, a lateral magnification of the vibration-proof group in a state where the infinite distance object is in focus is denoted by βIS. A combined lateral magnification of all lenses closer to the image side than the vibration-proof group in a state where the infinite distance object is in focus is denoted by βISR. In a case where there is no lens on the image side with respect to the vibration-proof group, βISR=1. By not allowing the corresponding value of Conditional Expression (17) to be equal to or less than a lower limit value thereof, a ratio of the amount of movement of the image plane position to the unit amount of movement of the vibration-proof group is prevented from becoming excessively small, and thus the amount of movement of the focusing group during image shake correction is prevented from becoming excessively large. As a result, it is advantageous for achieving both size reduction and high performance. By not allowing the corresponding value of Conditional Expression (17) to be equal to or greater than an upper limit value thereof, the ratio of the amount of movement of the image plane position to the unit amount of movement of the vibration-proof group is prevented from becoming excessively large, which is advantageous for achieving both manufacturing suitability and size reduction.

$$1.5 < \vert ( 1 - β IS ) \times β ISR \vert < 6 \qquad ( 17 )$$

In order to obtain more favorable characteristics, the lower limit value of Conditional Expression (17) is more preferably set to 1.75, still more preferably set to 2, and still more preferably set to 2.25. The upper limit value of Conditional Expression (17) is more preferably set to 5.5, still more preferably set to 5, still more preferably set to 4.5, and still more preferably set to 4.

In a configuration in which the third lens group G3 includes a vibration-proof group and the vibration-proof group includes at least one negative lens, the imaging lens preferably satisfies at least one of Conditional Expression (18), (19), or (20). Here, an average of refractive indices of all negative lenses in the vibration-proof group at the d line is denoted by NaveISn. An average of Abbe numbers of all the negative lenses in the vibration-proof group based on the d line is denoted by νaveISn. An average of partial dispersion ratios of all the negative lenses in the vibration-proof group between the g line and the F line is denoted by θaveISn.

$$1.6 < NaveISn < 2.01 \qquad ( 18 )$$

$$16 < vaveISn < 65 \qquad ( 19 )$$

$$0.49 < θ aveISn < 0.72 \qquad ( 20 )$$

By not allowing the corresponding value of Conditional Expression (18) to be equal to or less than a lower limit value thereof, it is possible to suppress undercorrection of field curvature during image shake correction. By not allowing the corresponding value of Conditional Expression (18) to be equal to or greater than an upper limit value thereof, it is possible to suppress overcorrection of field curvature during image shake correction.

In order to obtain more favorable characteristics, the lower limit value of Conditional Expression (18) is more preferably set to 1.64, still more preferably set to 1.68, still more preferably set to 1.74, still more preferably set to 1.78, and still more preferably set to 1.84. The upper limit value of Conditional Expression (18) is more preferably set to 1.96.

By not allowing the corresponding value of Conditional Expression (19) to be equal to or less than a lower limit value thereof, it is possible to suppress undercorrection of lateral chromatic aberration during image shake correction. By not allowing the corresponding value of Conditional Expression (19) to be equal to or greater than an upper limit value thereof, it is possible to suppress overcorrection of lateral chromatic aberration during image shake correction.

In order to obtain more favorable characteristics, the lower limit value of Conditional Expression (19) is more preferably set to 17, still more preferably set to 18, still more preferably set to 19, still more preferably set to 20, and still more preferably set to 23. The upper limit value of Conditional Expression (19) is more preferably set to 60, still more preferably set to 55, still more preferably set to 50, still more preferably set to 45, and still more preferably set to 40.

By not allowing the corresponding value of Conditional Expression (20) to be equal to or less than a lower limit value thereof, it is possible to suppress undercorrection of secondary spectrum of lateral chromatic aberration during image shake correction. By not allowing the corresponding value of Conditional Expression (20) to be equal to or greater than an upper limit value thereof, it is possible to suppress overcorrection of secondary spectrum of lateral chromatic aberration during image shake correction.

In order to obtain more favorable characteristics, the lower limit value of Conditional Expression (20) is more preferably set to 0.5, still more preferably set to 0.51, and still more preferably set to 0.52. The upper limit value of Conditional Expression (20) is more preferably set to 0.7, still more preferably set to 0.68, still more preferably set to 0.66, and still more preferably set to 0.64.

In a configuration in which the third lens group G3 includes a vibration-proof group and the vibration-proof group includes at least one negative lens, the imaging lens more preferably satisfies Conditional Expressions (18), (19), and (20) simultaneously. Satisfying Conditional Expressions (18), (19), and (20) simultaneously is advantageous for reducing the weight of the vibration-proof group and appropriately correcting various aberrations during image shake correction.

The imaging lens preferably satisfies Conditional Expression (21). By not allowing the corresponding value of Conditional Expression (21) to be equal to or less than a lower limit value thereof, the back focal length Bf is prevented from becoming excessively short, which makes it easier to attach a mount replacement mechanism. By not allowing the corresponding value of Conditional Expression (21) to be equal to or greater than an upper limit value thereof, the back focal length Bf is prevented from becoming excessively long, which is advantageous for size reduction.

$$1.2 < B f / ( f \times tan ω ) < 5 \qquad ( 21 )$$

In order to obtain more favorable characteristics, the lower limit value of Conditional Expression (21) is more preferably set to 1.4, still more preferably set to 1.6, still more preferably set to 1.8, and still more preferably set to 2. The upper limit value of Conditional Expression (21) is more preferably set to 4.5, still more preferably set to 4, and still more preferably set to 3.5.

In a configuration in which the imaging lens includes the aperture stop St, the imaging lens preferably satisfies Conditional Expression (22). Here, a distance on the optical axis from the lens surface of the first lens group G1 closest to the object side to the aperture stop St in a state where the infinite distance object is in focus is denoted by dL1St. As an example, FIG. 2 shows the distance dL1St in the imaging lens of FIG. 1. By not allowing the corresponding value of Conditional Expression (22) to be equal to or less than a lower limit value thereof, a distance from the lens surface of the first lens group G1 closest to the object side to an entrance pupil position is prevented from becoming excessively short, which is advantageous for suppressing various aberrations. By not allowing the corresponding value of Conditional Expression (22) to be equal to or less than an upper limit value thereof, the distance from the lens surface of the first lens group G1 closest to the object side to the entrance pupil position is prevented from becoming excessively long, and thus it is possible to prevent the diameter of the lens in the first lens group G1 from becoming excessively large, which is advantageous for size reduction.

$$0.15 < d L 1 S t / f < 0.45 \qquad ( 22 )$$

In order to obtain more favorable characteristics, the lower limit value of Conditional Expression (22) is more preferably set to 0.17, still more preferably set to 0.19, still more preferably set to 0.21, and still more preferably set to 0.23. The upper limit value of Conditional Expression (22) is more preferably set to 0.41, still more preferably set to 0.38, still more preferably set to 0.35, and still more preferably set to 0.32.

The imaging lens preferably satisfies Conditional Expression (23). Here, a distance on the optical axis from the lens surface of the first lens group G1 closest to the object side to a paraxial entrance pupil position Penp in a state where the infinite distance object is in focus is denoted by dEnp. As an example, FIG. 2 shows the paraxial entrance pupil position Penp and the distance dEnp in the imaging lens of FIG. 1. By not allowing the corresponding value of Conditional Expression (23) to be equal to or less than a lower limit value thereof, a distance from the lens surface of the first lens group G1 closest to the object side to the paraxial entrance pupil position Penp is prevented from becoming excessively short, which is advantageous for suppressing various aberrations. By not allowing the corresponding value of Conditional Expression (23) to be equal to or less than an upper limit value thereof, the distance from the lens surface of the first lens group G1 closest to the object side to the paraxial entrance pupil position Penp is prevented from becoming excessively long, and thus it is possible to prevent the diameter of the lens in the first lens group G1 from becoming excessively large, which is advantageous for size reduction.

$$0.3 < dEnp / f < 1.5 \qquad ( 23 )$$

In order to obtain more favorable characteristics, the lower limit value of Conditional Expression (23) is more preferably set to 0.4, still more preferably set to 0.5, and still more preferably set to 0.6. The upper limit value of Conditional Expression (23) is more preferably set to 1.4, still more preferably set to 1.3, still more preferably set to 1.2, still more preferably set to 1.1, and still more preferably set to 1.

The imaging lens preferably satisfies Conditional Expression (24). Here, a distance on the optical axis from the image plane Sim to a paraxial exit pupil position Pexp in a state where the infinite distance object is in focus is denoted by dExp. As an example, FIG. 2 shows the paraxial exit pupil position Pexp and the distance dExp in the imaging lens of FIG. 1. A sign of dExp is defined with the image plane Sim as a reference such that a distance on the image side is positive and a distance on the object side is negative. In a case where an optical member having no refractive power is disposed between the image plane Sim and the paraxial exit pupil position Pexp, dExp is calculated using an air conversion distance for the optical member. By not allowing the corresponding value of Conditional Expression (24) to be equal to or less than a lower limit value thereof, it is easy to shorten the total length of the optical system, which is advantageous for size reduction. By not allowing the corresponding value of Conditional Expression (24) to be equal to or greater than an upper limit value thereof, it is easy to reduce an incidence angle of an off-axis principal ray on the image plane Sim, which is advantageous for ensuring the amount of peripheral light.

$$- 0.5 < dExp / f < - 0.1 \qquad ( 24 )$$

In order to obtain more favorable characteristics, the lower limit value of Conditional Expression (24) is more preferably set to −0.45, still more preferably set to −0.4, and still more preferably set to −0.35. The upper limit value of Conditional Expression (24) is more preferably set to −0.15 and still more preferably set to −0.2.

The imaging lens preferably satisfies Conditional Expression (25). By not allowing the corresponding value of Conditional Expression (25) to be equal to or less than a lower limit value thereof, it is particularly advantageous to suppress spherical aberration and axial chromatic aberration. By not allowing the corresponding value of Conditional Expression (25) to be equal to or greater than an upper limit value thereof, the number of lenses having a large diameter can be reduced, which is advantageous for reducing the whole system in size and weight.

$$0.02 < dF / f 1 < 0.24 \qquad ( 25 )$$

In order to obtain more favorable characteristics, the lower limit value of Conditional Expression (25) is more preferably set to 0.04 and still more preferably set to 0.06. The upper limit value of Conditional Expression (25) is more preferably set to 0.22, still more preferably set to 0.2, still more preferably set to 0.18, still more preferably set to 0.16, and still more preferably set to 0.14.

In a configuration in which the imaging lens includes the aperture stop St and the third lens group G3 includes the vibration-proof group, the imaging lens preferably satisfies Conditional Expression (26). Here, a length of the vibration-proof group on the optical axis is denoted by dIS. A distance on the optical axis from the aperture stop St to the lens surface of the third lens group G3 closest to the image side in a state where the infinite distance object is in focus is denoted by dStG3r. As an example, FIG. 2 shows the length dIS and the distance dStG3r in the imaging lens of FIG. 1. By not allowing the corresponding value of Conditional Expression (26) to be equal to or less than a lower limit value thereof, the refractive power of the vibration-proof group is prevented from becoming excessively strong, which is advantageous for correcting various aberrations. By not allowing the corresponding value of Conditional Expression (26) to be equal to or greater than an upper limit value thereof, there is an advantage in reducing the vibration-proof group in size and weight.

$$0.04 < dIS / dStG 3 r < 0.45 \qquad ( 26 )$$

In order to obtain more favorable characteristics, the lower limit value of Conditional Expression (26) is more preferably set to 0.06, still more preferably set to 0.08, and still more preferably set to 0.1. The upper limit value of Conditional Expression (26) is more preferably set to 0.4, still more preferably set to 0.35, still more preferably set to 0.3, still more preferably set to 0.25, and still more preferably set to 0.2.

In a configuration in which the third lens group G3 includes a vibration-proof group and at least one negative lens disposed closer to the image side than the vibration-proof group, the imaging lens preferably satisfies at least one of Conditional Expression (27) or (28). Here, an Abbe number of the negative lens disposed closer to the image side than the vibration-proof group based on the d line is denoted by νISRn. A partial dispersion ratio of the negative lens disposed closer to the image side than the vibration-proof group between the g line and the F line is denoted by θISRn.

$$60 < vISRn < 96 \qquad ( 27 )$$

$$0.69 < θ ISRn < 0.79 \qquad ( 28 )$$

By not allowing the corresponding value of Conditional Expression (27) to be equal to or less than a lower limit value thereof, it is possible to suppress undercorrection of lateral chromatic aberration. By not allowing the corresponding value of Conditional Expression (27) to be equal to or greater than an upper limit value thereof, it is possible to suppress overcorrection of lateral chromatic aberration.

In order to obtain more favorable characteristics, the lower limit value of Conditional Expression (27) is more preferably set to 65, still more preferably set to 70, and still more preferably set to 75. The upper limit value of Conditional Expression (27) is more preferably set to 91, still more preferably set to 86, and still more preferably set to 82.

By not allowing the corresponding value of Conditional Expression (28) to be equal to or less than a lower limit value thereof, it is possible to suppress undercorrection of secondary spectrum of lateral chromatic aberration. By not allowing the corresponding value of Conditional Expression (28) to be equal to or greater than an upper limit value thereof, it is possible to suppress overcorrection of secondary spectrum of lateral chromatic aberration.

In order to obtain more favorable characteristics, the lower limit value of Conditional Expression (28) is more preferably set to 0.7, still more preferably set to 0.71, and still more preferably set to 0.72. The upper limit value of Conditional Expression (28) is more preferably set to 0.78, still more preferably set to 0.77, and still more preferably set to 0.76.

In a configuration in which the third lens group G3 includes a vibration-proof group and at least one negative lens disposed closer to the image side than the vibration-proof group, the imaging lens more preferably includes at least one negative lens that satisfies Conditional Expressions (27) and (28) simultaneously. In this case, it is particularly easy to appropriately correct lateral chromatic aberration.

In a configuration in which the third lens group G3 includes a vibration-proof group and a plurality of negative lenses disposed closer to the image side than the vibration-proof group, the imaging lens preferably satisfies at least one of Conditional Expression (29), (30), or (31). Here, an average of refractive indices of all negative lenses disposed closer to the image side than the vibration-proof group at the d line is denoted by NaveISRn. An average of Abbe numbers of all the negative lenses disposed closer to the image side than the vibration-proof group based on the d line is denoted by νaveISRn. An average of partial dispersion ratios of all the negative lenses disposed closer to the image side than the vibration-proof group between the g line and the F line is denoted by θaveISRn.

$$1.49 < NaveISRn < 1.8 \qquad ( 29 )$$

$$45 < vaveISRn < 75 \qquad ( 30 )$$

$$0.5 < θ aveISRn < 0.6 \qquad ( 31 )$$

By not allowing the corresponding value of Conditional Expression (29) to be equal to or less than a lower limit value thereof, it is possible to suppress undercorrection of field curvature. By not allowing the corresponding value of Conditional Expression (29) to be equal to or greater than an upper limit value thereof, it is possible to suppress overcorrection of field curvature.

In order to obtain more favorable characteristics, the lower limit value of Conditional Expression (29) is more preferably set to 1.51, still more preferably set to 1.53, still more preferably set to 1.55, and still more preferably set to 1.57. The upper limit value of Conditional Expression (29) is more preferably set to 1.77, still more preferably set to 1.75, still more preferably set to 1.73, and still more preferably set to 1.7.

By not allowing the corresponding value of Conditional Expression (30) to be equal to or less than a lower limit value thereof, it is possible to suppress undercorrection of lateral chromatic aberration. By not allowing the corresponding value of Conditional Expression (30) to be equal to or greater than an upper limit value thereof, it is possible to suppress overcorrection of lateral chromatic aberration.

In order to obtain more favorable characteristics, the lower limit value of Conditional Expression (30) is more preferably set to 48, still more preferably set to 51, and still more preferably set to 54. The upper limit value of Conditional Expression (30) is more preferably set to 72, still more preferably set to 69, and still more preferably set to 68.

By not allowing the corresponding value of Conditional Expression (31) to be equal to or less than a lower limit value thereof, it is possible to suppress undercorrection of secondary spectrum of lateral chromatic aberration. By not allowing the corresponding value of Conditional Expression (31) to be equal to or greater than an upper limit value thereof, it is possible to suppress overcorrection of secondary spectrum of lateral chromatic aberration.

In order to obtain more favorable characteristics, the lower limit value of Conditional Expression (31) is more preferably set to 0.51, still more preferably set to 0.52, and still more preferably set to 0.53. The upper limit value of Conditional Expression (31) is more preferably set to 0.59, still more preferably set to 0.58, and still more preferably set to 0.57.

In a configuration in which the third lens group G3 includes a vibration-proof group and a plurality of negative lenses disposed closer to the image side than the vibration-proof group, the imaging lens more preferably satisfies Conditional Expressions (29), (30), and (31) simultaneously. In this case, it is particularly easy to appropriately correct field curvature and lateral chromatic aberration.

In a case where an average of specific gravities of all lenses in the second lens group G2 is denoted by SG2, the imaging lens preferably satisfies Conditional Expression (32). The “specific gravity” in the present specification refers to a ratio to a mass of pure water at 4° C. under a pressure of 101.325 kilopascals (kPa), which is standard pressure. By not allowing the corresponding value of Conditional Expression (32) to be equal to or less than a lower limit value thereof, a material having a high refractive index can be selected, and thus the absolute value of the curvature radius can be increased, which is advantageous for reducing the weight of the second lens group G2. By not allowing the corresponding value of Conditional Expression (32) to be equal to or greater than an upper limit value thereof, there is an advantage in reducing the weight of the second lens group G2.

$$2.7 < SG 2 < 4.5 \qquad ( 32 )$$

In order to obtain more favorable characteristics, the lower limit value of Conditional Expression (32) is more preferably set to 2.8, still more preferably set to 2.9, and still more preferably set to 3. The upper limit value of Conditional Expression (32) is more preferably set to 4.4, still more preferably set to 4.3, still more preferably set to 4.2, still more preferably set to 4.1, and still more preferably set to 4.

In a configuration in which the third lens group G3 includes a vibration-proof group and the vibration-proof group includes at least one negative lens, the imaging lens preferably satisfies Conditional Expression (33). Here, an average of specific gravities of all negative lenses in the vibration-proof group is denoted by SGISn. By not allowing the corresponding value of Conditional Expression (33) to be equal to or less than a lower limit value thereof, a material having a high refractive index can be selected, and thus the absolute value of the curvature radius can be increased, which is advantageous for reducing the weight of the vibration-proof group. By not allowing the corresponding value of Conditional Expression (33) to be equal to or greater than an upper limit value thereof, there is an advantage in reducing the weight of the vibration-proof group.

$$3.4 < SGISn < 4.7 \qquad ( 33 )$$

In order to obtain more favorable characteristics, the lower limit value of Conditional Expression (33) is more preferably set to 3.5, still more preferably set to 3.6, and still more preferably set to 3.7. The upper limit value of Conditional Expression (33) is more preferably set to 4.6, still more preferably set to 4.5, and still more preferably set to 4.4.

In a configuration in which the third lens group G3 includes an aspherical lens, the imaging lens preferably satisfies Conditional Expression (34). Here, symbols for the aspherical lens in the third lens group G3 are defined as follows. A paraxial curvature radius of a surface of the aspherical lens on the object side is denoted by Rcf. A paraxial curvature radius of a surface of the aspherical lens on the image side is denoted by Rcr. A curvature radius of the surface of the aspherical lens on the object side at a position of a maximum effective diameter is denoted by Ryf. A curvature radius of the surface of the aspherical lens on the image side at a position of a maximum effective diameter is denoted by Ryr. By not allowing the corresponding value of Conditional Expression (34) to be equal to or less than a lower limit value thereof, the refractive power on the peripheral side of the lens is prevented from becoming excessively strong, which is advantageous for suppressing distortion. By not allowing the corresponding value of Conditional Expression (34) to be equal to or greater than an upper limit value thereof, the refractive power on the peripheral side of the lens is prevented from becoming excessively weak, which is advantageous for correcting field curvature and astigmatism of an off-axis ray that occurs on the peripheral side of the lens.

$$0.65 < \vert ( 1 / Rcf - 1 / Rcr ) / ( 1 / Ryf - 1 / Ryr ) \vert < 1.35 \qquad ( 34 )$$

In order to obtain more favorable characteristics, the lower limit value of Conditional Expression (34) is more preferably set to 0.7, still more preferably set to 0.75, still more preferably set to 0.8, and still more preferably set to 0.85. The upper limit value of Conditional Expression (34) is more preferably set to 1.3, still more preferably set to 1.25, still more preferably set to 1.2, and still more preferably set to 1.15.

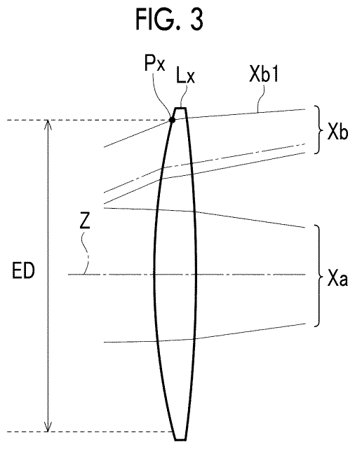

The “position of the maximum effective diameter” will be described with reference to FIG. 3. FIG. 3 is a diagram for description. In FIG. 3, a left side is the object side, and a right side is the image side. FIG. 3 shows an on-axis luminous flux Xa and an off-axis luminous flux Xb passing through a lens Lx. In the example of FIG. 3, a ray Xb1 that is an upper ray in the off-axis luminous flux Xb is a ray passing through the outermost side. Here, the term “outer side” refers to a radially outward side with the optical axis Z as the center, that is, a side away from the optical axis Z. In the present specification, a position of an intersection between the ray that passes through the outermost side and a lens surface is a position Px of the maximum effective diameter. In addition, twice a distance from the position Px of the maximum effective diameter to the optical axis Z is an effective diameter ED of a surface of the lens Lx on the object side. In the example of FIG. 3, the upper ray of the off-axis luminous flux Xb is the ray passing through the outermost side, but which ray passes through the outermost side varies depending on the optical system.

The example shown in FIG. 1 is merely an example, and various modifications can be made without departing from the gist of the technology of the present disclosure. For example, the number of lenses included in each lens group, the number of lenses included in the front partial group GF, the number of lenses included in the focusing group, and the number of lenses included in the vibration-proof group may be different from the numbers in the example of FIG. 1. The lens corresponding to the focusing group and the lens corresponding to the vibration-proof group may be different from those in the example of FIG. 1.

The above-mentioned preferred configurations and available configurations may be optional combinations, and it is preferable to selectively adopt the configurations in accordance with required specifications.

For example, a preferred aspect of the imaging lens of the present disclosure consists of, in order from the object side to the image side, a first lens group G1 having a positive refractive power, a second lens group G2, and a third lens group G3, in which, during focusing, a spacing between the first lens group G1 and the second lens group G2 changes, a spacing between the second lens group G2 and the third lens group G3 changes, and Conditional Expressions (1) and (2) are satisfied.

Next, examples of the imaging lens of the present disclosure will be described with reference to the drawings. Reference numerals provided to lenses and lens groups in a cross-sectional view of each example are independently used for each example in order to avoid complication of description and the drawings caused by an increase in the number of digits of the reference numerals. Accordingly, a common reference numeral provided in the drawings of different examples does not necessarily indicate a common configuration.

### Example 1

Since a cross-sectional view of a configuration of an imaging lens of Example 1 is shown in FIG. 1, and its illustration method and configuration are the same as described above, the duplicate descriptions will be partially omitted. The imaging lens of Example 1 consists of, in order from the object side to the image side, a first lens group G1 having a positive refractive power, a second lens group G2 having a negative refractive power, and a third lens group G3 having a negative refractive power. During focusing from the infinite distance object to the nearest object, the second lens group G2 moves toward the image side, and the first lens group G1 and the third lens group G3 remain stationary with respect to the image plane Sim.

The first lens group G1 consists of, in order from the object side to the image side, lenses L11 to L18 and an aperture stop St. The second lens group G2 consists of a lens L21. The third lens group G3 consists of, in order from the object side to the image side, lenses L31 to L40. The front partial group GF consists of lenses L11 and L12. The vibration-proof group consists of lenses L33 to L35.

Basic lens data of the imaging lens of Example 1 is shown in Table 1, and specifications thereof are shown in Table 2.

The table of the basic lens data is described as below. The column of “Sn” indicates surface numbers in a case where the number is increased by one at a time toward the image side from a surface closest to the object side as a first surface. The column of “R” indicates a curvature radius of each surface. The column of “D” indicates a surface spacing on the optical axis between each surface and its adjacent surface on the image side. The column of “Nd” indicates a refractive index of each lens at the d line. The column of “νd” indicates an Abbe number of each lens based on the d line. The column “θgF” indicates a partial dispersion ratio of each lens between the g line and the F line. The column of “SG” indicates a specific gravity of each lens.

In the table of the basic lens data, a sign of a curvature radius of a surface convex toward the object side is defined as positive, and a sign of a curvature radius of a surface convex toward the image side is defined as negative. The field of the surface number of the surface corresponding to the aperture stop St have the surface number and the word (St). A value in the lowermost field of the column of D in the table indicates a spacing between a surface closest to the image side in the table and the image plane Sim.

The table of the specification shows the focal length f, the back focal length Bf, the open F-number FNo, and the maximum full angle of view 20, based on the d line. In the field of the maximum full angle of view, [°] indicates that the unit is degrees. The FNo. of the table of the specifications and the FNo. of aberration diagrams described below are the same as the FNo of Conditional Expression (1). Tables 1 and 2 show values in a state where the infinite distance object is in focus.

Although, in the data of each table, a degree unit is used for angles, and a millimeter unit is used for lengths, since the optical system can also be proportionally enlarged or proportionally reduced to be used, other appropriate units can also be used. In addition, the numerical values rounded to predetermined digits are described in each table shown below.

TABLE 1
Example 1

| Sn | R | D | Nd | νd | θgF | SG |
|---|---|---|---|---|---|---|
| 1 | 399.2896 | 6.0000 | 1.60342 | 38.03 | 0.58356 | 2.63 |
| 2 | −8082.1798 | 1.0000 | | | | |
| 3 | 103.2591 | 14.2710 | 1.43700 | 95.10 | 0.53364 | 3.53 |
| 4 | 2430.6564 | 50.0899 | | | | |
| 5 | 134.0069 | 8.6777 | 1.43700 | 95.10 | 0.53364 | 3.53 |
| 6 | −222.3436 | 1.7000 | 1.91082 | 35.25 | 0.58224 | 4.97 |
| 7 | 119.8783 | 0.5441 | | | | |
| 8 | 71.2777 | 6.8654 | 1.43700 | 95.10 | 0.53364 | 3.53 |
| 9 | 302.2238 | 21.5140 | | | | |
| 10 | 56.6944 | 4.6301 | 1.80518 | 25.46 | 0.61572 | 3.36 |
| 11 | 212.4003 | 0.3520 | | | | |
| 12 | 186.6618 | 1.3014 | 1.85150 | 40.78 | 0.56958 | 4.70 |
| 13 | 33.7836 | 7.0194 | 1.43700 | 95.10 | 0.53364 | 3.53 |
| 14 | 158.0288 | 13.2392 | | | | |
| 15(St) | ∞ | 2.9236 | | | | |
| 16 | 260.0007 | 1.2000 | 1.69680 | 55.53 | 0.54341 | 3.70 |
| 17 | 59.4630 | 35.6349 | | | | |
| 18 | 97.1322 | 1.3000 | 1.95906 | 17.47 | 0.65993 | 3.59 |
| 19 | 47.3110 | 2.3938 | 1.63980 | 34.47 | 0.59233 | 2.76 |
| 20 | −294.4409 | 2.2363 | | | | |
| 21 | 1545.9049 | 3.9750 | 1.60342 | 38.03 | 0.58356 | 2.63 |
| 22 | −28.6700 | 0.9100 | 1.56384 | 60.71 | 0.54120 | 3.06 |
| 23 | 77.3797 | 2.1084 | | | | |
| 24 | −87.2158 | 1.2455 | 1.81600 | 46.62 | 0.55682 | 5.07 |
| 25 | 86.3782 | 3.0000 | | | | |
| 26 | 128.4413 | 8.8388 | 1.59551 | 39.24 | 0.58043 | 2.63 |
| 27 | −201.9816 | 10.1356 | | | | |
| 28 | 265.3452 | 4.5739 | 1.54814 | 45.78 | 0.56859 | 2.54 |
| 29 | −71.2093 | 1.5100 | 1.55200 | 70.70 | 0.54219 | 3.74 |
| 30 | 362.6907 | 3.0789 | | | | |
| 31 | 144.4956 | 8.0588 | 1.59551 | 39.24 | 0.58043 | 2.63 |
| 32 | −44.1006 | 1.6000 | 1.62041 | 60.29 | 0.54266 | 3.59 |
| 33 | −321.1447 | 92.5781 | | | | |

TABLE 2
Example 1

| | |
|---|---|
| f | 584.92 |
| Bf | 92.58 |
| FNo. | 5.76 |
| 2ω[°] | 5.28 |

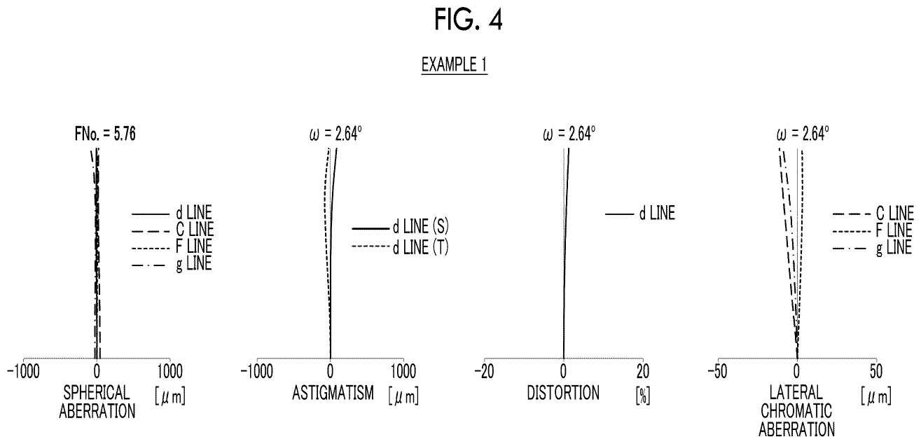

FIG. 4 shows a diagram of aberrations of the imaging lens of Example 1 in a state where the infinite distance object is in focus. In FIG. 4, the spherical aberration, the astigmatism, the distortion, and the lateral chromatic aberration are shown in this order from the left. In the spherical aberration diagram, the aberrations at the d line, the C line, the F line, and the g line are indicated by a solid line, a long broken line, a short broken line, and a dot-dashed line, respectively. In the astigmatism diagram, the aberration at the d line in a sagittal direction is indicated by a solid line, and the aberration on the d line in a tangential direction is indicated by a short broken line. In the distortion diagram, the aberration at the d line is indicated by a solid line. In the lateral chromatic aberration diagram, the aberrations at the C line, the F line, and the g line are indicated by a long broken line, a short broken line, and a dot-dashed line, respectively. In the spherical aberration diagram, a value of the open F-number is shown after “FNo.=”. In other aberration diagrams, a value of the maximum half angle of view is shown after “ω=”.

Symbols, meanings, description methods, and illustration methods of each data related to Example 1 are basically the same for the following examples unless otherwise noted, and thus the duplicate descriptions thereof will be omitted below.

### Example 2

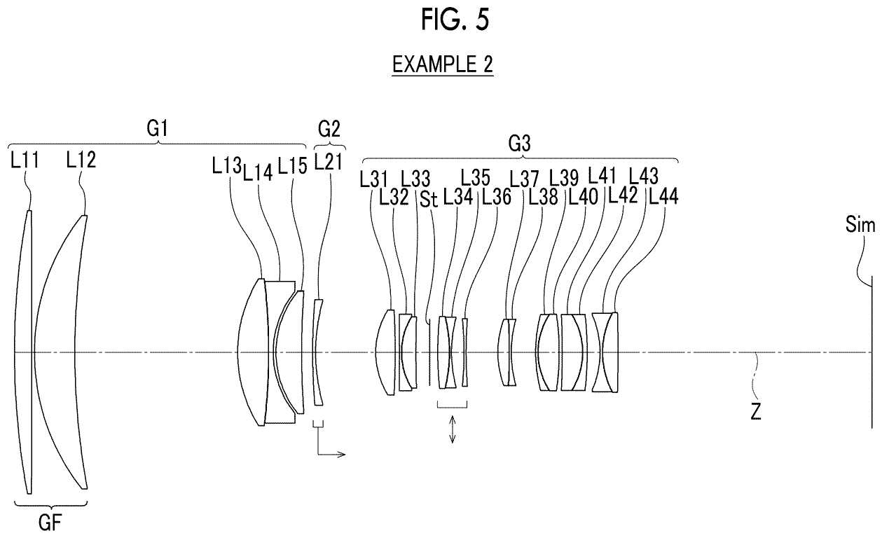

A cross-sectional view of a configuration of an imaging lens of Example 2 is shown in FIG. 5. The imaging lens of Example 2 consists of, in order from the object side to the image side, a first lens group G1 having a positive refractive power, a second lens group G2 having a negative refractive power, and a third lens group G3 having a negative refractive power. During focusing from the infinite distance object to the nearest object, the second lens group G2 moves toward the image side, and the first lens group G1 and the third lens group G3 remain stationary with respect to the image plane Sim.

The first lens group G1 consists of, in order from the object side to the image side, lenses L11 to L15. The second lens group G2 consists of a lens L21. The third lens group G3 consists of, in order from the object side to the image side, lenses L31 to L33, an aperture stop St, and lenses L34 to L44. The front partial group GF consists of lenses L11 and L12. The vibration-proof group consists of lenses L34 to L36.

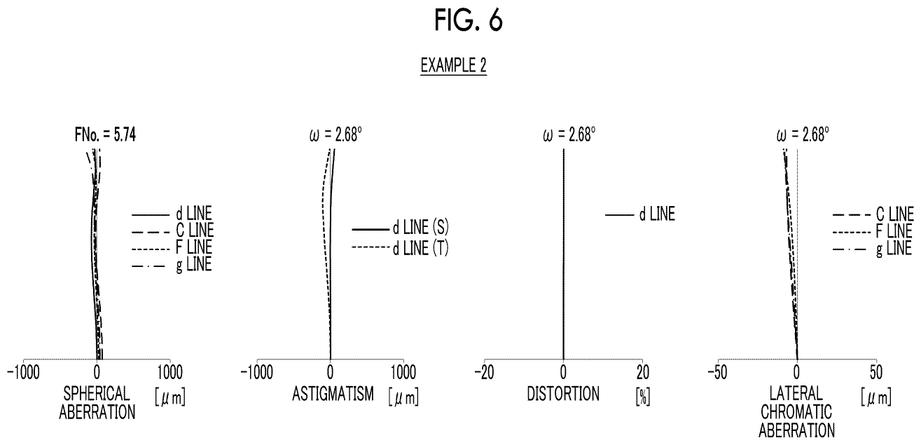

Regarding the imaging lens of Example 2, Table 3 shows basic lens data, Table 4 shows specifications, and FIG. 6 shows a diagram of aberrations.

TABLE 3
Example 2

| Sn | R | D | Nd | νd | θgF | SG |
|---|---|---|---|---|---|---|
| 1 | 280.0338 | 6.2081 | 1.57501 | 41.50 | 0.57672 | 2.58 |
| 2 | −18865.4569 | 1.0000 | | | | |
| 3 | 79.3748 | 14.6319 | 1.48071 | 85.29 | 0.53623 | 3.68 |
| 4 | 271.9983 | 58.8856 | | | | |
| 5 | 50.1387 | 11.2120 | 1.43700 | 95.10 | 0.53364 | 3.53 |
| 6 | −229.6481 | 1.6669 | 1.78800 | 47.37 | 0.55598 | 4.3 |
| 7 | 34.8031 | 1.0000 | | | | |
| 8 | 34.7560 | 9.2757 | 1.43700 | 95.10 | 0.53364 | 3.53 |
| 9 | 298.4893 | 4.0000 | | | | |
| 10 | 232.5792 | 1.0700 | 1.74400 | 44.79 | 0.56560 | 4.32 |
| 11 | 68.2643 | 21.7651 | | | | |
| 12 | 29.0227 | 7.0109 | 1.43700 | 95.10 | 0.53364 | 3.53 |
| 13 | −289.6276 | 1.5008 | | | | |
| 14 | −8407.3976 | 0.7887 | 1.95375 | 32.32 | 0.59015 | 5.1 |
| 15 | 24.4983 | 5.2100 | 1.57144 | 71.61 | 0.54193 | 4.11 |
| 16 | 442.8596 | 4.9168 | | | | |
| 17(St) | ∞ | 3.0000 | | | | |
| 18 | 139.4438 | 4.0300 | 1.98613 | 16.48 | 0.66558 | 3.54 |
| 19 | −54.6387 | 0.7600 | 1.91082 | 35.25 | 0.58224 | 4.97 |
| 20 | 48.8574 | 4.5100 | | | | |
| 21 | −118.6569 | 0.7500 | 1.98613 | 16.48 | 0.66558 | 3.54 |
| 22 | 175.2953 | 11.4572 | | | | |
| 23 | 33.1218 | 4.1500 | 1.63980 | 34.47 | 0.59233 | 2.76 |
| 24 | −251.4823 | 0.7600 | 1.62280 | 57.05 | 0.54640 | 3.6 |
| 25 | 43.9900 | 8.7939 | | | | |
| 26 | 52.8513 | 0.9000 | 1.98613 | 16.48 | 0.66558 | 3.54 |
| 27 | 25.0755 | 7.6316 | 1.78880 | 28.43 | 0.60092 | 3.33 |
| 28 | −93.1083 | 1.1129 | | | | |
| 29 | −286.7278 | 7.3678 | 1.69895 | 30.05 | 0.60282 | 2.94 |
| 30 | −25.6805 | 1.6000 | 1.71299 | 53.87 | 0.54587 | 3.79 |
| 31 | −132.2086 | 4.7040 | | | | |
| 32 | −33.2932 | 0.9000 | 1.55200 | 70.70 | 0.54219 | 3.74 |
| 33 | 30.7727 | 5.5872 | 1.56732 | 42.82 | 0.57309 | 2.57 |
| 34 | −606.8370 | 91.8709 | | | | |

TABLE 4
Example 2

| | |
|---|---|
| f | 584.93 |
| Bf | 91.86 |
| FNo. | 5.74 |
| 2ω[°] | 5.36 |

### Example 3

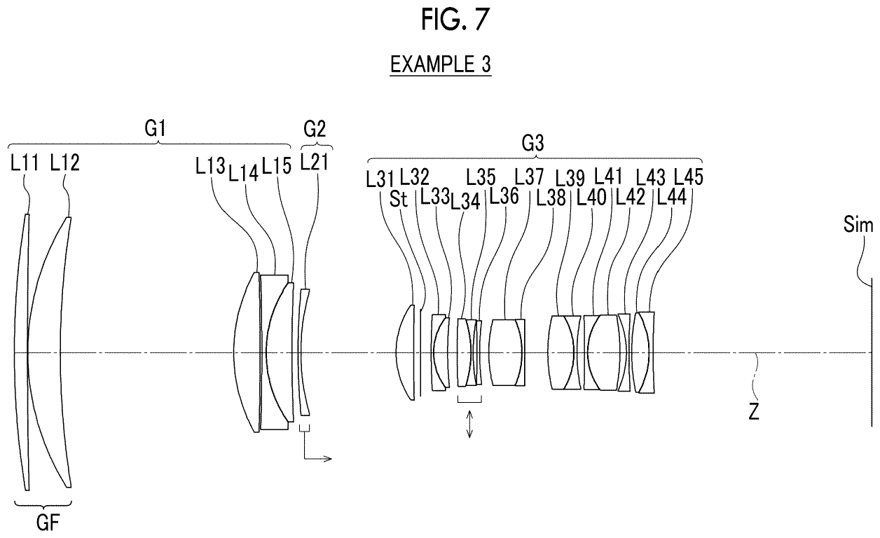

A cross-sectional view of a configuration of an imaging lens of Example 3 is shown in FIG. 7. The imaging lens of Example 3 consists of, in order from the object side to the image side, a first lens group G1 having a positive refractive power, a second lens group G2 having a negative refractive power, and a third lens group G3 having a negative refractive power. During focusing from the infinite distance object to the nearest object, the second lens group G2 moves toward the image side, and the first lens group G1 and the third lens group G3 remain stationary with respect to the image plane Sim.

The first lens group G1 consists of, in order from the object side to the image side, lenses L11 to L15. The second lens group G2 consists of a lens L21. The third lens group G3 consists of, in order from the object side to the image side, a lens L31, an aperture stop St, and lenses L32 to L45. The front partial group GF consists of lenses L11 and L12. The vibration-proof group consists of lenses L34 to L36.

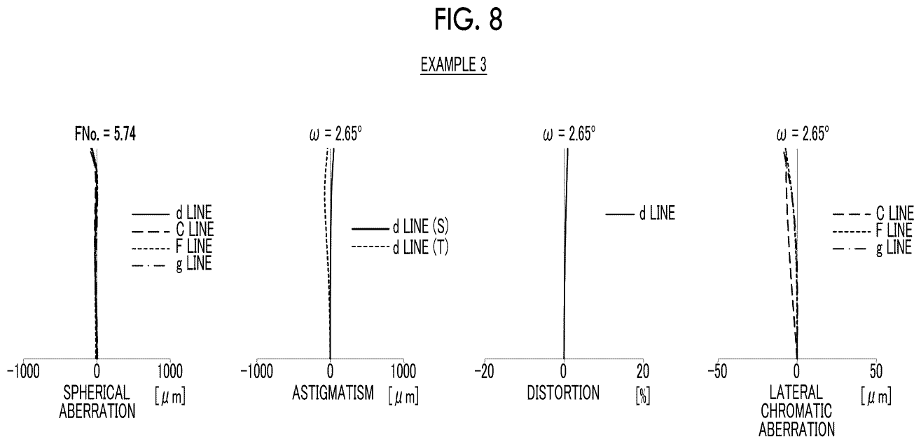

Regarding the imaging lens of Example 3, Table 5 shows basic lens data, Table 6 shows specifications, and FIG. 8 shows a diagram of aberrations.

TABLE 5
Example 3

| Sn | R | D | Nd | νd | θgF | SG |
|---|---|---|---|---|---|---|
| 1 | 317.8551 | 4.8376 | 1.67270 | 32.10 | 0.59891 | 2.91 |
| 2 | 1957.5377 | 0.1500 | | | | |
| 3 | 93.3059 | 12.0761 | 1.49700 | 81.61 | 0.53887 | 3.70 |
| 4 | 309.1716 | 64.2060 | | | | |
| 5 | 60.7108 | 9.7740 | 1.43700 | 95.10 | 0.53364 | 3.53 |
| 6 | −1194.7024 | 0.7083 | | | | |
| 7 | −835.4089 | 1.5802 | 1.81600 | 46.62 | 0.55682 | 5.07 |
| 8 | 44.7458 | 9.5810 | 1.43700 | 95.10 | 0.53364 | 3.53 |
| 9 | 553.4837 | 2.2480 | | | | |
| 10 | 246.9272 | 1.0276 | 1.58313 | 59.37 | 0.54345 | 3.19 |
| 11 | 81.1355 | 35.3688 | | | | |
| 12 | 30.9056 | 6.5095 | 1.49700 | 81.61 | 0.53887 | 3.70 |
| 13 | 599.6136 | 2.5344 | | | | |
| 14(St) | ∞ | 4.0111 | | | | |
| 15 | 257.8521 | 0.9174 | 1.92119 | 23.96 | 0.62025 | 3.84 |
| 16 | 21.2231 | 5.1783 | 1.52841 | 76.45 | 0.53954 | 3.76 |
| 17 | 129.1825 | 3.5582 | | | | |
| 18 | 282.0470 | 5.1203 | 1.84666 | 23.84 | 0.62012 | 3.50 |
| 19 | −40.0969 | 0.8273 | 1.83481 | 42.72 | 0.56477 | 4.57 |
| 20 | 67.4308 | 1.3806 | | | | |
| 21 | −302.7556 | 1.0000 | 1.94595 | 17.98 | 0.65460 | 3.51 |
| 22 | 94.8454 | 3.3963 | | | | |
| 23 | 48.0851 | 12.3539 | 1.67270 | 32.10 | 0.59891 | 2.91 |
| 24 | −29.9536 | 1.0008 | 1.74100 | 52.64 | 0.54676 | 4.04 |
| 25 | 980.1306 | 8.5719 | | | | |
| 26 | 57.4791 | 9.6994 | 1.60342 | 38.03 | 0.58356 | 2.63 |
| 27 | −26.5380 | 1.1100 | 1.49700 | 81.61 | 0.53887 | 3.70 |
| 28 | 62.9633 | 2.8346 | | | | |
| 29 | −572.8504 | 1.1584 | 1.85150 | 40.78 | 0.56958 | 4.70 |
| 30 | 22.9123 | 11.9911 | 1.84666 | 23.84 | 0.62012 | 3.50 |
| 31 | −74.6414 | 2.4152 | | | | |
| 32 | −33.2146 | 0.9500 | 1.49700 | 81.61 | 0.53887 | 3.70 |
| 33 | 271.8515 | 1.0000 | | | | |
| 34 | 71.5427 | 6.4938 | 1.80518 | 25.46 | 0.61572 | 3.36 |
| 35 | −30.0667 | 1.5000 | 1.98613 | 16.48 | 0.66558 | 3.54 |
| 36 | 292.5495 | 80.9997 | | | | |

TABLE 6
Example 3

| | |
|---|---|
| f | 586.01 |
| Bf | 81.00 |
| FNo. | 5.74 |
| 2ω[°] | 5.30 |

### Example 4

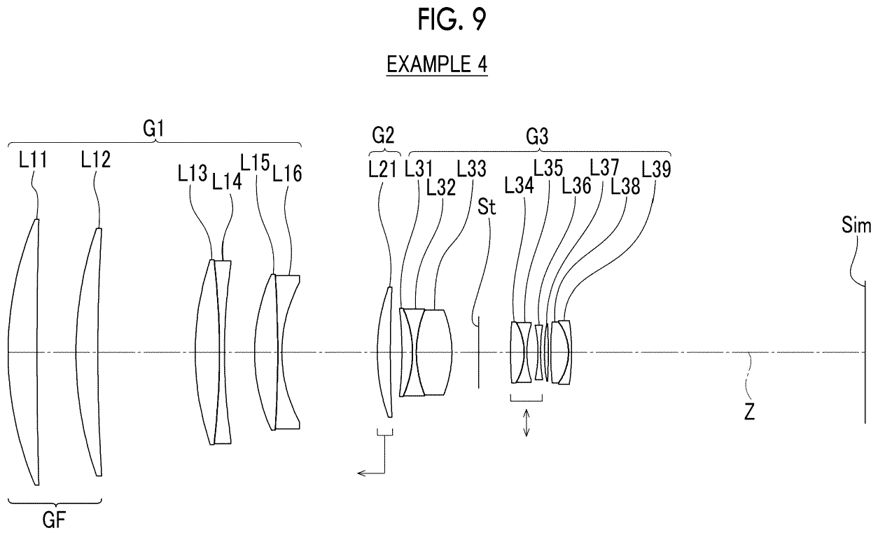

A cross-sectional view of a configuration of an imaging lens of Example 4 is shown in FIG. 9. The imaging lens of Example 4 consists of, in order from the object side to the image side, a first lens group G1 having a positive refractive power, a second lens group G2 having a positive refractive power, and a third lens group G3 having a negative refractive power. During focusing from the infinite distance object to the nearest object, the second lens group G2 moves toward the object side, and the first lens group G1 and the third lens group G3 remain stationary with respect to the image plane Sim.

The first lens group G1 consists of, in order from the object side to the image side, lenses L11 to L16. The second lens group G2 consists of a lens L21. The third lens group G3 consists of, in order from the object side to the image side, lenses L31 to L33, an aperture stop St, and lenses L34 to L39. The front partial group GF consists of lenses L11 and L12. The vibration-proof group consists of lenses L34 to L36.

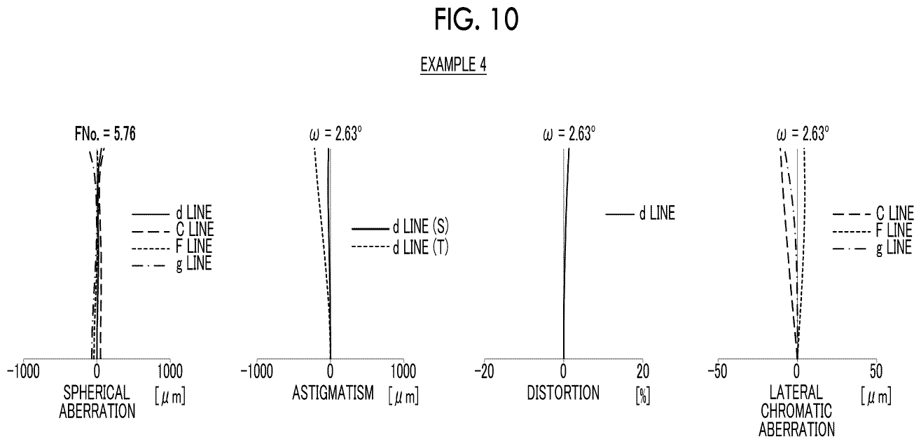

Regarding the imaging lens of Example 4, Table 7 shows basic lens data, Table 8 shows specifications, and FIG. 10 shows a diagram of aberrations.

TABLE 7
Example 4

| Sn | R | D | Nd | νd | θgF | SG |
|---|---|---|---|---|---|---|
| 1 | 131.3732 | 11.2000 | 1.43700 | 95.10 | 0.53364 | 3.53 |
| 2 | 2005.9737 | 15.0899 | | | | |
| 3 | 147.0229 | 8.4599 | 1.43700 | 95.10 | 0.53364 | 3.53 |
| 4 | 753.9482 | 37.7525 | | | | |
| 5 | 112.0226 | 9.4264 | 1.43700 | 95.10 | 0.53364 | 3.53 |
| 6 | −298.1550 | 1.7000 | 1.78800 | 47.37 | 0.55598 | 4.30 |
| 7 | 227.5320 | 11.6780 | | | | |
| 8 | 72.3555 | 8.9993 | 1.43700 | 95.10 | 0.53364 | 3.53 |
| 9 | −446.2811 | 1.5790 | 1.51633 | 64.14 | 0.53531 | 2.52 |
| 10 | 56.0975 | 36.9700 | | | | |
| 11 | 74.9343 | 5.0744 | 1.43700 | 95.10 | 0.53364 | 3.53 |
| 12 | 515.6342 | 4.5139 | | | | |
| 13 | −147.1780 | 4.0866 | 1.72151 | 29.23 | 0.60541 | 3.07 |
| 14 | −41.1754 | 1.4951 | 1.88300 | 40.76 | 0.56679 | 5.52 |
| 15 | 43.8150 | 13.7411 | 1.51823 | 58.90 | 0.54567 | 2.48 |
| 16 | −44.4817 | 10.4268 | | | | |
| 17(St) | ∞ | 12.3381 | | | | |
| 18 | 185.1240 | 5.2826 | 1.66755 | 41.96 | 0.57417 | 3.80 |
| 19 | −23.1174 | 1.0373 | 1.55200 | 70.70 | 0.54219 | 3.74 |
| 20 | 35.6033 | 4.2998 | | | | |
| 21 | −49.4831 | 1.0000 | 1.83481 | 42.72 | 0.56477 | 4.57 |
| 22 | 73.9162 | 1.4500 | | | | |
| 23 | 67.1230 | 1.5000 | 1.69895 | 30.05 | 0.60282 | 2.94 |
| 24 | −277.3736 | 1.0000 | | | | |
| 25 | 133.3428 | 6.8511 | 1.85896 | 22.73 | 0.62844 | 3.71 |
| 26 | −19.9258 | 1.2000 | 2.00272 | 19.32 | 0.64514 | 5.08 |
| 27 | −90.0576 | 113.5636 | | | | |

TABLE 8
Example 4

| | |
|---|---|
| f | 586.74 |
| Bf | 113.57 |
| FNo. | 5.76 |
| 2ω[°] | 5.26 |

### Example 5

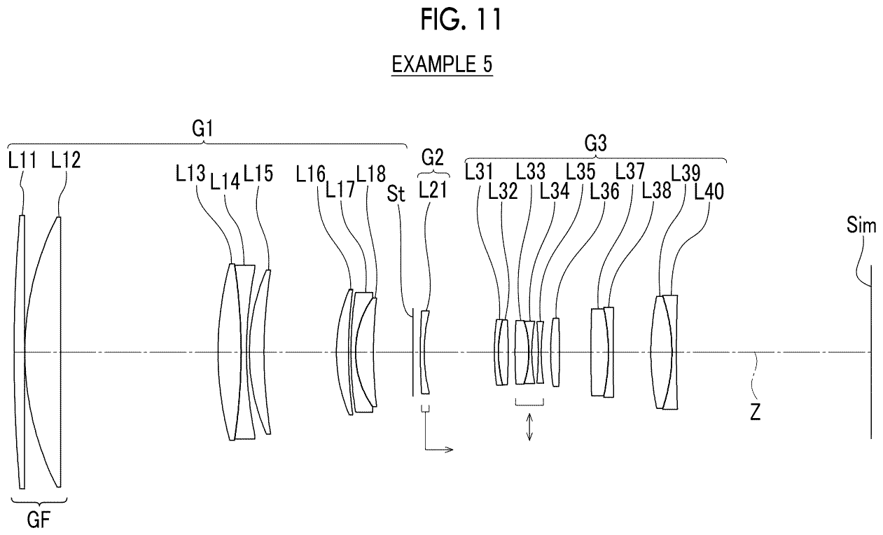

A cross-sectional view of a configuration of an imaging lens of Example 5 is shown in FIG. 11. The imaging lens of Example 5 consists of, in order from the object side to the image side, a first lens group G1 having a positive refractive power, a second lens group G2 having a negative refractive power, and a third lens group G3 having a negative refractive power. During focusing from the infinite distance object to the nearest object, the second lens group G2 moves toward the image side, and the first lens group G1 and the third lens group G3 remain stationary with respect to the image plane Sim.

The first lens group G1 consists of, in order from the object side to the image side, lenses L11 to L18 and an aperture stop St. The second lens group G2 consists of a lens L21. The third lens group G3 consists of, in order from the object side to the image side, lenses L31 to L40. The front partial group GF consists of lenses L11 and L12. The vibration-proof group consists of lenses L33 to L35.

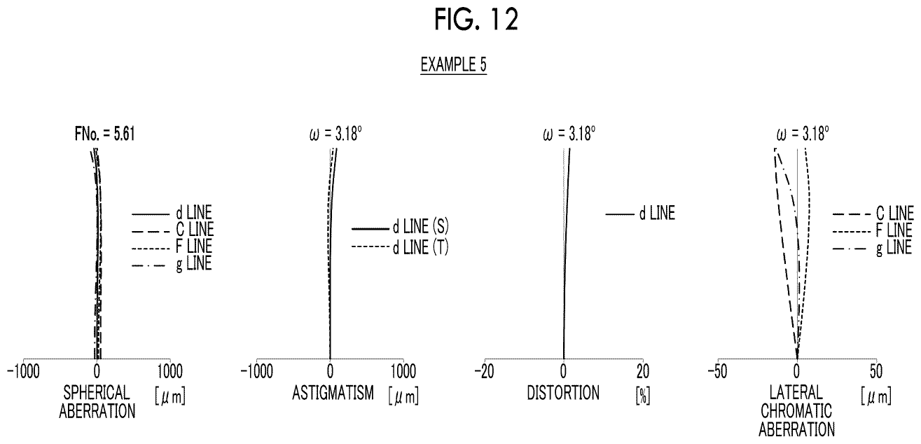

Regarding the imaging lens of Example 5, Table 9 shows basic lens data, Table 10 shows specifications, and FIG. 12 shows a diagram of aberrations.

TABLE 9
Example 5

| Sn | R | D | Nd | νd | θgF | SG |
|---|---|---|---|---|---|---|
| 1 | 515.3911 | 3.2770 | 1.62004 | 36.26 | 0.58800 | 2.69 |
| 2 | ∞ | 0.1500 | | | | |
| 3 | 94.5474 | 11.3351 | 1.43700 | 95.10 | 0.53364 | 3.53 |
| 4 | ∞ | 50.0000 | | | | |
| 5 | 105.7487 | 7.3414 | 1.43700 | 95.10 | 0.53364 | 3.53 |
| 6 | −183.0584 | 1.7000 | 1.90265 | 35.77 | 0.58156 | 4.91 |
| 7 | 132.1536 | 0.9120 | | | | |
| 8 | 64.8965 | 4.6421 | 1.43700 | 95.10 | 0.53364 | 3.53 |
| 9 | 156.5033 | 22.9882 | | | | |
| 10 | 50.4850 | 3.8572 | 1.80518 | 25.46 | 0.61572 | 3.36 |
| 11 | 147.1121 | 0.7739 | | | | |
| 12 | 124.2560 | 1.4479 | 1.87070 | 40.73 | 0.56825 | 4.84 |
| 13 | 30.0767 | 5.6942 | 1.43700 | 95.10 | 0.53364 | 3.53 |
| 14 | 147.9645 | 12.6004 | | | | |
| 15(St) | ∞ | 2.3007 | | | | |
| 16 | 213.6733 | 1.2000 | 1.67790 | 55.35 | 0.54339 | 3.59 |
| 17 | 50.3476 | 22.1176 | | | | |
| 18 | 75.1605 | 1.3000 | 2.00272 | 19.32 | 0.64514 | 5.08 |
| 19 | 40.5569 | 3.1075 | 1.63980 | 34.47 | 0.59233 | 2.76 |
| 20 | −204.0954 | 2.2000 | | | | |
| 21 | 179.6844 | 4.3956 | 1.62004 | 36.26 | 0.58800 | 2.69 |
| 22 | −32.6332 | 0.9100 | 1.59349 | 67.00 | 0.53667 | 3.14 |
| 23 | 52.1016 | 2.0689 | | | | |
| 24 | −98.6965 | 0.9000 | 1.81600 | 46.62 | 0.55682 | 5.07 |
| 25 | 62.3794 | 3.0000 | | | | |
| 26 | 71.9221 | 2.8156 | 1.58144 | 40.75 | 0.57757 | 2.59 |
| 27 | −288.0124 | 10.0000 | | | | |
| 28 | 516.3370 | 5.5449 | 1.51742 | 52.43 | 0.55649 | 2.46 |
| 29 | −66.6746 | 1.5100 | 1.59349 | 67.00 | 0.53667 | 3.14 |
| 30 | 976.5881 | 12.0000 | | | | |
| 31 | 86.8390 | 6.6890 | 1.58144 | 40.75 | 0.57757 | 2.59 |
| 32 | −55.1346 | 1.4000 | 1.61800 | 63.39 | 0.54015 | 3.52 |
| 33 | 485.0718 | 61.8474 | | | | |

TABLE 10
Example 5

| | |
|---|---|
| f | 484.96 |
| Bf | 61.84 |
| FNo. | 5.61 |
| 2ω[°] | 6.36 |

### Example 6

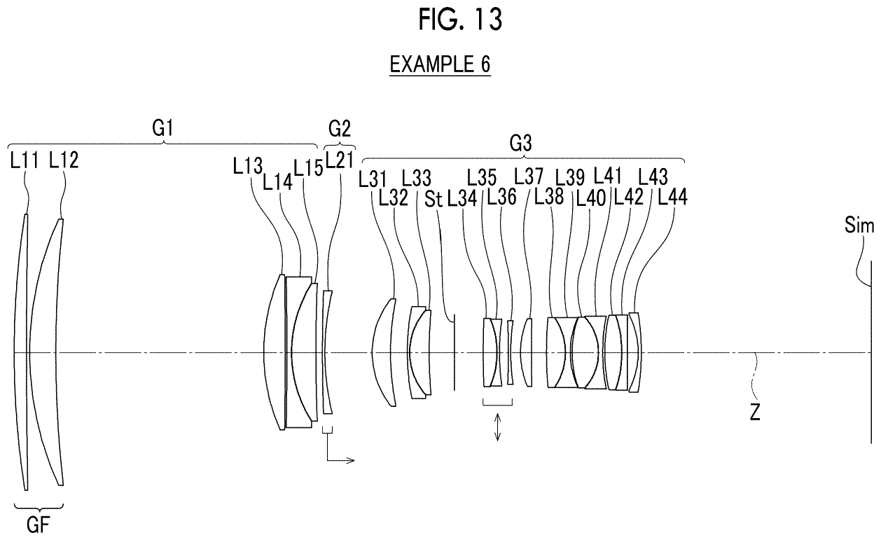

A cross-sectional view of a configuration of an imaging lens of Example 6 is shown in FIG. 13. The imaging lens of Example 6 consists of, in order from the object side to the image side, a first lens group G1 having a positive refractive power, a second lens group G2 having a negative refractive power, and a third lens group G3 having a negative refractive power. During focusing from the infinite distance object to the nearest object, the second lens group G2 moves toward the image side, and the first lens group G1 and the third lens group G3 remain stationary with respect to the image plane Sim.

The first lens group G1 consists of, in order from the object side to the image side, lenses L11 to L15. The second lens group G2 consists of a lens L21. The third lens group G3 consists of, in order from the object side to the image side, lenses L31 to L33, an aperture stop St, and lenses L34 to L44. The front partial group GF consists of lenses L11 and L12. The vibration-proof group consists of lenses L34 to L36.

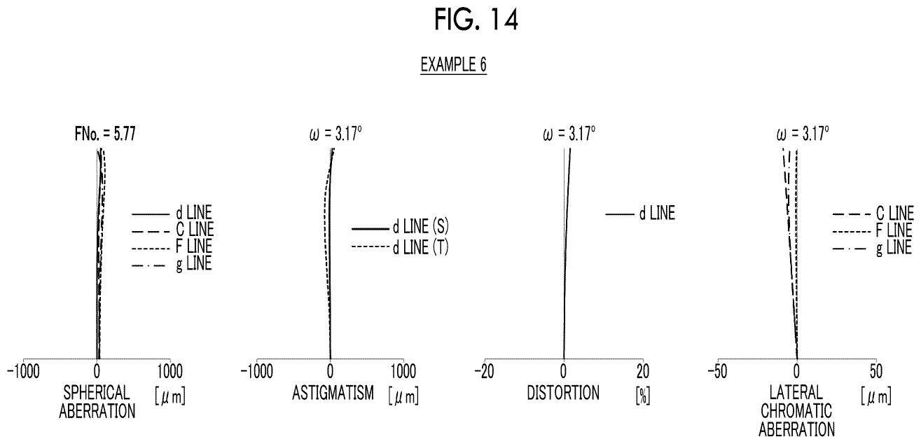

Regarding the imaging lens of Example 6, Table 11 shows basic lens data, Table 12 shows specifications, and FIG. 14 shows a diagram of aberrations.

TABLE 11
Example 6

| Sn | R | D | Nd | νd | θgF | SG |
|---|---|---|---|---|---|---|
| 1 | 277.9460 | 3.8514 | 1.72825 | 28.46 | 0.60772 | 3.06 |
| 2 | 2360.5204 | 0.9996 | | | | |
| 3 | 98.9768 | 8.1940 | 1.49700 | 81.61 | 0.53887 | 3.70 |
| 4 | 375.1901 | 64.9996 | | | | |
| 5 | 59.4945 | 6.6722 | 1.43700 | 95.10 | 0.53364 | 3.53 |
| 6 | −1739.2525 | 0.5000 | | | | |
| 7 | −1451.4313 | 1.5158 | 1.70154 | 41.02 | 0.57580 | 3.63 |
| 8 | 39.6503 | 7.6023 | 1.43700 | 95.10 | 0.53364 | 3.53 |
| 9 | 542.2491 | 1.9996 | | | | |
| 10 | 479.5312 | 0.7998 | 1.81600 | 46.62 | 0.55682 | 5.07 |
| 11 | 78.9241 | 14.7868 | | | | |
| 12 | 26.6444 | 5.7297 | 1.49700 | 81.61 | 0.53887 | 3.70 |
| 13 | 81.4904 | 5.2572 | | | | |
| 14 | 72.0635 | 0.7496 | 1.95375 | 32.32 | 0.59015 | 5.10 |
| 15 | 19.8827 | 6.0719 | 1.49700 | 81.61 | 0.53887 | 3.70 |
| 16 | 137.2748 | 7.7823 | | | | |
| 17(St) | ∞ | 8.9746 | | | | |
| 18 | 265.0473 | 4.3024 | 1.84666 | 23.84 | 0.62012 | 3.50 |
| 19 | −27.2216 | 0.7596 | 1.80279 | 46.76 | 0.55727 | 4.65 |
| 20 | 68.1466 | 2.8016 | | | | |
| 21 | −218.4854 | 0.7496 | 1.98613 | 16.48 | 0.66558 | 3.54 |
| 22 | 69.7941 | 3.0445 | | | | |
| 23 | 27.1370 | 3.4319 | 1.51742 | 52.43 | 0.55649 | 2.46 |
| 24 | 915.8881 | 4.6618 | | | | |
| 25 | 113.9322 | 5.9547 | 1.59551 | 39.22 | 0.58110 | 2.62 |
| 26 | −18.9813 | 1.5096 | 1.52841 | 76.45 | 0.53954 | 3.76 |
| 27 | 26.5855 | 0.5931 | | | | |
| 28 | 32.7722 | 8.2541 | 1.78880 | 28.43 | 0.60092 | 3.33 |
| 29 | −16.2444 | 1.2992 | 1.92119 | 23.96 | 0.62025 | 3.84 |
| 30 | 61.9408 | 0.6379 | | | | |
| 31 | 52.1270 | 5.3195 | 1.84666 | 23.84 | 0.62012 | 3.50 |
| 32 | −36.4012 | 1.7599 | 1.72916 | 54.68 | 0.54484 | 4.02 |
| 33 | 4396.3548 | 3.3445 | | | | |
| 34 | −26.0145 | 1.0003 | 1.55032 | 75.50 | 0.54001 | 4.09 |
| 35 | −77.3066 | 71.8970 | | | | |

TABLE 12
Example 6

| | |
|---|---|
| f | 485.72 |
| Bf | 71.89 |
| FNo. | 5.77 |
| 2ω[°] | 6.34 |

### Example 7

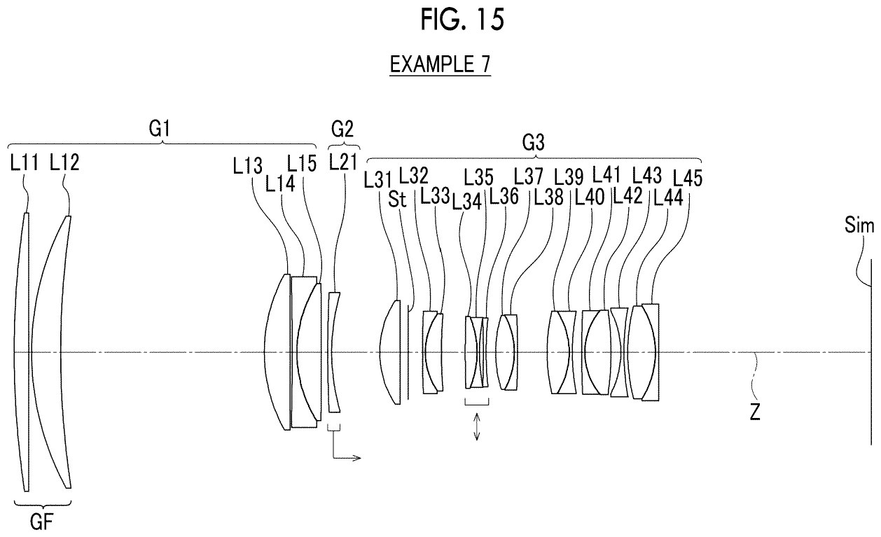

A cross-sectional view of a configuration of an imaging lens of Example 7 is shown in FIG. 15. The imaging lens of Example 7 consists of, in order from the object side to the image side, a first lens group G1 having a positive refractive power, a second lens group G2 having a negative refractive power, and a third lens group G3 having a negative refractive power. During focusing from the infinite distance object to the nearest object, the second lens group G2 moves toward the image side, and the first lens group G1 and the third lens group G3 remain stationary with respect to the image plane Sim.

The first lens group G1 consists of, in order from the object side to the image side, lenses L11 to L15. The second lens group G2 consists of a lens L21. The third lens group G3 consists of, in order from the object side to the image side, a lens L31, an aperture stop St, and lenses L32 to L45. The front partial group GF consists of lenses L11 and L12. The vibration-proof group consists of lenses L34 to L36.

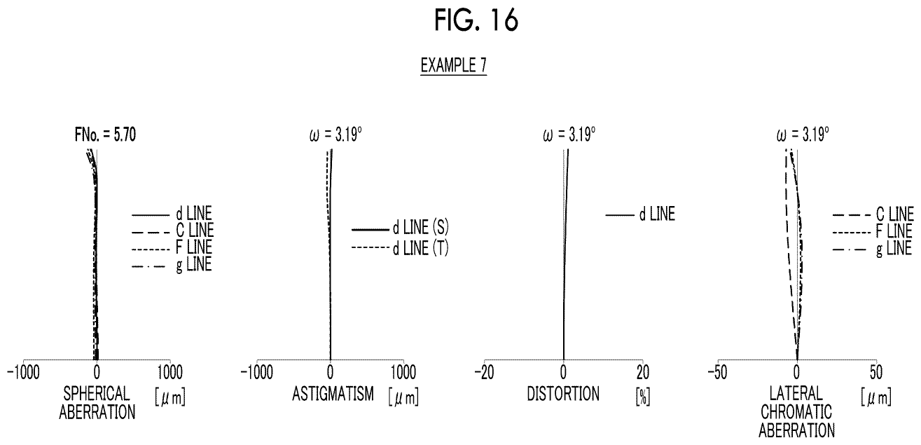

Regarding the imaging lens of Example 7, Table 13 shows basic lens data, Table 14 shows specifications, and FIG. 16 shows a diagram of aberrations.

TABLE 13
Example 7

| Sn | R | D | Nd | νd | θgF | SG |
|---|---|---|---|---|---|---|
| 1 | 287.9986 | 4.5000 | 1.63980 | 34.47 | 0.59233 | 2.76 |
| 2 | ∞ | 0.9510 | | | | |
| 3 | 88.2297 | 9.0900 | 1.49700 | 81.61 | 0.53887 | 3.70 |
| 4 | 279.4780 | 63.5240 | | | | |
| 5 | 49.8839 | 8.0000 | 1.43700 | 95.10 | 0.53364 | 3.53 |
| 6 | ∞ | 0.6970 | | | | |
| 7 | −1153.3576 | 1.5000 | 1.80420 | 46.50 | 0.55727 | 4.40 |
| 8 | 39.8871 | 7.5900 | 1.43700 | 95.10 | 0.53364 | 3.53 |
| 9 | −1962.8727 | 2.0010 | | | | |
| 10 | 395.3446 | 1.2200 | 1.69680 | 55.46 | 0.54260 | 3.67 |
| 11 | 64.9927 | 15.0000 | | | | |
| 12 | 29.4999 | 6.3200 | 1.49700 | 81.61 | 0.53887 | 3.70 |
| 13 | ∞ | 2.5590 | | | | |
| 14(St) | ∞ | 4.4860 | | | | |
| 15 | 346.7425 | 0.8800 | 1.92119 | 23.96 | 0.62025 | 3.84 |
| 16 | 20.9662 | 4.8700 | 1.55032 | 75.50 | 0.54001 | 4.09 |
| 17 | 157.7037 | 7.4000 | | | | |
| 18 | 415.7340 | 3.6700 | 1.84666 | 23.84 | 0.62012 | 3.50 |
| 19 | −29.6829 | 0.7600 | 1.83481 | 42.72 | 0.56477 | 4.57 |
| 20 | 52.4615 | 1.2150 | | | | |
| 21 | −320.5664 | 0.8600 | 1.94595 | 17.98 | 0.65460 | 3.51 |
| 22 | 94.9071 | 2.9990 | | | | |
| 23 | 38.1656 | 5.8300 | 1.63980 | 34.47 | 0.59233 | 2.76 |
| 24 | −23.6923 | 1.0000 | 1.77250 | 49.62 | 0.55038 | 4.28 |
| 25 | −247.6705 | 9.2240 | | | | |
| 26 | 56.5577 | 6.8600 | 1.59551 | 39.24 | 0.58043 | 2.63 |
| 27 | −24.0928 | 1.0000 | 1.49700 | 81.61 | 0.53887 | 3.70 |
| 28 | 64.8246 | 2.9130 | | | | |
| 29 | 297.9934 | 1.0000 | 1.87070 | 40.73 | 0.56825 | 4.84 |
| 30 | 20.3416 | 8.1400 | 1.84666 | 23.84 | 0.62012 | 3.50 |
| 31 | −94.8636 | 3.0670 | | | | |
| 32 | −28.3317 | 0.9700 | 1.49700 | 81.61 | 0.53887 | 3.70 |
| 33 | 75.0160 | 1.2000 | | | | |
| 34 | 57.4938 | 8.6200 | 1.78880 | 28.43 | 0.60092 | 3.33 |
| 35 | −27.1008 | 1.0500 | 1.98613 | 16.48 | 0.66558 | 3.54 |
| 36 | ∞ | 66.3210 | | | | |

TABLE 14
Example 7

| | |
|---|---|
| f | 485.45 |
| Bf | 66.32 |
| FNo. | 5.70 |
| 2ω[°] | 6.38 |

### Example 8

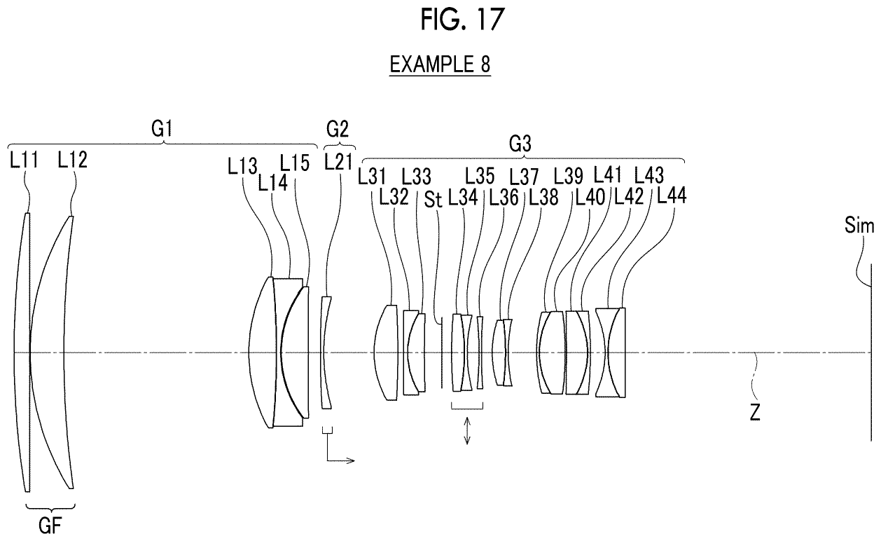

A cross-sectional view of a configuration of an imaging lens of Example 8 is shown in FIG. 17. The imaging lens of Example 8 consists of, in order from the object side to the image side, a first lens group G1 having a positive refractive power, a second lens group G2 having a negative refractive power, and a third lens group G3 having a negative refractive power. During focusing from the infinite distance object to the nearest object, the second lens group G2 moves toward the image side, and the first lens group G1 and the third lens group G3 remain stationary with respect to the image plane Sim.

The first lens group G1 consists of, in order from the object side to the image side, lenses L11 to L15. The second lens group G2 consists of a lens L21. The third lens group G3 consists of, in order from the object side to the image side, lenses L31 to L33, an aperture stop St, and lenses L34 to L44. The front partial group GF consists of lenses L11 and L12. The vibration-proof group consists of lenses L34 to L36.

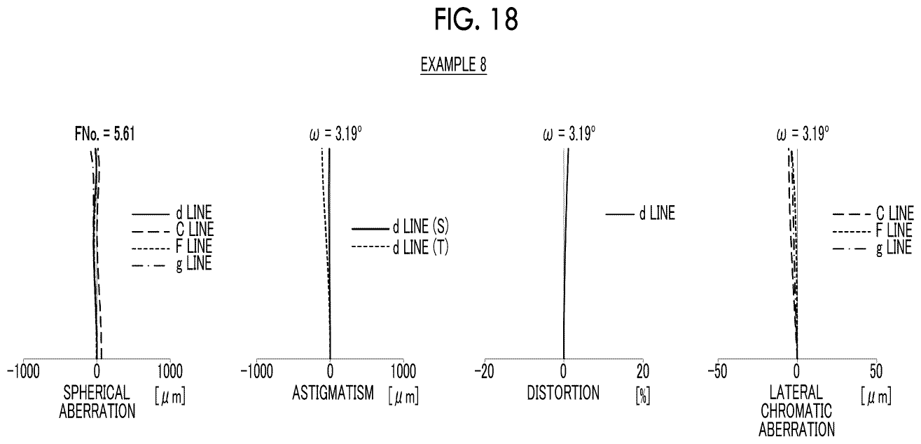

Regarding the imaging lens of Example 8, Table 15 shows basic lens data, Table 16 shows specifications, and FIG. 18 shows a diagram of aberrations.

TABLE 15
Example 8

| Sn | R | D | Nd | νd | θgF | SG |
|---|---|---|---|---|---|---|
| 1 | 268.5525 | 4.8646 | 1.57501 | 41.50 | 0.57672 | 2.58 |
| 2 | −165142.7832 | 0.1500 | | | | |
| 3 | 79.4106 | 10.4664 | 1.49700 | 81.61 | 0.53887 | 3.70 |
| 4 | 299.0715 | 57.6656 | | | | |
| 5 | 47.9703 | 8.6288 | 1.43700 | 95.10 | 0.53364 | 3.53 |
| 6 | −254.4155 | 1.3000 | 1.77250 | 49.62 | 0.55038 | 4.28 |
| 7 | 33.4727 | 0.2000 | | | | |
| 8 | 32.8183 | 8.3869 | 1.43700 | 95.10 | 0.53364 | 3.53 |
| 9 | 1831.9762 | 3.8221 | | | | |
| 10 | 303.4099 | 1.0700 | 1.72000 | 50.23 | 0.55214 | 3.86 |
| 11 | 62.3958 | 15.6484 | | | | |
| 12 | 29.2794 | 7.4000 | 1.43700 | 95.10 | 0.53364 | 3.53 |
| 13 | −287.9927 | 1.7924 | | | | |
| 14 | −20483.9622 | 1.3000 | 1.95375 | 32.32 | 0.59015 | 5.10 |
| 15 | 23.6558 | 5.2100 | 1.61800 | 63.33 | 0.54414 | 3.67 |
| 16 | 382.0080 | 5.3000 | | | | |
| 17(St) | ∞ | 3.0000 | | | | |
| 18 | 152.9876 | 4.0300 | 1.98613 | 16.48 | 0.66558 | 3.54 |
| 19 | −59.1405 | 0.8600 | 1.90043 | 37.37 | 0.57668 | 4.90 |
| 20 | 46.7917 | 3.6588 | | | | |
| 21 | −109.4548 | 0.7500 | 1.98613 | 16.48 | 0.66558 | 3.54 |
| 22 | 145.8198 | 3.3740 | | | | |
| 23 | 32.5417 | 4.1500 | 1.64769 | 33.79 | 0.59449 | 2.70 |
| 24 | −73.8511 | 0.8100 | 1.59282 | 68.62 | 0.54414 | 4.13 |
| 25 | 45.1858 | 8.8307 | | | | |
| 26 | 49.7232 | 0.9076 | 1.98613 | 16.48 | 0.66558 | 3.54 |
| 27 | 24.5387 | 8.0100 | 1.77047 | 29.74 | 0.59514 | 3.34 |
| 28 | −102.0660 | 0.4150 | | | | |
| 29 | −697.5977 | 6.5757 | 1.72825 | 28.32 | 0.60755 | 3.01 |
| 30 | −25.5736 | 0.9100 | 1.70300 | 52.38 | 0.55070 | 3.85 |
| 31 | −128.2679 | 4.5691 | | | | |
| 32 | −29.5878 | 0.9100 | 1.55032 | 75.50 | 0.54001 | 4.09 |
| 33 | 28.1809 | 5.3991 | 1.58144 | 40.75 | 0.57757 | 2.59 |
| 34 | −1818.5237 | 76.6671 | | | | |

TABLE 16
Example 8

| | |
|---|---|
| f | 485.05 |
| Bf | 76.66 |
| FNo. | 5.61 |
| 2ω[°] | 6.38 |

### Example 9

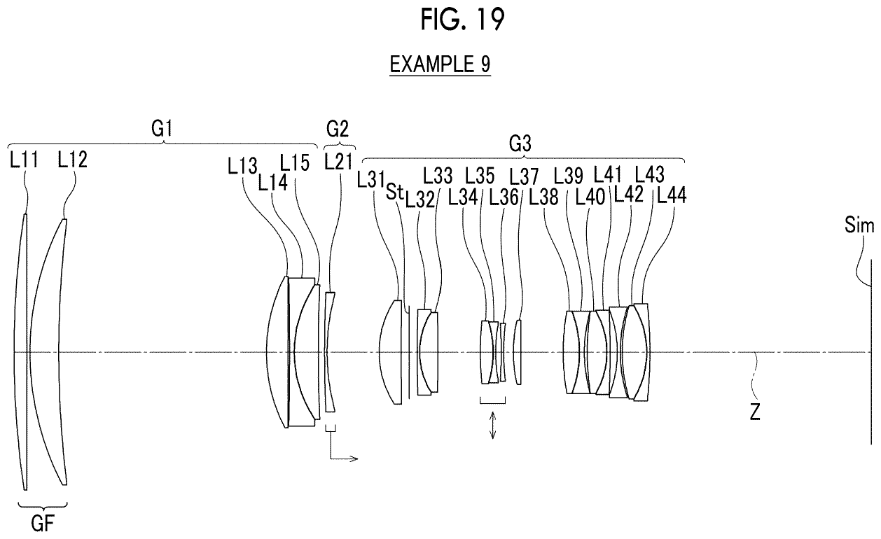

A cross-sectional view of a configuration of an imaging lens of Example 9 is shown in FIG. 19. The imaging lens of Example 9 consists of, in order from the object side to the image side, a first lens group G1 having a positive refractive power, a second lens group G2 having a negative refractive power, and a third lens group G3 having a negative refractive power. During focusing from the infinite distance object to the nearest object, the second lens group G2 moves toward the image side, and the first lens group G1 and the third lens group G3 remain stationary with respect to the image plane Sim.

The first lens group G1 consists of, in order from the object side to the image side, lenses L11 to L15. The second lens group G2 consists of a lens L21. The third lens group G3 consists of, in order from the object side to the image side, a lens L31, an aperture stop St, and lenses L32 to L44. The front partial group GF consists of lenses L11 and L12. The vibration-proof group consists of lenses L34 to L36.

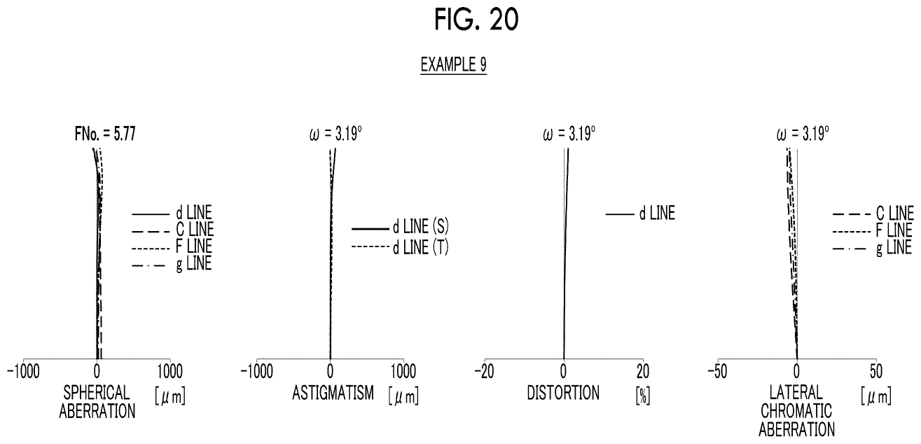

Regarding the imaging lens of Example 9, Table 17 shows basic lens data, Table 18 shows specifications, and FIG. 20 shows a diagram of aberrations.

TABLE 17
Example 9

| Sn | R | D | Nd | νd | θgF | SG |
|---|---|---|---|---|---|---|
| 1 | 297.6967 | 3.9862 | 1.59551 | 39.22 | 0.58042 | 2.62 |
| 2 | ∞ | 0.9996 | | | | |
| 3 | 89.7046 | 8.9973 | 1.49700 | 81.61 | 0.53887 | 3.70 |
| 4 | 336.4963 | 65.0005 | | | | |
| 5 | 50.8532 | 6.7223 | 1.43700 | 95.10 | 0.53364 | 3.53 |
| 6 | −32735878.1371 | 0.5000 | | | | |
| 7 | −1066.7714 | 1.4995 | 1.71700 | 47.93 | 0.56062 | 4.25 |
| 8 | 37.0337 | 7.4836 | 1.43700 | 95.10 | 0.53364 | 3.53 |
| 9 | 418.8753 | 2.0000 | | | | |
| 10 | 436.7908 | 0.7997 | 1.72916 | 54.54 | 0.54535 | 4.05 |
| 11 | 69.9122 | 16.2496 | | | | |
| 12 | 29.6567 | 6.9191 | 1.49700 | 81.61 | 0.53887 | 3.70 |
| 13 | 1095.7555 | 2.4996 | | | | |
| 14(St) | ∞ | 2.4996 | | | | |
| 15 | 357.1660 | 0.7817 | 1.95375 | 32.32 | 0.59015 | 5.10 |
| 16 | 23.4788 | 5.7212 | 1.49700 | 81.61 | 0.53887 | 3.70 |
| 17 | −550.7811 | 13.1138 | | | | |
| 18 | 104.4794 | 4.0384 | 1.86966 | 20.02 | 0.64349 | 3.37 |
| 19 | −31.8329 | 0.7596 | 1.83481 | 42.72 | 0.56486 | 4.73 |
| 20 | 49.7175 | 1.7500 | | | | |
| 21 | −134.9573 | 0.7514 | 1.98613 | 16.48 | 0.66558 | 3.54 |
| 22 | 70.8025 | 3.0165 | | | | |
| 23 | 41.9618 | 2.3939 | 1.64769 | 33.84 | 0.59243 | 2.77 |
| 24 | 12823.1715 | 13.2420 | | | | |
| 25 | 72.4455 | 5.0964 | 1.72825 | 28.32 | 0.60755 | 3.01 |
| 26 | −35.7882 | 1.5128 | 1.55032 | 75.50 | 0.54001 | 4.09 |
| 27 | 46.3562 | 0.8941 | | | | |
| 28 | 81.3272 | 6.1624 | 1.71736 | 29.50 | 0.60404 | 3.05 |
| 29 | −25.4742 | 0.9995 | 1.87070 | 40.73 | 0.56825 | 4.84 |
| 30 | −284.1692 | 2.2613 | | | | |
| 31 | −36.7335 | 0.9496 | 1.49700 | 81.61 | 0.53887 | 3.70 |
| 32 | 46.0764 | 0.5997 | | | | |
| 33 | 50.1020 | 7.6809 | 1.78880 | 28.43 | 0.60092 | 3.33 |
| 34 | −27.9235 | 0.9996 | 1.98613 | 16.48 | 0.66558 | 3.54 |
| 35 | −140.0770 | 69.2756 | | | | |

TABLE 18
Example 9

| | |
|---|---|
| f | 485.36 |
| Bf | 69.27 |
| FNo. | 5.77 |
| 2ω[°] | 6.38 |

### Example 10

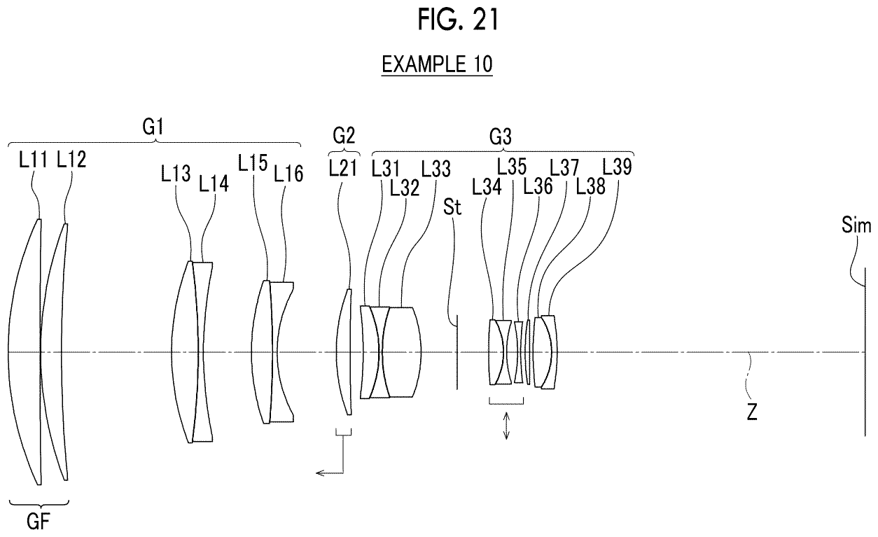

A cross-sectional view of a configuration of an imaging lens of Example 10 is shown in FIG. 21. The imaging lens of Example 10 consists of, in order from the object side to the image side, a first lens group G1 having a positive refractive power, a second lens group G2 having a positive refractive power, and a third lens group G3 having a negative refractive power. During focusing from the infinite distance object to the nearest object, the second lens group G2 moves toward the object side, and the first lens group G1 and the third lens group G3 remain stationary with respect to the image plane Sim.

The first lens group G1 consists of, in order from the object side to the image side, lenses L11 to L16. The second lens group G2 consists of a lens L21. The third lens group G3 consists of, in order from the object side to the image side, lenses L31 to L33, an aperture stop St, and lenses L34 to L39. The front partial group GF consists of lenses L11 and L12. The vibration-proof group consists of lenses L34 to L36.

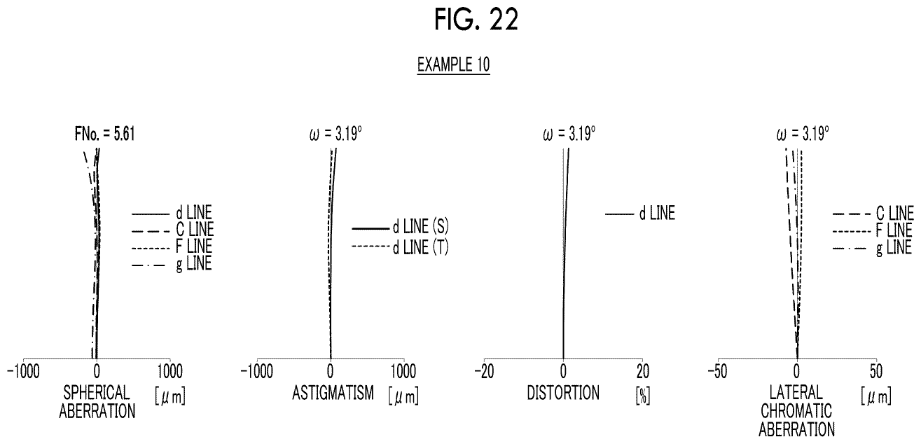

Regarding the imaging lens of Example 10, Table 19 shows basic lens data, Table 20 shows specifications, and FIG. 22 shows a diagram of aberrations.

TABLE 19
Example 10

| Sn | R | D | Nd | νd | θgF | SG |
|---|---|---|---|---|---|---|
| 1 | 101.7771 | 10.4176 | 1.43700 | 95.10 | 0.53364 | 3.53 |
| 2 | 2677.6121 | 0.2184 | | | | |
| 3 | 116.3174 | 6.8010 | 1.43700 | 95.10 | 0.53364 | 3.53 |
| 4 | 429.7597 | 36.0005 | | | | |
| 5 | 82.2358 | 8.7101 | 1.43700 | 95.10 | 0.53364 | 3.53 |
| 6 | −219.7857 | 1.7018 | 1.72916 | 54.09 | 0.54490 | 3.98 |
| 7 | 131.1920 | 15.6766 | | | | |
| 8 | 70.0959 | 6.9083 | 1.43700 | 95.10 | 0.53364 | 3.53 |
| 9 | −278.5054 | 1.5116 | 1.51633 | 64.14 | 0.53531 | 2.52 |
| 10 | 42.7057 | 19.3350 | | | | |
| 11 | 58.3817 | 4.5061 | 1.43700 | 95.10 | 0.53364 | 3.53 |
| 12 | 569.7228 | 4.2534 | | | | |
| 13 | −119.5925 | 5.2074 | 1.69895 | 30.05 | 0.60282 | 2.94 |
| 14 | −37.0782 | 1.0492 | 1.88100 | 40.14 | 0.57010 | 5.40 |
| 15 | 45.7113 | 12.6845 | 1.49700 | 81.61 | 0.53887 | 3.70 |
| 16 | −38.9781 | 11.6242 | | | | |
| 17(St) | ∞ | 10.2750 | | | | |
| 18 | 127.2882 | 4.8500 | 1.63980 | 34.47 | 0.59233 | 2.76 |
| 19 | −21.7270 | 1.0100 | 1.55397 | 71.76 | 0.53931 | 3.66 |
| 20 | 31.6996 | 3.5973 | | | | |
| 21 | −45.4825 | 1.0001 | 1.77250 | 49.62 | 0.55038 | 4.28 |
| 22 | 75.6055 | 1.4500 | | | | |
| 23 | 69.2077 | 1.5066 | 1.73800 | 32.33 | 0.59005 | 3.19 |
| 24 | −1294.6307 | 1.1267 | | | | |
| 25 | 102.0584 | 6.0482 | 1.80518 | 25.46 | 0.61572 | 3.36 |
| 26 | −21.2096 | 1.8034 | 2.00272 | 19.32 | 0.64514 | 5.08 |
| 27 | −68.6755 | 100.6734 | | | | |

TABLE 20
Example 10

| | |
|---|---|
| f | 484.88 |
| Bf | 100.67 |
| FNo. | 5.61 |
| 2ω[°] | 6.38 |

### Example 11

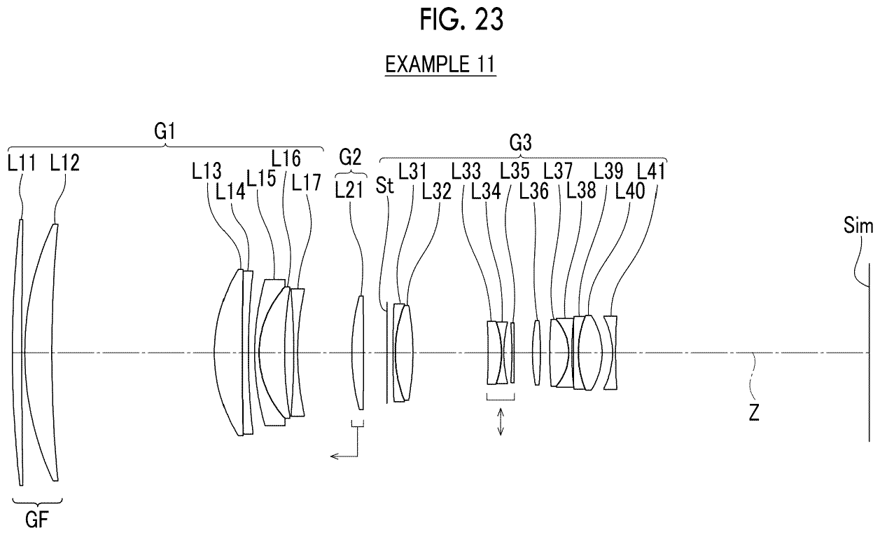

A cross-sectional view of a configuration of an imaging lens of Example 11 is shown in FIG. 23. The imaging lens of Example 11 consists of, in order from the object side to the image side, a first lens group G1 having a positive refractive power, a second lens group G2 having a positive refractive power, and a third lens group G3 having a negative refractive power. During focusing from the infinite distance object to the nearest object, the second lens group G2 moves toward the object side, and the first lens group G1 and the third lens group G3 remain stationary with respect to the image plane Sim.

The first lens group G1 consists of, in order from the object side to the image side, lenses L11 to L17. The second lens group G2 consists of a lens L21. The third lens group G3 consists of, in order from the object side to the image side, an aperture stop St and lenses L31 to L41. The front partial group GF consists of lenses L11 and L12. The vibration-proof group consists of lenses L33 to L35.

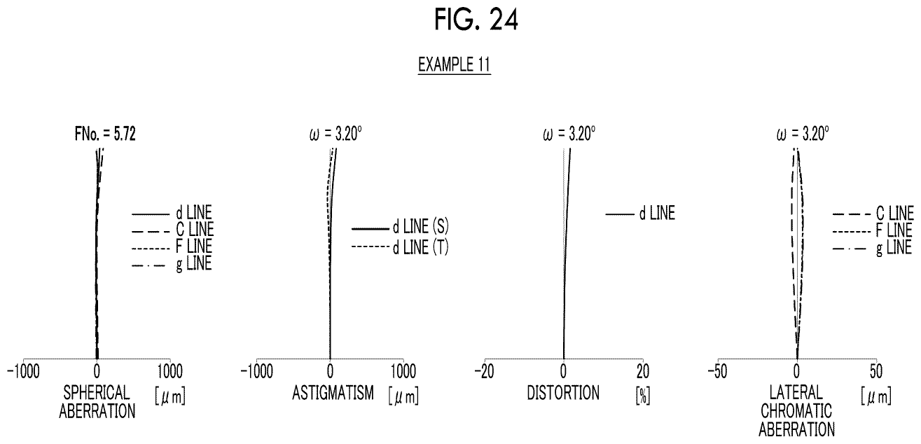

Regarding the imaging lens of Example 11, Table 21 shows basic lens data, Table 22 shows specifications, and FIG. 24 shows a diagram of aberrations.

TABLE 21
Example 11

| Sn | R | D | Nd | νd | θgF | SG |
|---|---|---|---|---|---|---|
| 1 | 381.8946 | 3.0478 | 1.67270 | 32.17 | 0.59825 | 2.90 |
| 2 | 2568.3060 | 0.9996 | | | | |
| 3 | 98.2039 | 8.8026 | 1.49700 | 81.61 | 0.53894 | 3.90 |
| 4 | 448.7031 | 52.8496 | | | | |
| 5 | 50.6964 | 8.9731 | 1.43700 | 95.10 | 0.53364 | 3.53 |
| 6 | 1362.8462 | 1.9996 | 1.72916 | 54.68 | 0.54484 | 4.02 |
| 7 | 236.3407 | 1.9996 | | | | |
| 8 | 84.2771 | 1.4996 | 1.72916 | 54.68 | 0.54484 | 4.02 |
| 9 | 31.2132 | 8.2331 | 1.43700 | 95.10 | 0.53364 | 3.53 |
| 10 | 125.7115 | 2.9997 | | | | |
| 11 | −234.3787 | 1.2496 | 1.72916 | 54.68 | 0.54484 | 4.02 |
| 12 | 91.2940 | 17.6462 | | | | |
| 13 | 70.8464 | 3.8156 | 1.49700 | 81.61 | 0.53894 | 3.90 |
| 14 | −1090.9456 | 7.5856 | | | | |
| 15(St) | ∞ | 1.9996 | | | | |
| 16 | 357.1658 | 0.7496 | 2.00330 | 28.32 | 0.60322 | 5.02 |
| 17 | 42.2983 | 5.7546 | 1.52841 | 76.45 | 0.53954 | 3.76 |
| 18 | −83.7472 | 24.4546 | | | | |
| 19 | −204.7967 | 4.3595 | 1.80810 | 22.70 | 0.62951 | 3.30 |
| 20 | −29.8010 | 0.7596 | 1.72916 | 54.68 | 0.54484 | 4.02 |
| 21 | 40.0811 | 2.5870 | | | | |
| 22 | −136.7725 | 0.7496 | 1.98613 | 16.48 | 0.66558 | 3.54 |
| 23 | 1077.3377 | 5.9861 | | | | |
| 24 | 57.4673 | 2.6303 | 1.84666 | 23.78 | 0.62076 | 3.51 |
| 25 | −102.3295 | 2.9996 | | | | |
| 26 | 127.4390 | 6.1864 | 1.78880 | 28.43 | 0.60092 | 3.33 |
| 27 | −16.2675 | 0.9996 | 1.96300 | 24.11 | 0.62126 | 4.20 |
| 28 | 104.3253 | 0.6024 | | | | |
| 29 | 2223.9413 | 1.5096 | 1.52841 | 76.45 | 0.53954 | 3.76 |
| 30 | 32.6095 | 7.7466 | 1.59551 | 39.22 | 0.58110 | 2.62 |
| 31 | −22.2618 | 3.3707 | | | | |
| 32 | −25.0041 | 0.9996 | 1.59282 | 68.62 | 0.54414 | 4.13 |
| 33 | 163.6449 | 82.3857 | | | | |

TABLE 22
Example 11

| | |
|---|---|
| f | 481.55 |
| Bf | 82.39 |
| FNo. | 5.72 |
| 2ω[°] | 6.40 |

### Example 12

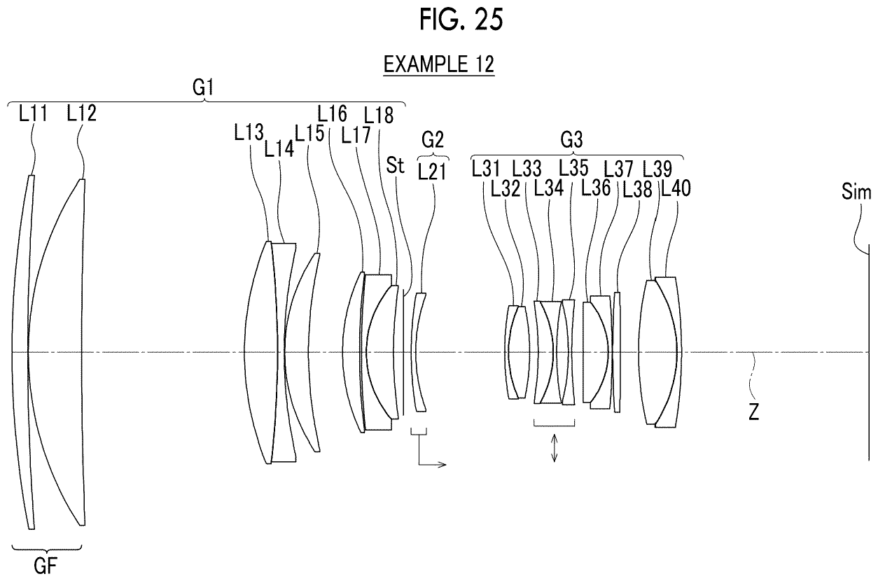

A cross-sectional view of a configuration of an imaging lens of Example 12 is shown in FIG. 25. The imaging lens of Example 12 consists of, in order from the object side to the image side, a first lens group G1 having a positive refractive power, a second lens group G2 having a negative refractive power, and a third lens group G3 having a negative refractive power. During focusing from the infinite distance object to the nearest object, the second lens group G2 moves toward the image side, and the first lens group G1 and the third lens group G3 remain stationary with respect to the image plane Sim.

The first lens group G1 consists of, in order from the object side to the image side, lenses L11 to L18 and an aperture stop St. The second lens group G2 consists of a lens L21. The third lens group G3 consists of, in order from the object side to the image side, lenses L31 to L40. The front partial group GF consists of lenses L11 and L12. The vibration-proof group consists of lenses L33 to L35.

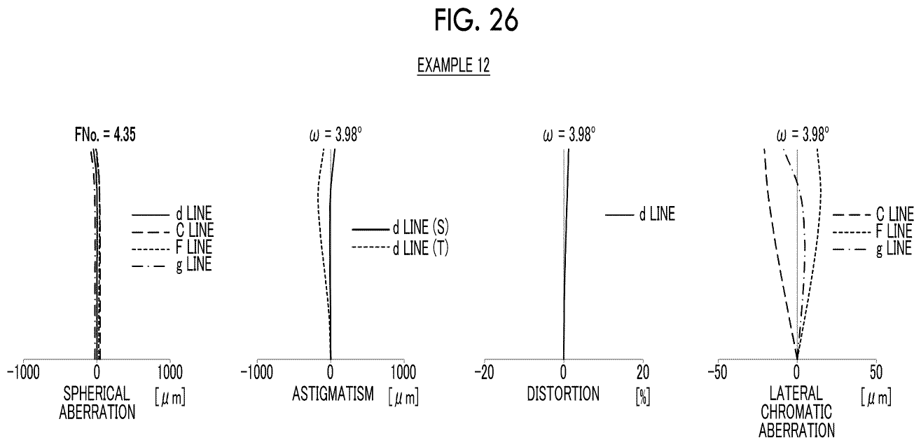

Regarding the imaging lens of Example 12, Table 23 shows basic lens data, Table 24 shows specifications, and FIG. 26 shows a diagram of aberrations.

TABLE 23
Example 12

| Sn | R | D | Nd | νd | θgF | SG |
|---|---|---|---|---|---|---|
| 1 | 240.5751 | 4.0607 | 1.58913 | 61.25 | 0.54038 | 3.27 |
| 2 | 595.5728 | 0.1500 | | | | |
| 3 | 81.2832 | 13.7962 | 1.43700 | 95.10 | 0.53364 | 3.53 |
| 4 | 1115.7283 | 42.0000 | | | | |
| 5 | 75.0453 | 8.5769 | 1.43700 | 95.10 | 0.53364 | 3.53 |
| 6 | −248.0119 | 1.7000 | 1.90043 | 37.37 | 0.57668 | 4.90 |
| 7 | 119.6879 | 0.1500 | | | | |
| 8 | 45.4086 | 6.1692 | 1.43700 | 95.10 | 0.53364 | 3.53 |
| 9 | 109.5752 | 8.7941 | | | | |
| 10 | 47.6260 | 4.3842 | 1.84666 | 23.84 | 0.62012 | 3.50 |
| 11 | 157.3003 | 0.5000 | | | | |
| 12 | 187.9534 | 1.3000 | 1.90043 | 37.37 | 0.57668 | 4.90 |
| 13 | 26.2059 | 7.0100 | 1.43700 | 95.10 | 0.53364 | 3.53 |
| 14 | 112.4115 | 2.5704 | | | | |
| 15(St) | ∞ | 2.0000 | | | | |
| 16 | 87.0029 | 1.2000 | 1.75500 | 52.32 | 0.54757 | 4.17 |
| 17 | 43.2881 | 23.0016 | | | | |
| 18 | 67.4594 | 1.0000 | 2.00100 | 29.13 | 0.59952 | 5.12 |
| 19 | 28.5012 | 5.4622 | 1.59551 | 39.24 | 0.58043 | 2.63 |
| 20 | −57.2158 | 2.2000 | | | | |
| 21 | −81.0280 | 3.8896 | 1.62004 | 36.26 | 0.58800 | 2.69 |
| 22 | −26.9637 | 0.9000 | 1.65160 | 58.54 | 0.53901 | 3.24 |
| 23 | 73.1006 | 3.0275 | | | | |
| 24 | −53.6353 | 0.9000 | 1.75500 | 52.32 | 0.54757 | 4.17 |
| 25 | 123.4120 | 3.0000 | | | | |
| 26 | −1921.9759 | 6.4318 | 1.59551 | 39.24 | 0.58043 | 2.63 |
| 27 | −20.4620 | 1.0000 | 1.69680 | 55.53 | 0.54341 | 3.70 |
| 28 | −172.4735 | 0.1500 | | | | |
| 29 | 248.3213 | 2.0000 | 1.62004 | 36.26 | 0.58800 | 2.69 |
| 30 | −964.5133 | 4.6858 | | | | |
| 31 | 82.1803 | 9.7936 | 1.57099 | 50.80 | 0.55768 | 2.76 |
| 32 | −33.6530 | 1.2000 | 1.61800 | 63.33 | 0.54414 | 3.67 |
| 33 | −118.7126 | 48.4969 | | | | |

TABLE 24
Example 12

| | |
|---|---|
| f | 387.95 |
| Bf | 48.50 |
| FNo. | 4.35 |
| 2ω[°] | 7.96 |

### Example 13

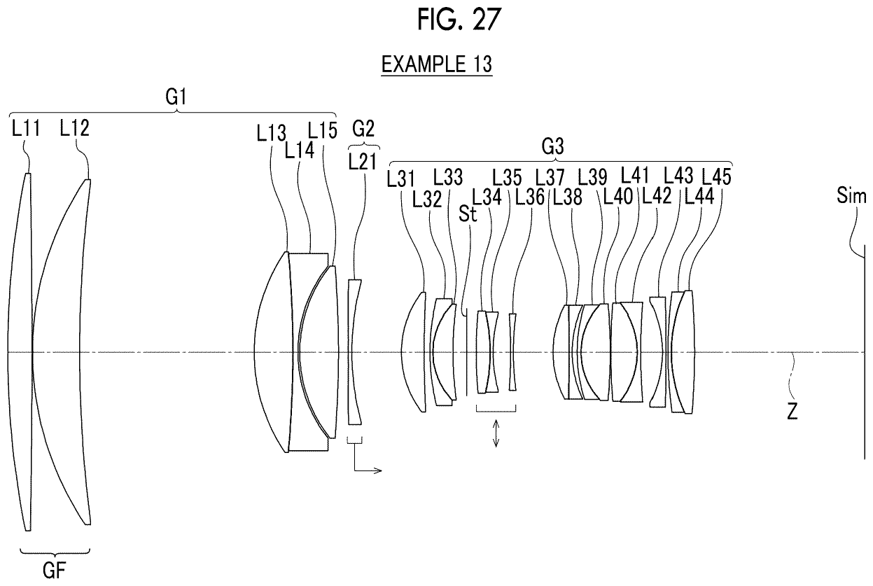

A cross-sectional view of a configuration of an imaging lens of Example 13 is shown in FIG. 27. The imaging lens of Example 13 consists of, in order from the object side to the image side, a first lens group G1 having a positive refractive power, a second lens group G2 having a negative refractive power, and a third lens group G3 having a negative refractive power. During focusing from the infinite distance object to the nearest object, the second lens group G2 moves toward the image side, and the first lens group G1 and the third lens group G3 remain stationary with respect to the image plane Sim.

The first lens group G1 consists of, in order from the object side to the image side, lenses L11 to L15. The second lens group G2 consists of a lens L21. The third lens group G3 consists of, in order from the object side to the image side, lenses L31 to L33, an aperture stop St, and lenses L34 to L45. The front partial group GF consists of lenses L11 and L12. The vibration-proof group consists of lenses L34 to L36.

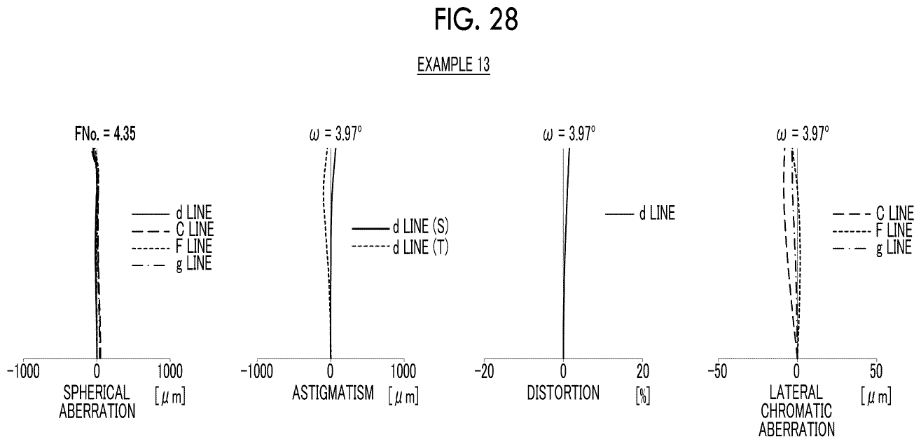

Regarding the imaging lens of Example 13, Table 25 shows basic lens data, Table 26 shows specifications, and FIG. 28 shows a diagram of aberrations.

TABLE 25
Example 13

| Sn | R | D | Nd | νd | θgF | SG |
|---|---|---|---|---|---|---|
| 1 | 233.8957 | 6.2668 | 1.56732 | 42.82 | 0.57309 | 2.57 |
| 2 | −2492.1441 | 0.1500 | | | | |
| 3 | 79.3306 | 12.1929 | 1.49700 | 81.61 | 0.53887 | 3.70 |
| 4 | 345.4609 | 45.0000 | | | | |
| 5 | 45.7090 | 10.0200 | 1.43700 | 95.10 | 0.53364 | 3.53 |
| 6 | −280.0468 | 1.3000 | 1.80420 | 46.50 | 0.55727 | 4.40 |
| 7 | 35.2899 | 0.5000 | | | | |
| 8 | 35.2706 | 10.0000 | 1.43700 | 95.10 | 0.53364 | 3.53 |
| 9 | −268.4867 | 2.5000 | | | | |
| 10 | 1889.1342 | 0.9500 | 1.78590 | 43.93 | 0.56118 | 4.43 |
| 11 | 67.6086 | 12.8237 | | | | |
| 12 | 25.0134 | 5.9068 | 1.43700 | 95.10 | 0.53364 | 3.53 |
| 13 | 300.9340 | 1.5000 | | | | |
| 14 | 56.5114 | 0.7500 | 1.95375 | 32.32 | 0.59015 | 5.10 |
| 15 | 17.6162 | 5.2100 | 1.59551 | 39.24 | 0.58043 | 2.63 |
| 16 | 92.5992 | 3.5000 | | | | |
| 17(St) | ∞ | 2.5000 | | | | |
| 18 | 123.7689 | 3.6000 | 1.98613 | 16.48 | 0.66558 | 3.54 |
| 19 | −44.9696 | 0.7600 | 1.95375 | 32.32 | 0.59015 | 5.10 |
| 20 | 36.9313 | 4.5100 | | | | |
| 21 | −151.6784 | 0.7500 | 1.98613 | 16.48 | 0.66558 | 3.54 |
| 22 | 74.4898 | 10.2475 | | | | |
| 23 | 25.6296 | 4.1500 | 1.67270 | 32.10 | 0.59891 | 2.91 |
| 24 | −684.2810 | 0.8100 | 1.59282 | 68.62 | 0.54414 | 4.13 |
| 25 | 28.3707 | 1.2950 | | | | |
| 26 | 39.4888 | 0.9856 | 1.98613 | 16.48 | 0.66558 | 3.54 |
| 27 | 17.6687 | 7.5612 | 1.72825 | 28.32 | 0.60755 | 3.01 |
| 28 | −132.6856 | 0.1500 | | | | |
| 29 | 153.3877 | 6.8283 | 1.74077 | 27.79 | 0.60961 | 3.10 |
| 30 | −20.2439 | 0.9100 | 1.72916 | 54.68 | 0.54451 | 4.18 |
| 31 | 155.8818 | 5.5000 | | | | |
| 32 | −28.4685 | 0.9000 | 1.57144 | 71.61 | 0.54193 | 4.11 |
| 33 | −677.6240 | 0.5000 | | | | |
| 34 | 112.4879 | 0.9100 | 1.59282 | 68.62 | 0.54414 | 4.13 |
| 35 | 37.2731 | 6.0000 | 1.59551 | 39.24 | 0.58043 | 2.63 |
| 36 | −180.2385 | 43.9914 | | | | |

TABLE 26
Example 13

| | |
|---|---|
| f | 388.14 |
| Bf | 43.99 |
| FNo. | 4.35 |
| 2ω[°] | 7.94 |

### Example 14

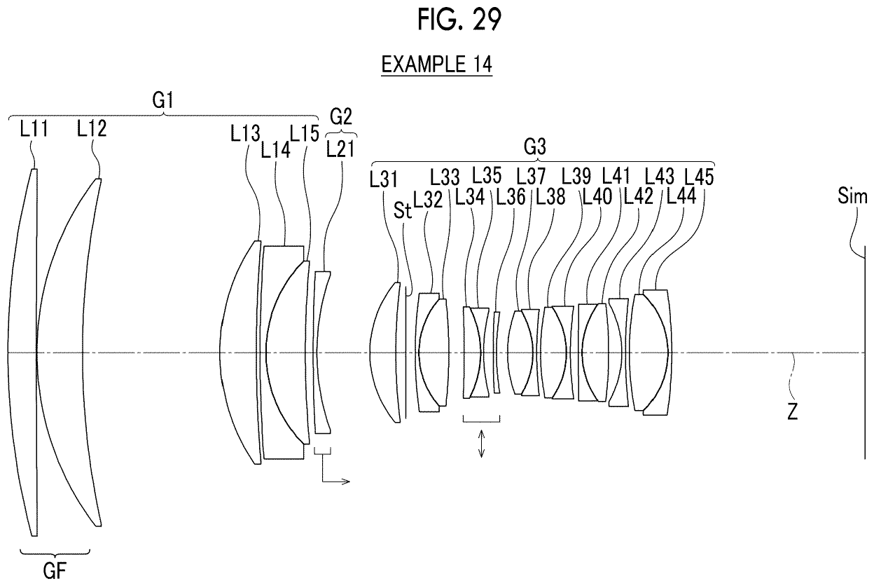

A cross-sectional view of a configuration of an imaging lens of Example 14 is shown in FIG. 29. The imaging lens of Example 14 consists of, in order from the object side to the image side, a first lens group G1 having a positive refractive power, a second lens group G2 having a negative refractive power, and a third lens group G3 having a negative refractive power. During focusing from the infinite distance object to the nearest object, the second lens group G2 moves toward the image side, and the first lens group G1 and the third lens group G3 remain stationary with respect to the image plane Sim.

The first lens group G1 consists of, in order from the object side to the image side, lenses L11 to L15. The second lens group G2 consists of a lens L21. The third lens group G3 consists of, in order from the object side to the image side, a lens L31, an aperture stop St, and lenses L32 to L45. The front partial group GF consists of lenses L11 and L12. The vibration-proof group consists of lenses L34 to L36.

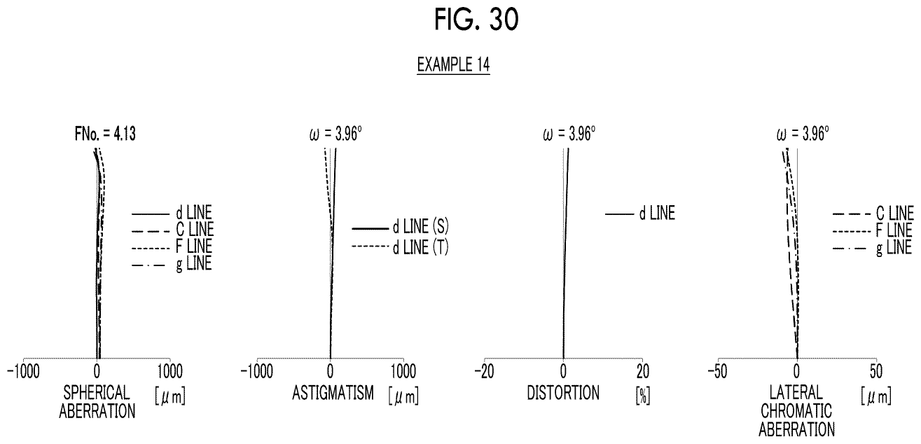

Regarding the imaging lens of Example 14, Table 27 shows basic lens data, Table 28 shows specifications, and FIG. 30 shows a diagram of aberrations.

TABLE 27
Example 14

| Sn | R | D | Nd | νd | θgF | SG |
|---|---|---|---|---|---|---|
| 1 | 182.9406 | 7.3835 | 1.68960 | 31.14 | 0.60319 | 3.26 |
| 2 | 4194.3781 | 0.1500 | | | | |
| 3 | 73.5574 | 11.8254 | 1.49700 | 81.61 | 0.53887 | 3.70 |
| 4 | 204.2556 | 35.6162 | | | | |
| 5 | 50.7856 | 9.3258 | 1.45860 | 90.19 | 0.53516 | 3.63 |
| 6 | 327.9071 | 1.0000 | | | | |
| 7 | 375.8726 | 1.5233 | 1.83400 | 37.34 | 0.57908 | 4.57 |
| 8 | 33.3280 | 10.2278 | 1.43700 | 95.10 | 0.53364 | 3.53 |
| 9 | 255.8621 | 2.0000 | | | | |
| 10 | 362.0249 | 1.0000 | 1.77250 | 49.62 | 0.55038 | 4.28 |
| 11 | 59.0497 | 13.7299 | | | | |
| 12 | 27.9941 | 6.7347 | 1.55032 | 75.50 | 0.54001 | 4.09 |
| 13 | 138.0773 | 2.5438 | | | | |
| 14(St) | ∞ | 2.5000 | | | | |
| 15 | 112.2283 | 0.9586 | 1.92119 | 23.96 | 0.62025 | 3.84 |
| 16 | 20.5091 | 7.7758 | 1.55032 | 75.50 | 0.54001 | 4.09 |
| 17 | −118.7074 | 3.9336 | | | | |
| 18 | −332.9669 | 4.2888 | 1.84666 | 23.84 | 0.62012 | 3.50 |
| 19 | −25.1811 | 0.7500 | 1.84850 | 43.79 | 0.56197 | 5.08 |
| 20 | 41.2213 | 2.5000 | | | | |
| 21 | 167.7919 | 0.8600 | 1.98613 | 16.48 | 0.66558 | 3.54 |
| 22 | 59.6906 | 2.9000 | | | | |
| 23 | 30.8193 | 6.5726 | 1.62004 | 36.26 | 0.58800 | 2.69 |
| 24 | −20.5619 | 1.0000 | 1.75500 | 52.32 | 0.54757 | 4.17 |
| 25 | 100.7407 | 1.0000 | | | | |
| 26 | 63.1051 | 6.6973 | 1.62004 | 36.26 | 0.58800 | 2.69 |
| 27 | −20.0919 | 1.0000 | 1.49700 | 81.61 | 0.53887 | 3.70 |
| 28 | 79.9084 | 2.0832 | | | | |
| 29 | 875.5841 | 1.0000 | 1.90043 | 37.37 | 0.57720 | 5.19 |
| 30 | 21.0055 | 6.8673 | 1.84666 | 23.84 | 0.62012 | 3.50 |
| 31 | −102.7163 | 3.4107 | | | | |
| 32 | −25.6522 | 0.9500 | 1.55032 | 75.50 | 0.54001 | 4.09 |
| 33 | 129.0419 | 1.0000 | | | | |
| 34 | 77.3878 | 9.8970 | 1.84666 | 23.84 | 0.62012 | 3.50 |
| 35 | −20.8800 | 1.0000 | 1.98613 | 16.48 | 0.66558 | 3.54 |
| 36 | −105.2859 | 50.1038 | | | | |

TABLE 28
Example 14

| | |
|---|---|
| f | 390.57 |
| Bf | 50.10 |
| FNo. | 4.13 |
| 2ω[°] | 7.92 |

### Example 15

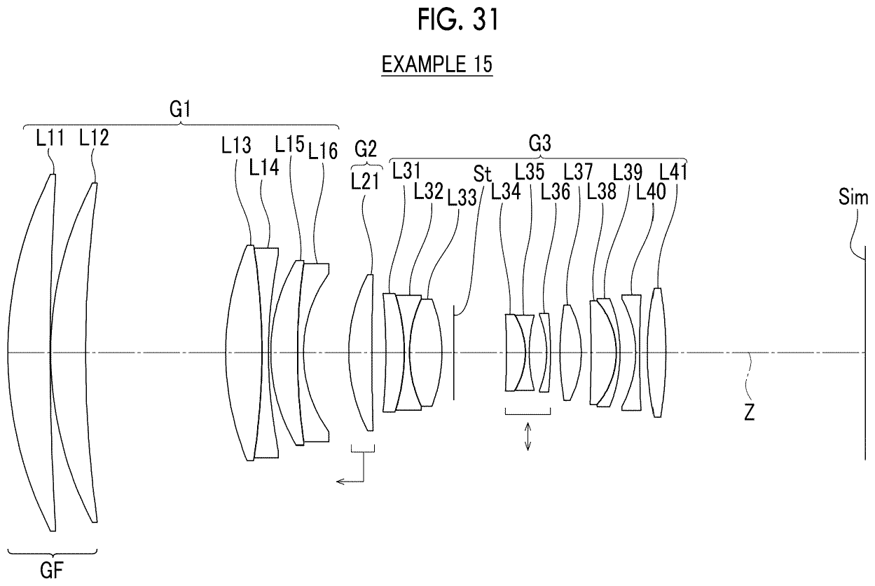

A cross-sectional view of a configuration of an imaging lens of Example 15 is shown in FIG. 31. The imaging lens of Example 15 consists of, in order from the object side to the image side, a first lens group G1 having a positive refractive power, a second lens group G2 having a positive refractive power, and a third lens group G3 having a negative refractive power. During focusing from the infinite distance object to the nearest object, the second lens group G2 moves toward the object side, and the first lens group G1 and the third lens group G3 remain stationary with respect to the image plane Sim.

The first lens group G1 consists of, in order from the object side to the image side, lenses L11 to L16. The second lens group G2 consists of a lens L21. The third lens group G3 consists of, in order from the object side to the image side, lenses L31 to L33, an aperture stop St, and lenses L34 to L41. The front partial group GF consists of lenses L11 and L12. The vibration-proof group consists of lenses L34 to L36.

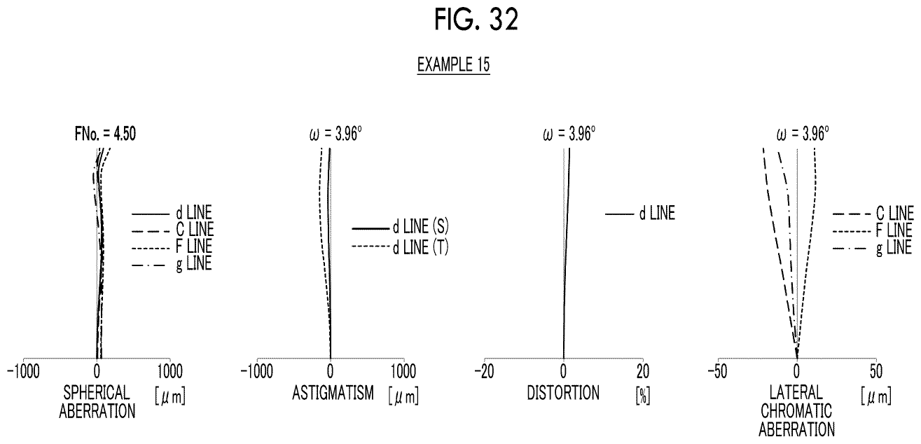

Regarding the imaging lens of Example 15, Table 29 shows basic lens data, Table 30 shows specifications, and FIG. 32 shows a diagram of aberrations.

TABLE 29
Example 15

| Sn | R | D | Nd | νd | θgF | SG |
|---|---|---|---|---|---|---|
| 1 | 100.5285 | 10.9313 | 1.49700 | 81.61 | 0.53887 | 3.70 |
| 2 | 727.0107 | 0.1350 | | | | |
| 3 | 93.3350 | 9.0000 | 1.49700 | 81.61 | 0.53887 | 3.70 |
| 4 | 309.7420 | 36.0507 | | | | |
| 5 | 72.2691 | 9.3451 | 1.43700 | 95.10 | 0.53364 | 3.53 |
| 6 | −180.5614 | 1.7000 | 1.80420 | 46.50 | 0.55727 | 4.40 |
| 7 | 124.4232 | 0.5892 | | | | |
| 8 | 46.4223 | 6.9000 | 1.43700 | 95.10 | 0.53364 | 3.53 |
| 9 | 163.6100 | 1.5100 | 1.56883 | 56.04 | 0.54853 | 2.85 |
| 10 | 34.7876 | 11.7347 | | | | |
| 11 | 43.9458 | 5.9677 | 1.43700 | 95.10 | 0.53364 | 3.53 |
| 12 | 646.1332 | 3.6009 | | | | |
| 13 | −163.1568 | 4.7595 | 1.84666 | 23.84 | 0.62012 | 3.50 |
| 14 | −49.8730 | 1.3330 | 1.90043 | 37.37 | 0.57668 | 4.90 |
| 15 | 33.0195 | 8.3906 | 1.45860 | 90.19 | 0.53516 | 3.63 |
| 16 | −37.6532 | 3.0392 | | | | |
| 17(St) | ∞ | 13.6207 | | | | |
| 18 | −179.8846 | 4.8600 | 1.72825 | 28.32 | 0.60755 | 3.01 |
| 19 | −18.6808 | 1.0000 | 1.74100 | 52.60 | 0.54792 | 4.09 |
| 20 | 35.8410 | 4.5000 | | | | |
| 21 | −26.0573 | 1.0000 | 1.83481 | 42.74 | 0.56490 | 4.58 |
| 22 | −104.0292 | 2.4711 | | | | |
| 23 | 72.5069 | 5.4903 | 1.57503 | 41.30 | 0.57356 | 3.18 |
| 24 | −27.3322 | 2.4994 | | | | |
| 25 | −353.2135 | 6.5306 | 1.80518 | 25.46 | 0.61572 | 3.36 |
| 26 | −20.3591 | 1.0022 | 2.00272 | 19.32 | 0.64514 | 5.08 |
| 27 | −37.3309 | 4.0000 | | | | |
| 28 | −28.5105 | 1.0000 | 1.77250 | 49.62 | 0.55038 | 4.28 |
| 29 | 294.3847 | 2.0000 | | | | |
| 30 | 80.5537 | 4.6592 | 1.53172 | 48.84 | 0.56309 | 2.50 |
| 31 | −104.1743 | 51.4975 | | | | |

TABLE 30
Example 15

| | |
|---|---|
| f | 389.75 |
| Bf | 51.49 |
| FNo. | 4.50 |
| 2ω[°] | 7.92 |

### Example 16

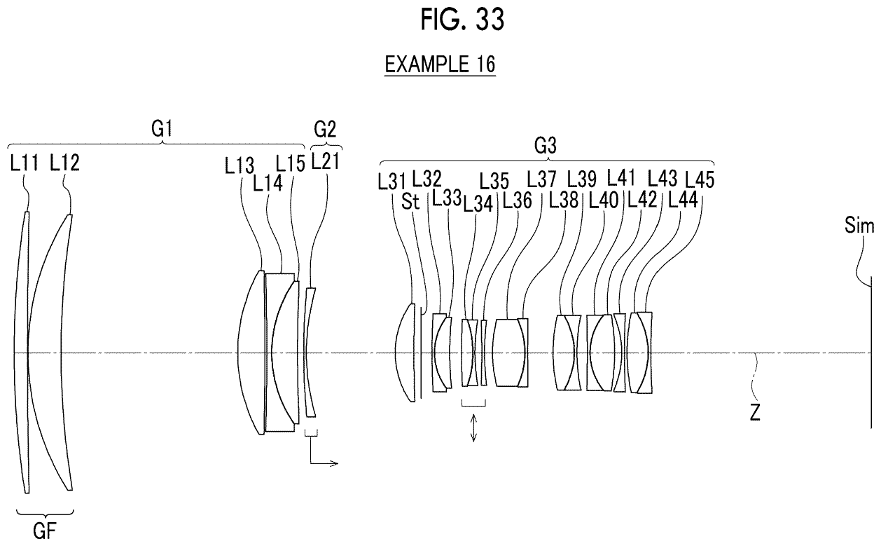

A cross-sectional view of a configuration of an imaging lens of Example 16 is shown in FIG. 33. The imaging lens of Example 16 consists of, in order from the object side to the image side, a first lens group G1 having a positive refractive power, a second lens group G2 having a negative refractive power, and a third lens group G3 having a negative refractive power. During focusing from the infinite distance object to the nearest object, the second lens group G2 moves toward the image side, and the first lens group G1 and the third lens group G3 remain stationary with respect to the image plane Sim.

The first lens group G1 consists of, in order from the object side to the image side, lenses L11 to L15. The second lens group G2 consists of a lens L21. The third lens group G3 consists of, in order from the object side to the image side, a lens L31, an aperture stop St, and lenses L32 to L45. The front partial group GF consists of lenses L11 and L12. The vibration-proof group consists of lenses L34 to L36.

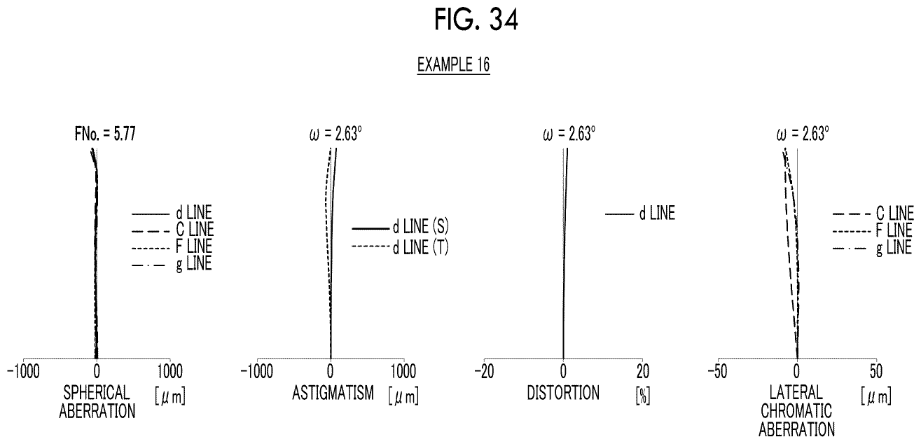

The imaging lens of Example 16 includes an aspherical lens that satisfies Conditional Expression (34). In the basic lens data described below, a reference sign * is added to surface numbers of aspherical surfaces, and the value of the paraxial curvature radius is shown in the field of the curvature radius of the aspherical surface. In addition, in the basic lens data, the effective diameter of each surface of the aspherical lens is described in the column of ED. Regarding the imaging lens of Example 16, Table 31 shows basic lens data, Table 32 shows specifications, Table 33 shows aspherical coefficients, and FIG. 34 shows a diagram of aberrations.

In Table 33, the row of Sn shows surface numbers of the aspherical surfaces, and the rows of KA and Am (m=4, 6, 8, 10) show numerical values of the aspherical coefficients for each aspherical surface. The “En” (n: integer) in numerical values of the aspherical coefficients in Table 33 indicates “×10ⁿ”. KA and Am are aspherical coefficients in an aspheric equation represented by the following equation.

$$Zd = C \times {h}^{2} / \{ 1 + {( 1 - KA \times {C}^{2} \times {h}^{2} )}^{1 / 2} \} + \sum Am \times {h}^{m}$$

where,
Zd: a depth of the aspherical surface (a length of a perpendicular line drawn from a point on the aspherical surface at a height h to a plane that is in contact with an aspherical surface apex and that is perpendicular to the optical axis Z),
h: a height (a distance from the optical axis Z to the lens surface),
C: a reciprocal of the paraxial curvature radius,
KA and Am: aspherical coefficients, and
Σ in the aspheric equation means a sum related to m.

TABLE 31
Example 16

| Sn | R | D | Nd | νd | θgF | SG | ED |
|---|---|---|---|---|---|---|---|
| 1 | 327.6456 | 4.8802 | 1.67270 | 32.10 | 0.59891 | 2.91 | |
| 2 | 2238.2960 | 0.1500 | | | | | |
| 3 | 93.1176 | 12.0677 | 1.49700 | 81.61 | 0.53887 | 3.70 | |
| 4 | 305.2505 | 64.1264 | | | | | |
| 5 | 60.2616 | 9.9007 | 1.43700 | 95.10 | 0.53364 | 3.53 | |
| 6 | −1364.5467 | 0.7233 | | | | | |
| 7 | −891.9086 | 1.7476 | 1.81600 | 46.62 | 0.55682 | 5.07 | |
| 8 | 44.6450 | 9.4100 | 1.43700 | 95.10 | 0.53364 | 3.53 | |
| 9 | 539.4796 | 2.2453 | | | | | |
| 10 | 239.6620 | 1.0000 | 1.58313 | 59.37 | 0.54345 | 3.19 | |
| 11 | 81.5002 | 32.3108 | | | | | |
| 12 | 30.7622 | 6.8583 | 1.49700 | 81.61 | 0.53887 | 3.70 | |
| 13 | 534.2918 | 2.5435 | | | | | |
| 14(St) | ∞ | 4.0204 | | | | | |
| 15 | 252.7503 | 0.9126 | 1.92119 | 23.96 | 0.62025 | 3.84 | |
| 16 | 21.2800 | 5.5525 | 1.52841 | 76.45 | 0.53954 | 3.76 | |
| 17 | 126.0742 | 4.2841 | | | | | |
| 18 | 277.0055 | 4.1269 | 1.84666 | 23.84 | 0.62012 | 3.50 | |
| 19 | −37.2968 | 0.7600 | 1.83481 | 42.72 | 0.56477 | 4.57 | |
| 20 | 67.4519 | 2.4901 | | | | | |
| 21 | −324.0385 | 1.0000 | 1.94595 | 17.98 | 0.65460 | 3.51 | |
| 22 | 93.7328 | 2.9000 | | | | | |
| 23 | 47.3938 | 11.8392 | 1.67270 | 32.10 | 0.59891 | 2.91 | |
| 24 | −28.1045 | 1.0000 | 1.74100 | 52.64 | 0.54676 | 4.04 | |
| 25 | 1040.4024 | 9.2070 | | | | | |
| 26 | 57.8512 | 7.7137 | 1.60342 | 38.03 | 0.58356 | 2.63 | |
| 27 | −26.7678 | 1.0000 | 1.49700 | 81.61 | 0.53887 | 3.70 | |
| 28 | 62.2618 | 3.7824 | | | | | |
| 29 | −527.9502 | 1.0000 | 1.85150 | 40.78 | 0.56958 | 4.70 | |
| 30 | 21.4150 | 8.9423 | 1.84666 | 23.84 | 0.62012 | 3.50 | |
| 31 | −75.3428 | 2.5896 | | | | | |
| *32 | −33.1800 | 0.9500 | 1.49700 | 81.61 | 0.53887 | 3.70 | 27.38 |
| *33 | 286.5336 | 1.0000 | | | | | 28.18 |
| 34 | 70.0772 | 7.6691 | 1.80518 | 25.46 | 0.61572 | 3.36 | |
| 35 | −27.5921 | 1.0000 | 1.98613 | 16.48 | 0.66558 | 3.54 | |
| 36 | 273.3359 | 80.0524 | | | | | |

TABLE 32
Example 16

| | |
|---|---|
| f | 588.46 |
| Bf | 80.06 |
| FNo. | 5.77 |
| 2ω[°] | 5.26 |

TABLE 33
Example 16

| Sn | 32 | 33 |
|---|---|---|
| KA | 1.0000000E+00 | 1.0000000E+00 |
| A4 | 1.3782412E−06 | 9.6332086E−07 |
| A6 | −2.8921419E−09 | −4.2343809E−09 |
| A8 | 4.8028140E−12 | 8.4388420E−12 |
| A10 | −1.0819531E−14 | −2.0490483E−14 |

### Example 17

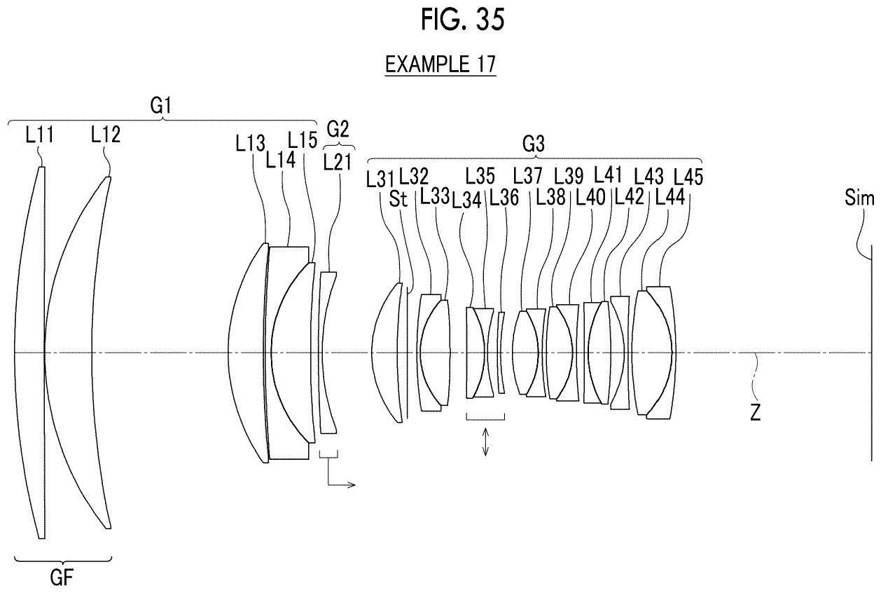

A cross-sectional view of a configuration of an imaging lens of Example 17 is shown in FIG. 35. The imaging lens of Example 17 consists of, in order from the object side to the image side, a first lens group G1 having a positive refractive power, a second lens group G2 having a negative refractive power, and a third lens group G3 having a negative refractive power. During focusing from the infinite distance object to the nearest object, the second lens group G2 moves toward the image side, and the first lens group G1 and the third lens group G3 remain stationary with respect to the image plane Sim.

The first lens group G1 consists of, in order from the object side to the image side, lenses L11 to L15. The second lens group G2 consists of a lens L21. The third lens group G3 consists of, in order from the object side to the image side, a lens L31, an aperture stop St, and lenses L32 to L45. The front partial group GF consists of lenses L11 and L12. The vibration-proof group consists of lenses L34 to L36.

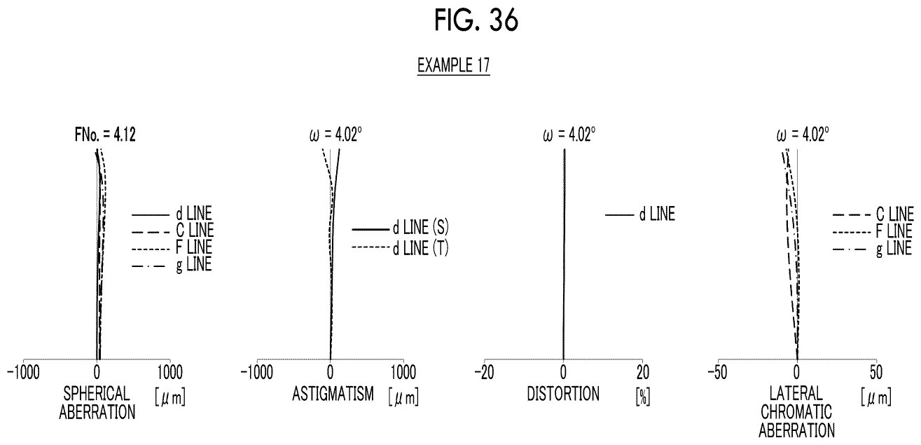

The imaging lens of Example 17 includes an aspherical lens that satisfies Conditional Expression (34). Regarding the imaging lens of Example 17, Table 34 shows basic lens data, Table 35 shows specifications, Table 36 shows aspherical coefficients, and FIG. 36 shows a diagram of aberrations. The descriptions in the tables of Example 17 are the same as those in Example 16.

TABLE 34
Example 17

| Sn | R | D | Nd | νd | θgF | SG | ED |
|---|---|---|---|---|---|---|---|
| 1 | 180.5528 | 7.6000 | 1.68960 | 31.14 | 0.60319 | 3.26 | |
| 2 | 6608.1469 | 0.1500 | | | | | |
| 3 | 71.6331 | 12.0258 | 1.49700 | 81.61 | 0.53887 | 3.70 | |
| 4 | 204.9261 | 34.7802 | | | | | |
| 5 | 47.8824 | 8.9918 | 1.45860 | 90.19 | 0.53516 | 3.63 | |
| 6 | 279.8188 | 0.5000 | | | | | |
| 7 | 324.3924 | 1.5000 | 1.83400 | 37.34 | 0.57908 | 4.57 | |
| 8 | 32.1597 | 10.0798 | 1.43700 | 95.10 | 0.53364 | 3.53 | |
| 9 | 223.7512 | 2.0000 | | | | | |
| 10 | 329.6877 | 1.0000 | 1.77250 | 49.62 | 0.55038 | 4.28 | |
| 11 | 55.0248 | 12.6909 | | | | | |
| 12 | 27.1659 | 6.4888 | 1.55032 | 75.50 | 0.54001 | 4.09 | |
| 13 | 120.6981 | 2.5465 | | | | | |
| 14(St) | ∞ | 2.5000 | | | | | |
| 15 | 97.6519 | 0.8800 | 1.92119 | 23.96 | 0.62025 | 3.84 | |
| 16 | 19.6441 | 7.6512 | 1.55032 | 75.50 | 0.54001 | 4.09 | |
| 17 | −138.7322 | 4.2278 | | | | | |
| 18 | −988.6768 | 4.5816 | 1.84666 | 23.84 | 0.62012 | 3.50 | |
| 19 | −23.3503 | 0.7500 | 1.84850 | 43.79 | 0.56197 | 5.08 | |
| 20 | 36.7686 | 2.5000 | | | | | |
| 21 | 132.1002 | 0.8600 | 1.98613 | 16.48 | 0.66558 | 3.54 | |
| 22 | 54.4285 | 2.9966 | | | | | |
| 23 | 30.2237 | 6.6454 | 1.62004 | 36.26 | 0.58800 | 2.69 | |
| 24 | −19.8565 | 1.0000 | 1.75500 | 52.32 | 0.54757 | 4.17 | |
| 25 | 73.0110 | 1.0000 | | | | | |
| 26 | 71.4908 | 6.7502 | 1.62004 | 36.26 | 0.58800 | 2.69 | |
| 27 | −18.9288 | 1.0000 | 1.49700 | 81.61 | 0.53887 | 3.70 | |
| 28 | 127.8928 | 2.0000 | | | | | |
| 29 | −1536.9733 | 1.0000 | 1.90043 | 37.37 | 0.57720 | 5.19 | |
| 30 | 26.1243 | 5.7823 | 1.84666 | 23.84 | 0.62012 | 3.50 | |
| 31 | −119.3249 | 3.4534 | | | | | |
| *32 | −25.8704 | 0.9500 | 1.55032 | 75.50 | 0.54001 | 4.09 | 26.22 |
| *33 | 425.2858 | 1.0000 | | | | | 28.80 |
| 34 | 80.6952 | 10.1210 | 1.84666 | 23.84 | 0.62012 | 3.50 | |
| 35 | −22.7454 | 1.0000 | 1.98613 | 16.48 | 0.66558 | 3.54 | |
| 36 | −94.9761 | 50.1143 | | | | | |

TABLE 35
Example 17

| | |
|---|---|
| f | 388.41 |
| Bf | 50.11 |
| FNo. | 4.12 |
| 2ω[°] | 8.04 |

TABLE 36
Example 17

| Sn | 32 | 33 |
|---|---|---|
| KA | 1.0000000E+00 | 1.0000000E+00 |
| A4 | 2.4170853E−06 | 3.3153184E−06 |
| A6 | 1.2728798E−08 | −1.0742163E−09 |
| A8 | −1.8367067E−10 | −4.8986583E−11 |
| A10 | 5.6909182E−13 | 1.5729167E−13 |

Tables 37 to 40 show the corresponding values of Conditional Expressions (1) to (34) of the imaging lenses of Examples 1 to 17. Preferred ranges of the conditional expressions may be set using the corresponding values of the examples shown in Tables 37 to 40 as the upper limits and the lower limits of the conditional expressions.

TABLE 37

| Expression | | | | | | |
|---|---|---|---|---|---|---|
| number | | Example 1 | Example 2 | Example 3 | Example 4 | Example 5 |
| (1) | FNo × (TL/f) | 3.196 | 3.042 | 3.116 | 3.256 | 3.147 |
| (2) | TL/f | 0.555 | 0.530 | 0.543 | 0.565 | 0.561 |
| (3) | dF/dL1St | 0.155 | 0.145 | 0.113 | 0.191 | 0.116 |
| (4) | dF/dAmax | 0.425 | 0.371 | 0.266 | 0.920 | 0.295 |
| (5) | dL1/dF | 0.282 | 0.284 | 0.284 | 0.322 | 0.222 |
| (6) | NL1 | 1.603 | 1.575 | 1.673 | 1.437 | 1.620 |
| (7) | NL1 + 0.01 × νL1 | 1.984 | 1.990 | 1.994 | 2.388 | 1.983 |
| (8) | θL1 + 0.0025 × νL1 | 0.679 | 0.680 | 0.679 | 0.771 | 0.679 |
| (9) | TL/(f × tan ω) | 12.032 | 11.323 | 11.727 | 12.307 | 10.096 |
| (10) | f1/f | 0.318 | 0.313 | 0.352 | 0.450 | 0.339 |
| (11) | \|f2/f] | 0.190 | 0.223 | 0.354 | 0.341 | 0.201 |
| (12) | \|f3/f] | 0.650 | 0.398 | 0.245 | 0.110 | 0.552 |
| (13) | \|(1 − β2²) × β3²\| | 7.565 | 7.812 | 5.573 | 6.025 | 6.509 |
| (14) | N2ave + 0.01 × ν2ave | 2.252 | 2.192 | 2.177 | 2.388 | 2.231 |
| (15) | θ2ave + 0.0025 × ν2ave | 0.682 | 0.678 | 0.692 | 0.771 | 0.682 |
| (16) | fIS/f | −0.070 | −0.071 | −0.077 | −0.048 | −0.072 |
| (17) | \|(1 − βIS) × βISR\| | 2.582 | 2.851 | 2.837 | 3.932 | 2.474 |
| (18) | NaveISn | 1.690 | 1.948 | 1.890 | 1.693 | 1.705 |
| (19) | νaveISn | 53.67 | 25.87 | 30.35 | 56.71 | 56.81 |
| (20) | θaveISn | 0.549 | 0.624 | 0.610 | 0.553 | 0.547 |
| (21) | Bf/(f × tan ω) | 3.433 | 3.355 | 2.987 | 4.215 | 2.295 |
| (22) | dL1St/f | 0.235 | 0.257 | 0.257 | 0.310 | 0.261 |
| (23) | dEnp/f | 0.611 | 1.137 | 0.837 | 1.168 | 0.714 |
| (24) | dExp/f | −0.325 | −0.245 | −0.222 | −0.243 | −0.291 |
| (25) | dF/f1 | 0.114 | 0.119 | 0.083 | 0.132 | 0.090 |
| (26) | dIS/dStG3r | 0.090 | 0.155 | 0.101 | 0.492 | 0.102 |
| (27) | νISRn | 70.70 | 57.05 | 81.61 | 19.32 | 67.00 |
| (28) | θISRn | 0.719 | 0.000 | 0.743 | 0.000 | 0.704 |
| (29) | NaveISRn | 1.586 | 1.718 | 1.715 | 2.003 | 1.606 |
| (30) | νaveISRn | 65.50 | 49.53 | 54.62 | 19.32 | 65.20 |
| (31) | θaveISRn | 0.542 | 0.575 | 0.572 | 0.645 | 0.538 |
| (32) | SG2 | 3.70 | 4.32 | 3.19 | 3.53 | 3.59 |
| (33) | SGISn | 4.07 | 4.26 | 4.04 | 4.16 | 4.11 |
| (34) | \|(1/Rcf − 1/Rcr)/(1/Ryf − 1/Ryr)\| | — | — | — | — | — |

TABLE 38

| Expression | | Example | Example | Example | Example | Example |
|---|---|---|---|---|---|---|
| number | | 6 | 7 | 8 | 9 | 10 |
| (1) | FNo × (TL/f) | 3.181 | 3.138 | 3.088 | 3.188 | 3.239 |
| (2) | TL/f | 0.551 | 0.551 | 0.551 | 0.552 | 0.577 |
| (3) | dF/dL1St | 0.095 | 0.118 | 0.116 | 0.113 | 0.119 |
| (4) | dF/dAmax | 0.201 | 0.229 | 0.268 | 0.215 | 0.484 |
| (5) | dL1/dF | 0.295 | 0.309 | 0.314 | 0.285 | 0.597 |
| (6) | NL1 | 1.728 | 1.640 | 1.575 | 1.596 | 1.437 |
| (7) | NL1 + 0.01 × νL1 | 2.013 | 1.985 | 1.990 | 1.988 | 2.388 |
| (8) | θL1 + 0.0025 × νL1 | 0.679 | 0.679 | 0.680 | 0.678 | 0.771 |
| (9) | TL/(f × tan ω) | 9.955 | 9.879 | 9.878 | 9.913 | 10.358 |
| (10) | f1/f | 0.325 | 0.324 | 0.317 | 0.324 | 0.550 |
| (11) | \|f2/f\| | 0.239 | 0.230 | 0.225 | 0.235 | 0.306 |
| (12) | \|f3/f] | 0.378 | 0.373 | 0.403 | 0.431 | 0.140 |
| (13) | \|(1 − β2²) × β3²\| | 8.009 | 7.996 | 7.973 | 7.989 | 6.235 |
| (14) | N2ave + 0.01 × ν2ave | 2.282 | 2.251 | 2.222 | 2.275 | 2.388 |
| (15) | θ2ave + 0.0025 × ν2ave | 0.673 | 0.681 | 0.678 | 0.682 | 0.771 |
| (16) | fIS/f | −0.080 | −0.078 | −0.076 | −0.073 | −0.058 |
| (17) | \|(1 − βIS) × βISR\| | 2.829 | 2.881 | 2.875 | 2.878 | 3.508 |
| (18) | NaveISn | 1.894 | 1.890 | 1.943 | 1.910 | 1.663 |
| (19) | νaveISn | 31.62 | 30.35 | 26.93 | 29.60 | 60.69 |
| (20) | θaveISn | 0.611 | 0.610 | 0.621 | 0.615 | 0.545 |
| (21) | Bf/(f × tan ω) | 2.672 | 2.451 | 2.836 | 2.561 | 3.726 |
| (22) | dL1St/f | 0.283 | 0.253 | 0.275 | 0.255 | 0.302 |
| (23) | dEnp/f | 0.969 | 0.703 | 1.062 | 0.708 | 1.173 |
| (24) | dExp/f | −0.215 | −0.229 | −0.237 | −0.248 | −0.265 |
| (25) | dF/f1 | 0.083 | 0.092 | 0.101 | 0.089 | 0.065 |
| (26) | dIS/dStG3r | 0.174 | 0.088 | 0.172 | 0.100 | 0.467 |
| (27) | νISRn | 76.45 | 81.61 | 75.50 | 81.61 | 19.32 |
| (28) | θISRn | 0.731 | 0.743 | 0.729 | 0.743 | 0.000 |
| (29) | NaveISRn | 1.682 | 1.725 | 1.708 | 1.726 | 2.003 |
| (30) | νaveISRn | 57.65 | 54.01 | 53.25 | 53.58 | 19.32 |
| (31) | θaveISRn | 0.561 | 0.572 | 0.575 | 0.578 | 0.645 |
| (32) | SG2 | 5.07 | 3.67 | 3.86 | 4.05 | 3.53 |
| (33) | SGISn | 4.10 | 4.04 | 4.22 | 4.14 | 3.97 |
| (34) | \|(1/Rcf − 1/Rcr)/(1/Ryf − 1/Ryr)\| | — | — | — | — | — |

TABLE 39

| Expression | | Example | Example | Example | Example | Example |
|---|---|---|---|---|---|---|
| number | | 11 | 12 | 13 | 14 | 15 |
| (1) | FNo × (TL/f) | 3.308 | 2.484 | 2.482 | 2.349 | 2.552 |
| (2) | TL/f | 0.578 | 0.571 | 0.571 | 0.569 | 0.567 |
| (3) | dF/dL1St | 0.106 | 0.178 | 0.157 | 0.188 | 0.175 |
| (4) | dF/dAmax | 0.243 | 0.429 | 0.414 | 0.544 | 0.557 |
| (5) | dL1/dF | 0.237 | 0.226 | 0.337 | 0.381 | 0.545 |
| (6) | NL1 | 1.673 | 1.589 | 1.567 | 1.690 | 1.497 |
| (7) | NL1 + 0.01 × νL1 | 1.994 | 2.202 | 1.996 | 2.001 | 2.313 |
| (8) | θL1 + 0.0025 × νL1 | 0.679 | 0.694 | 0.680 | 0.681 | 0.743 |
| (9) | TL/(f × tan ω) | 10.346 | 8.206 | 8.220 | 8.215 | 8.194 |
| (10) | f1/f | 0.910 | 0.341 | 0.317 | 0.353 | 0.512 |
| (11) | \|f2/f\| | 0.278 | 0.298 | 0.230 | 0.234 | 0.276 |
| (12) | \|f3/f\| | 0.137 | 0.299 | 0.321 | 0.642 | 0.111 |
| (13) | \|(1 − β2²) × β3²\| | 5.817 | 5.201 | 7.974 | 7.006 | 7.812 |
| (14) | N2ave + 0.01 × ν2ave | 2.313 | 2.278 | 2.225 | 2.269 | 2.388 |
| (15) | θ2ave + 0.0025 × ν2ave | 0.743 | 0.678 | 0.671 | 0.674 | 0.771 |
| (16) | fIS/f | −0.073 | −0.065 | −0.068 | −0.074 | −0.049 |
| (17) | \|(1 − βIS) × βISR\| | 3.056 | 2.382 | 2.799 | 2.893 | 3.301 |
| (18) | NaveISn | 1.858 | 1.703 | 1.970 | 1.917 | 1.788 |
| (19) | νaveISn | 35.58 | 55.43 | 24.40 | 30.14 | 47.67 |
| (20) | θaveISn | 0.605 | 0.543 | 0.628 | 0.614 | 0.556 |
| (21) | Bf/(f × tan ω) | 3.060 | 1.797 | 1.633 | 1.853 | 1.910 |
| (22) | dL1St/f | 0.253 | 0.261 | 0.305 | 0.264 | 0.295 |
| (23) | dEnp/f | 0.633 | 0.563 | 1.087 | 0.732 | 0.981 |
| (24) | dExp/f | −0.266 | −0.293 | −0.217 | −0.237 | −0.259 |
| (25) | dF/f1 | 0.029 | 0.136 | 0.151 | 0.140 | 0.101 |
| (26) | dIS/dStG3r | 0.117 | 0.125 | 0.171 | 0.126 | 0.277 |
| (27) | νISRn | 76.45 | 63.33 | 71.61 | 81.61 | 49.62 |
| (28) | θISRn | 0.731 | 0.702 | 0.721 | 0.743 | 0.000 |
| (29) | NaveISRn | 1.695 | 1.657 | 1.694 | 1.738 | 1.888 |
| (30) | νaveISRn | 56.39 | 59.43 | 56.00 | 52.66 | 34.47 |
| (31) | θaveISRn | 0.568 | 0.544 | 0.568 | 0.574 | 0.598 |
| (32) | SG2 | 3.90 | 4.17 | 4.43 | 4.28 | 3.53 |
| (33) | SGISn | 3.78 | 3.71 | 4.32 | 4.31 | 4.34 |
| (34) | \|(1/Rcf − 1/Rcr)/(1/Ryf − 1/Ryr)\| | — | — | — | — | — |

TABLE 40

| Expression | | Example | Example |
|---|---|---|---|
| number | | 16 | 17 |
| (1) | FNo × (TL/f) | 3.057 | 2.324 |
| (2) | TL/f | 0.530 | 0.564 |
| (3) | dF/dL1St | 0.116 | 0.197 |
| (4) | dF/dAmax | 0.267 | 0.569 |
| (5) | dL1/dF | 0.285 | 0.384 |
| (6) | NL1 | 1.673 | 1.690 |
| (7) | NL1 + 0.01 × νL1 | 1.994 | 2.001 |
| (8) | θL1 + 0.0025 × νL1 | 0.679 | 0.681 |
| (9) | TL/(f × tan ω) | 11.534 | 8.027 |
| (10) | f1/f | 0.351 | 0.339 |
| (11) | \|f2/f\| | 0.361 | 0.220 |
| (12) | \|f3/f\| | 0.223 | 0.700 |
| (13) | \|(1 − β2²) × β3²\| | 5.548 | 7.614 |
| (14) | N2ave + 0.01 × ν2ave | 2.177 | 2.269 |
| (15) | θ2ave + 0.0025 × ν2ave | 0.692 | 0.674 |
| (16) | fIS/f | −0.077 | −0.072 |
| (17) | \|(1 − βIS) × βISR\| | 2.834 | 2.818 |
| (18) | NaveISn | 1.890 | 1.917 |
| (19) | νaveISn | 30.35 | 30.14 |
| (20) | θaveISn | 0.610 | 0.614 |
| (21) | Bf/(f × tan ω) | 2.962 | 1.836 |
| (22) | dL1St/f | 0.251 | 0.258 |
| (23) | dEnp/f | 0.791 | 0.720 |
| (24) | dExp/f | −0.216 | −0.249 |
| (25) | dF/f1 | 0.083 | 0.150 |
| (26) | dIS/dStG3r | 0.105 | 0.131 |
| (27) | νISRn | 81.61 | 81.61 |
| (28) | θISRn | 0.743 | 0.743 |
| (29) | NaveISRn | 1.715 | 1.738 |
| (30) | νaveISRn | 54.62 | 52.66 |
| (31) | θaveISRn | 0.572 | 0.574 |
| (32) | SG2 | 3.19 | 4.28 |
| (33) | SGISn | 4.04 | 4.31 |
| (34) | \|(1/Rcf − 1/Rcr)/(1/Ryf − | 1.013 | 0.977 |
| | 1/Ryr)\| | | |

The imaging lenses of Examples 1 to 17 have an open F-number of less than 5.8, and particularly, some Examples have an open F-number of less than 4.6, thereby achieving a small F-number as a telephoto type. In addition, the imaging lenses of Examples 1 to 17 are configured to be compact, and yet various aberrations are favorably corrected to maintain high optical performance.

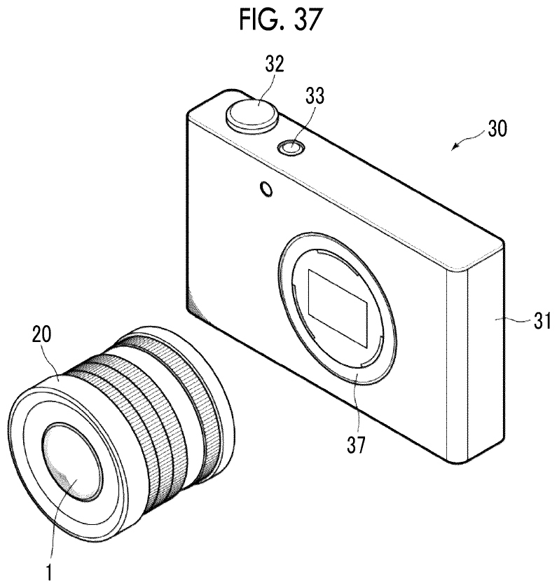

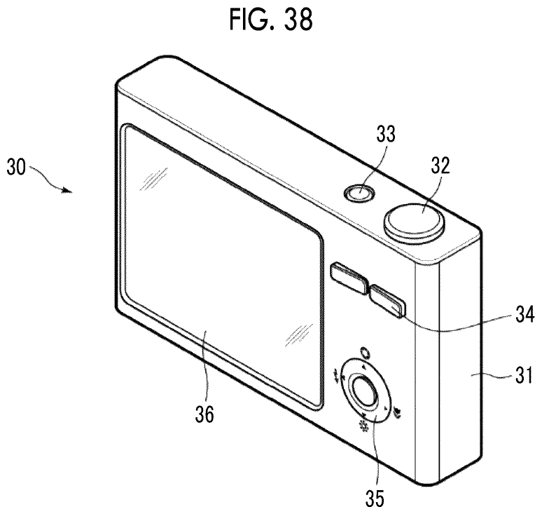

Next, an imaging apparatus according to the embodiment of the present disclosure will be described. FIGS. 37 and 38 are external views of a camera 30 that is the imaging apparatus according to the embodiment of the present disclosure. FIG. 37 is a perspective view of the camera 30 as seen from a front side, and FIG. 38 is a perspective view of the camera 30 as seen from a rear side. The camera 30 is a so-called mirrorless type digital camera in which an interchangeable lens 20 can be attachably and detachably mounted. The interchangeable lens 20 includes the imaging lens 1, which is housed in a lens barrel, according to the embodiment of the present disclosure.

The camera 30 comprises a camera body 31, in which a shutter button 32 and a power button 33 are provided on an upper surface of the camera body 31. In addition, an operation unit 34, an operation unit 35, and a display unit 36 are provided on a rear surface of the camera body 31. The display unit 36 can display a captured image and an image within an angle of view before capturing.

An imaging aperture through which light from an imaging target enters is provided in a center portion of a front surface of the camera body 31, a mount 37 is provided at a position corresponding to the imaging aperture, and the interchangeable lens 20 is mounted on the camera body 31 via the mount 37.

An imaging element, such as a charge coupled device (CCD) or a complementary metal oxide semiconductor (CMOS), that outputs an imaging signal corresponding to a subject image formed by the interchangeable lens 20, a signal processing circuit that processes the imaging signal output from the imaging element to generate an image, a recording medium for recording the generated image, and the like are provided in the camera body 31. In the camera 30, a still image or a moving image can be captured by pressing the shutter button 32, and the image data obtained by this capturing is recorded on the recording medium.

A technology of the present disclosure has been hitherto described through the embodiments and the examples, but the technology of the present disclosure is not limited to the above-mentioned embodiments and examples, and may be modified into various forms. For example, the curvature radius, the surface spacing, the refractive index, the Abbe number, the aspherical coefficient, and the like of each lens are not limited to the values shown in the examples, and different values may be used.

In addition, the imaging apparatus according to the embodiment of the present disclosure is not limited to the above-described example and can have various aspects of, for example, a camera of a type other than a mirrorless type, a film camera, a video camera, and a security camera.

In regard with the embodiment and the examples described above, the following supplementary notes are further disclosed.

### APPENDIX 1

An imaging lens consisting of, in order from an object side to an image side, a first lens group having a positive refractive power, a second lens group, and a third lens group,
in which, during focusing, a spacing between the first lens group and the second lens group changes, and a spacing between the second lens group and the third lens group changes, and
in a case where
   an open F-number in a state where an infinite distance object is in focus is denoted by FNo,
   a sum of a distance on an optical axis from a lens surface of the first lens group closest to the object side to a lens surface of the third lens group closest to the image side and a back focal length of a whole system at an air conversion distance in a state where the infinite distance object is in focus is denoted by TL, and
   a focal length of the whole system in a state where the infinite distance object is in focus is denoted by f,
   Conditional Expressions (1) and (2) are satisfied, which are represented by

$$2 < FNo \times ( TL / f ) < 3.5 , and \qquad ( 1 )$$

$$0.45 < TL / f < 0.6 . \qquad ( 2 )$$

### APPENDIX 2

The imaging lens according to Appendix 1,
in which an aperture stop is disposed closer to the image side than an intersection between a lens surface of the first lens group closest to the image side and the optical axis, and
in a case where
   a group consisting of a portion of the whole system that is closer to the object side than a maximum air spacing on the optical axis between lens surfaces of the whole system in a state where the infinite distance object is in focus is defined as a front partial group,
   a length of the front partial group on the optical axis is denoted by dF, and
   a distance on the optical axis from the lens surface of the first lens group closest to the object side to the aperture stop in a state where the infinite distance object is in focus is denoted by dL1St,
   Conditional Expression (3) is satisfied, which is represented by

$$0.05 < dF / d L 1 St < 0.28 . \qquad ( 3 )$$

### APPENDIX 3

The imaging lens according to Appendix 1 or 2,
in which, in a case where
   a group consisting of a portion of the whole system that is closer to the object side than a maximum air spacing on the optical axis between lens surfaces of the whole system in a state where the infinite distance object is in focus is defined as a front partial group,
   a length of the front partial group on the optical axis is denoted by dF, and
   the maximum air spacing is denoted by dAmax,
   Conditional Expression (4) is satisfied, which is represented by

$$0.1 < dF / dA max < 0.99 . \qquad ( 4 )$$

### APPENDIX 4

The imaging lens according to any one of Appendices 1 to 3,
in which, in a case where
   a group consisting of a portion of the whole system that is closer to the object side than a maximum air spacing on the optical axis between lens surfaces of the whole system in a state where the infinite distance object is in focus is defined as a front partial group,
   a length of a lens closest to the object side in the first lens group on the optical axis is denoted by dL1,
   a length of the front partial group on the optical axis is denoted by dF, and
   a refractive index of the lens closest to the object side in the first lens group at a d line is denoted by NL1,
   Conditional Expressions (5) and (6) are satisfied, which are represented by

$$0.15 < d L 1 / dF < 0.65 , and \qquad ( 5 )$$

$$1.41 < NL 1 < 2.01 . \qquad ( 6 )$$

### APPENDIX 5

The imaging lens according to any one of Appendices 1 to 4,
in which, in a case where
   a refractive index of a lens closest to the object side in the first lens group at a d line is denoted by NL1,
   an Abbe number of the lens closest to the object side in the first lens group based on the d line is denoted by νL1, and
   a partial dispersion ratio of the lens closest to the object side in the first lens group between a g line and an F line is denoted by θL1,
   Conditional Expressions (7) and (8) are satisfied, which are represented by

$$1.85 < NL 1 + 0.01 \times vL 1 < 2.5 , and \qquad ( 7 )$$

$$0.59 < θ L 1 + 0.0025 \times vL 1 < 0.79 . \qquad ( 8 )$$

### APPENDIX 6

The imaging lens according to any one of Appendices 1 to 5,
in which, in a case where a maximum half angle of view in a state where the infinite distance object is in focus is denoted by ω, Conditional Expression (9) is satisfied, which is represented by

$$6.5 < TL / ( f \times tan ω ) < 20. \qquad ( 9 )$$

### APPENDIX 7

The imaging lens according to any one of Appendices 1 to 6,
in which, in a case where
   a group consisting of a portion of the whole system that is closer to the object side than a maximum air spacing on the optical axis between lens surfaces of the whole system in a state where the infinite distance object is in focus is defined as a front partial group,
   a length of a lens closest to the object side in the first lens group on the optical axis is denoted by dL1, and
   a length of the front partial group on the optical axis is denoted by dF,
   Conditional Expression (5-1) is satisfied, which is represented by

$$0.19 < d L 1 / dF < 0.31 . \qquad ( 5 - 1 )$$

### APPENDIX 8

The imaging lens according to any one of Appendices 1 to 7,
in which, in a case where a focal length of the first lens group is denoted by f1, Conditional Expression (10) is satisfied, which is represented by

$$0.18 < f 1 / f < 1. \qquad ( 10 )$$

### APPENDIX 9

The imaging lens according to any one of Appendices 1 to 8,
in which, in a case where a focal length of the second lens group is denoted by f2, Conditional Expression (11) is satisfied, which is represented by

$$0.08 < \vert f 2 / f \vert < 0.5 . \qquad ( 11 )$$

### APPENDIX 10

The imaging lens according to any one of Appendices 1 to 9,
in which, in a case where a focal length of the third lens group is denoted by f3, Conditional Expression (12) is satisfied, which is represented by

$$0.05 < \vert f 3 / f \vert < 1. \qquad ( 12 )$$

### APPENDIX 11

The imaging lens according to any one of Appendices 1 to 10,
in which, in a case where
   a lateral magnification of the second lens group in a state where the infinite distance object is in focus is denoted by β2, and
   a lateral magnification of the third lens group in a state where the infinite distance object is in focus is denoted by β3,
Conditional Expression (13) is satisfied, which is represented by

$$2.5 < \vert ( 1 - β {2}^{2} ) \times β {3}^{2} \vert < 10. \qquad ( 13 )$$

### APPENDIX 12

The imaging lens according to any one of Appendices 1 to 11,
in which, in a case where
   an average of refractive indices of all lenses in the second lens group at a d line is denoted by N2ave,
   an average of Abbe numbers of all the lenses in the second lens group based on the d line is denoted by ν2ave, and
   an average of partial dispersion ratios of all the lenses in the second lens group between a g line and an F line is denoted by θ2ave,
   Conditional Expressions (14) and (15) are satisfied, which are represented by

$$1. 85 < N 2 ave + 0.01 \times v 2 ave < 2.7 , and \qquad ( 14 )$$

$$0.59 < θ 2 ave + 0.0025 \times v 2 ave < 0.79 . \qquad ( 15 )$$

### APPENDIX 13

The imaging lens according to any one of Appendices 1 to 12,
in which the third lens group includes a vibration-proof group that moves in a direction intersecting the optical axis during image shake correction, and
in a case where a focal length of the vibration-proof group is denoted by fIS, Conditional Expression (16) is satisfied, which is represented by

$$- 0.13 < fIS / f < - 0.02 . \qquad ( 16 )$$

### APPENDIX 14

The imaging lens according to any one of Appendices 1 to 13,
in which the third lens group includes a vibration-proof group that moves in a direction intersecting the optical axis during image shake correction, and
in a case where
   a lateral magnification of the vibration-proof group in a state where the infinite distance object is in focus is denoted by βIS, and
   a combined lateral magnification of all lenses that are closer to the image side than the vibration-proof group in a state where the infinite distance object is in focus is denoted by βISR,
   Conditional Expression (17) is satisfied, which is represented by

$$1.5 < \vert ( 1 - β IS ) \times β ISR \vert < 6. \qquad ( 17 )$$

### APPENDIX 15

The imaging lens according to any one of Appendices 1 to 14,
in which the third lens group includes a vibration-proof group that moves in a direction intersecting the optical axis during image shake correction,
the vibration-proof group includes at least one negative lens, and
in a case where
   an average of refractive indices of all negative lenses in the vibration-proof group at a d line is denoted by NaveISn,
   an average of Abbe numbers of all the negative lenses in the vibration-proof group based on the d line is denoted by νaveISn, and
   an average of partial dispersion ratios of all the negative lenses in the vibration-proof group between a g line and an F line is denoted by θaveISn,
   Conditional Expressions (18), (19), and (20) are satisfied, which are represented by

$$1. 6 < NaveISn < 2.01 , \qquad ( 18 )$$

$$16 < vavISn < 65 , and \qquad ( 19 )$$

$$0.49 < θ aveISn < 0.72 . \qquad ( 20 )$$

### APPENDIX 16

The imaging lens according to any one of Appendices 1 to 15,
in which, in a case where
   the back focal length of the whole system at the air conversion distance in a state where the infinite distance object is in focus is denoted by Bf, and
   a maximum half angle of view in a state where the infinite distance object is in focus is denoted by ω,
   Conditional Expression (21) is satisfied, which is represented by

$$1.2 < Bf / ( f \times tan ω ) < 5. \qquad ( 21 )$$

### APPENDIX 17

The imaging lens according to any one of Appendices 1 to 16,
in which the imaging lens includes an aperture stop, and
in a case where a distance on the optical axis from the lens surface of the first lens group closest to the object side to the aperture stop in a state where the infinite distance object is in focus is denoted by dL1St, Conditional Expression (22) is satisfied, which is represented by

$$0.15 < dL 1 St / f < 0 \text{.45} . \qquad ( 22 )$$

### APPENDIX 18

The optical system according to any one of Appendices 1 to 17,
in which, in a case where a distance on the optical axis from the lens surface of the first lens group closest to the object side to a paraxial entrance pupil position in a state where the infinite distance object is in focus is denoted by dEnp, Conditional Expression (23) is satisfied, which is represented by

$$0.3 < dEnp / f < 1.5 . \qquad ( 23 )$$

### APPENDIX 19

The imaging lens according to any one of Appendices 1 to 18,
in which, in a case where
   a distance on the optical axis from an image plane to a paraxial exit pupil position in a state where the infinite distance object is in focus is denoted by dExp,
   a sign of dExp is defined with the image plane as a reference such that a distance on the image side is positive and a distance on the object side is negative, and
   dExp is calculated using the air conversion distance for an optical member having no refractive power in a case where the optical member is disposed between the image plane and the paraxial exit pupil position,
   Conditional Expression (24) is satisfied, which is represented by

$$- 0 \text{.5} < dExp / f < - 0.1 . \qquad ( 24 )$$

### APPENDIX 20

The imaging lens according to any one of Appendices 1 to 19,
in which, in a case where
   a group consisting of a portion of the whole system that is closer to the object side than a maximum air spacing on the optical axis between lens surfaces of the whole system in a state where the infinite distance object is in focus is defined as a front partial group,
   a length of the front partial group on the optical axis is denoted by dF, and
   a focal length of the first lens group is denoted by f1,
   Conditional Expression (25) is satisfied, which is represented by

$$0.02 < dF / f 1 < 0.24 . \qquad ( 25 )$$

### APPENDIX 21

The imaging lens according to any one of Appendices 1 to 20,
in which the imaging lens includes an aperture stop,
the third lens group includes a vibration-proof group that moves in a direction intersecting the optical axis during image shake correction, and
in a case where
   a length of the vibration-proof group on the optical axis is denoted by dIS, and
   a distance on the optical axis from the aperture stop to the lens surface of the third lens group closest to the image side in a state where the infinite distance object is in focus is denoted by dStG3r,
   Conditional Expression (26) is satisfied, which is represented by

$$0.04 < dIS / dStG 3 r < 0 \text{.45} . \qquad ( 26 )$$

### APPENDIX 22

The imaging lens according to any one of Appendices 1 to 21,
in which the second lens group has a negative refractive power.

### APPENDIX 23

The imaging lens according to any one of Appendices 1 to 21,
in which the second lens group has a positive refractive power.

### APPENDIX 24

The imaging lens according to any one of Appendices 1 to 23,
in which, in a case where a group consisting of a portion of the whole system that is closer to the object side than a maximum air spacing on the optical axis between lens surfaces of the whole system in a state where the infinite distance object is in focus is defined as a front partial group, the front partial group consists of two positive lenses.

### APPENDIX 25

The imaging lens according to any one of Appendices 1 to 24,
in which the number of positive lenses included in the first lens group is four or less.

### APPENDIX 26

The imaging lens according to any one of Appendices 1 to 25,
in which the first lens group includes, successively in order from a position closest to the object side to the image side, a positive lens, a positive lens, a positive lens, and a negative lens.

### APPENDIX 27

The imaging lens according to any one of Appendices 1 to 26,
in which the third lens group has a negative refractive power.

### APPENDIX 28

The imaging lens according to any one of Appendices 1 to 27,
in which the third lens group includes a vibration-proof group that moves in a direction intersecting the optical axis during image shake correction and at least one negative lens disposed closer to the image side than the vibration-proof group, and
in a case where
   an Abbe number of the negative lens disposed closer to the image side than the vibration-proof group based on a d line is denoted by νISRn, and
   a partial dispersion ratio of the negative lens disposed closer to the image side than the vibration-proof group between a g line and an F line is denoted by θISRn,
   the imaging lens includes at least one negative lens that satisfies Conditional Expressions (27) and (28), which are represented by

$$60 < ν ISRn < 96 , and \qquad ( 27 )$$

$$0.69 < θ ISRn < 0.79 . \qquad ( 28 )$$

### APPENDIX 29

The imaging lens according to any one of Appendices 1 to 28,
in which the third lens group includes a vibration-proof group that moves in a direction intersecting the optical axis during image shake correction and a plurality of negative lenses disposed closer to the image side than the vibration-proof group, and
in a case where
   an average of refractive indices of all negative lenses disposed closer to the image side than the vibration-proof group at a d line is denoted by NaveISRN,
   an average of Abbe numbers of all the negative lenses disposed closer to the image side than the vibration-proof group based on the d line is denoted by νaveISRn, and
   an average of partial dispersion ratios of all the negative lenses disposed closer to the image side than the vibration-proof group between a g line and an F line is denoted by θaveISRn,
   Conditional Expressions (29), (30), and (31) are satisfied, which are represented by

$$1.49 < NaveISRn < 1.8 , \qquad ( 29 )$$

$$45 < ν aveISRn < 75 , and \qquad ( 30 )$$

$$0.5 < θ aveISRn < 0.6 . \qquad ( 31 )$$

### APPENDIX 30

The imaging lens according to any one of Appendices 1 to 29,
in which the third lens group includes a vibration-proof group that moves in a direction intersecting the optical axis during image shake correction, and
the third lens group includes two or more cemented lenses each configured by cementing a positive lens and a negative lens in order from the object side, the cemented lenses being disposed closer to the image side than the vibration-proof group.

### APPENDIX 31

The imaging lens according to any one of Appendices 1 to 30,
in which, in a case where an average of specific gravities of all lenses in the second lens group is denoted by SG2, Conditional Expression (32) is satisfied, which is represented by

$$2.7 < SG 2 < 4.5 . \qquad ( 32 )$$

### APPENDIX 32

The imaging lens according to any one of Appendices 1 to 31,
in which the third lens group includes a vibration-proof group that moves in a direction intersecting the optical axis during image shake correction,
the vibration-proof group includes at least one negative lens, and
in a case where an average of specific gravities of all negative lenses in the vibration-proof group is denoted by SGISn, Conditional Expression (33) is satisfied, which is represented by

$$3. 4 < SGISn < 4.7 . \qquad ( 33 )$$

### APPENDIX 33

The imaging lens according to any one of Appendices 1 to 32,
in which the third lens group includes an aspherical lens, and
in a case where
   a paraxial curvature radius of a surface of the aspherical lens on the object side is denoted by Rcf,
   a paraxial curvature radius of a surface of the aspherical lens on the image side is denoted by Rcr,
   a curvature radius at a position of a maximum effective diameter of the surface of the aspherical lens on the object side is denoted by Ryf, and
   a curvature radius at a position of a maximum effective diameter of the surface of the aspherical lens on the image side is denoted by Ryr,
   Conditional Expression (34) is satisfied, which is represented by

$$0.65 < \vert ( 1 / Rcf - 1 / Rcr ) / ( 1 / Ryf - 1 / Ryr ) \vert < 1.35 . \qquad ( 34 )$$

### APPENDIX 34

An imaging apparatus comprising:
the imaging lens according to any one of Appendices 1 to 33.

All documents, patent applications, and technical standards described in this specification are herein incorporated by reference to the same extent that each individual document, patent application, or technical standard was specifically and individually indicated to be incorporated by reference.

What is claimed is:

1. An imaging lens consisting of, in order from an object side to an image side, a first lens group having a positive refractive power, a second lens group, and a third lens group,
wherein, during focusing, a spacing between the first lens group and the second lens group changes, and a spacing between the second lens group and the third lens group changes, and
in a case where
an open F-number in a state where an infinite distance object is in focus is denoted by FNo,
a sum of a distance on an optical axis from a lens surface of the first lens group closest to the object side to a lens surface of the third lens group closest to the image side and a back focal length of the imaging lens at an air conversion distance in a state where the infinite distance object is in focus is denoted by TL, and
a focal length of the imaging lens in a state where the infinite distance object is in focus is denoted by f,
Conditional Expressions (1) and (2) are satisfied, which are represented by
$$2 < FN o \times ( TL / f ) < 3.5 , and \qquad ( 1 )$$
$$0.45 < TL / f < 0.6 . \qquad ( 2 )$$

2. The imaging lens according to claim 1,
wherein an aperture stop is disposed closer to the image side than an intersection between a lens surface of the first lens group closest to the image side and the optical axis, and
in a case where
a group consisting of a portion of the imaging lens that is closer to the object side than a maximum air spacing on the optical axis between lens surfaces of the imaging lens in a state where the infinite distance object is in focus is defined as a front partial group,
a length of the front partial group on the optical axis is denoted by dF, and
a distance on the optical axis from the lens surface of the first lens group closest to the object side to the aperture stop in a state where the infinite distance object is in focus is denoted by dL1St,
Conditional Expression (3) is satisfied, which is represented by
0.05<dF/dL1St<0.28 (3).

3. The imaging lens according to claim 1,
wherein, in a case where
a group consisting of a portion of the imaging lens that is closer to the object side than a maximum air spacing on the optical axis between lens surfaces of the imaging lens in a state where the infinite distance object is in focus is defined as a front partial group,
a length of the front partial group on the optical axis is denoted by dF, and
the maximum air spacing is denoted by dAmax,
Conditional Expression (4) is satisfied, which is represented by
$$0.1 < dF / dA max < 0 \text{.99} . \qquad ( 4 )$$

4. The imaging lens according to claim 1,
wherein, in a case where
a group consisting of a portion of the imaging lens that is closer to the object side than a maximum air spacing on the optical axis between lens surfaces of the imaging lens in a state where the infinite distance object is in focus is defined as a front partial group,
a length of a lens closest to the object side in the first lens group on the optical axis is denoted by dL1,
a length of the front partial group on the optical axis is denoted by dF, and
a refractive index of the lens closest to the object side in the first lens group at a d line is denoted by NL1,
Conditional Expressions (5) and (6) are satisfied, which are represented by
$$0.15 < d L 1 / dF < 0.65 , and \qquad ( 5 )$$
$$1.41 < NL 1 < 2 \text{.01} . \qquad ( 6 )$$

5. The imaging lens according to claim 1,
wherein, in a case where
a refractive index of a lens closest to the object side in the first lens group at a d line is denoted by NL1,
an Abbe number of the lens closest to the object side in the first lens group based on the d line is denoted by νL1, and
a partial dispersion ratio of the lens closest to the object side in the first lens group between a g line and an F line is denoted by θL1,
Conditional Expressions (7) and (8) are satisfied, which are represented by
$$1.85 < NL 1 + 0.01 \times ν L 1 < 2.5 , and \qquad ( 7 )$$
$$0.59 < θ L 1 + 0.0 \; 025 \times ν L 1 < 0.79 . \qquad ( 8 )$$

6. The imaging lens according to claim 1,
wherein, in a case where a maximum half angle of view in a state where the infinite distance object is in focus is denoted by ω, Conditional Expression (9) is satisfied, which is represented by
$$6.5 < TL / ( f \times tan ω ) < 20. \qquad ( 9 )$$

7. The imaging lens according to claim 1,
wherein, in a case where
a group consisting of a portion of the imaging lens that is closer to the object side than a maximum air spacing on the optical axis between lens surfaces of the imaging lens in a state where the infinite distance object is in focus is defined as a front partial group,
a length of a lens closest to the object side in the first lens group on the optical axis is denoted by dL1, and
a length of the front partial group on the optical axis is denoted by dF,
Conditional Expression (5-1) is satisfied, which is represented by
$$0.19 < d L 1 / dF < 0.31 . \qquad ( 5 - 1 )$$

8. The imaging lens according to claim 1,
wherein, in a case where a focal length of the first lens group is denoted by f1, Conditional Expression (10) is satisfied, which is represented by
$$0.18 < f 1 / f < 1. \qquad ( 10 )$$

9. The imaging lens according to claim 1,
wherein, in a case where a focal length of the second lens group is denoted by f2, Conditional Expression (11) is satisfied, which is represented by
$$0.08 < \vert f 2 / f \vert < 0.5 . \qquad ( 11 )$$

10. The imaging lens according to claim 1,
wherein, in a case where a focal length of the third lens group is denoted by f3, Conditional Expression (12) is satisfied, which is represented by
$$0.05 < \vert f 3 / f \vert < 1. \qquad ( 12 )$$

11. The imaging lens according to claim 1,
wherein, in a case where
a lateral magnification of the second lens group in a state where the infinite distance object is in focus is denoted by β2, and
a lateral magnification of the third lens group in a state where the infinite distance object is in focus is denoted by β3,
Conditional Expression (13) is satisfied, which is represented by
$$2.5 < \vert ( 1 - {β2}^{2} ) \times β {3}^{2} \vert < 10. \qquad ( 13 )$$

12. The imaging lens according to claim 1,
wherein, in a case where
an average of refractive indices of all lenses in the second lens group at a d line is denoted by N2ave,
an average of Abbe numbers of all the lenses in the second lens group based on the d line is denoted by ν2ave, and
an average of partial dispersion ratios of all the lenses in the second lens group between a g line and an F line is denoted by θ2ave,
Conditional Expressions (14) and (15) are satisfied, which are represented by
$$1. 85 < N 2 a v e + 0.01 \times v 2 a v e < 2.7 , and \qquad ( 14 )$$
$$0.59 < θ 2 ave + 0.0025 \times v2ave < 0.79 . \qquad ( 15 )$$

13. The imaging lens according to claim 1,
wherein the third lens group includes a vibration-proof group that moves in a direction intersecting the optical axis during image shake correction, and
in a case where a focal length of the vibration-proof group is denoted by fIS, Conditional Expression (16) is satisfied, which is represented by
$$- 0.13 < fIS / f < - 0.02 . \qquad ( 16 )$$

14. The imaging lens according to claim 1,
wherein the third lens group includes a vibration-proof group that moves in a direction intersecting the optical axis during image shake correction, and
in a case where
a lateral magnification of the vibration-proof group in a state where the infinite distance object is in focus is denoted by βIS, and
a combined lateral magnification of all lenses that are closer to the image side than the vibration-proof group in a state where the infinite distance object is in focus is denoted by βISR,
Conditional Expression (17) is satisfied, which is represented by
$$1.5 < \vert ( 1 - β IS ) \times β ISR \vert < 6. \qquad ( 17 )$$

15. The imaging lens according to claim 1,
wherein the third lens group includes a vibration-proof group that moves in a direction intersecting the optical axis during image shake correction,
the vibration-proof group includes at least one negative lens, and
in a case where
an average of refractive indices of all negative lenses in the vibration-proof group at a d line is denoted by NaveISn,
an average of Abbe numbers of all the negative lenses in the vibration-proof group based on the d line is denoted by νaveISn, and
an average of partial dispersion ratios of all the negative lenses in the vibration-proof group between a g line and an F line is denoted by θaveISn,
Conditional Expressions (18), (19), and (20) are satisfied, which are represented by
$$1.6 < NaveISn < 2.01 , \qquad ( 18 )$$
$$16 < vaveISn < 65 , and \qquad ( 19 )$$
$$0.49 < θ aveISn < 0.72 . \qquad ( 20 )$$

16. The imaging lens according to claim 1,
wherein, in a case where
the back focal length of the imaging lens at the air conversion distance in a state where the infinite distance object is in focus is denoted by Bf, and
a maximum half angle of view in a state where the infinite distance object is in focus is denoted by ω,
Conditional Expression (21) is satisfied, which is represented by
$$1.2 < Bf / ( f \times tan ω ) < 5. \qquad ( 21 )$$

17. The imaging lens according to claim 1,
wherein the imaging lens includes an aperture stop, and
in a case where a distance on the optical axis from the lens surface of the first lens group closest to the object side to the aperture stop in a state where the infinite distance object is in focus is denoted by dL1St, Conditional Expression (22) is satisfied, which is represented by
$$0.15 < dL 1 St / f < 0 \text{.45} . \qquad ( 22 )$$

18. The optical system according to claim 1,
wherein, in a case where a distance on the optical axis from the lens surface of the first lens group closest to the object side to a paraxial entrance pupil position in a state where the infinite distance object is in focus is denoted by dEnp, Conditional Expression (23) is satisfied, which is represented by
$$0.3 < dEnp / f < 1.5 . \qquad ( 23 )$$

19. The imaging lens according to claim 1,
wherein, in a case where
a distance on the optical axis from an image plane to a paraxial exit pupil position in a state where the infinite distance object is in focus is denoted by dExp,
a sign of dExp is defined with the image plane as a reference such that a distance on the image side is positive and a distance on the object side is negative, and
dExp is calculated using the air conversion distance for an optical member having no refractive power in a case where the optical member is disposed between the image plane and the paraxial exit pupil position,
Conditional Expression (24) is satisfied, which is represented by
$$- 0.5 < dExp / f < - 0.1 . \qquad ( 24 )$$

20. The imaging lens according to claim 1,
wherein, in a case where
a group consisting of a portion of the imaging lens that is closer to the object side than a maximum air spacing on the optical axis between lens surfaces of the imaging lens in a state where the infinite distance object is in focus is defined as a front partial group,
a length of the front partial group on the optical axis is denoted by dF, and
a focal length of the first lens group is denoted by f1,
Conditional Expression (25) is satisfied, which is represented by
$$0.02 < dF / f 1 < 0.24 . \qquad ( 25 )$$

21. The imaging lens according to claim 1,
wherein the imaging lens includes an aperture stop,
the third lens group includes a vibration-proof group that moves in a direction intersecting the optical axis during image shake correction, and
in a case where
a length of the vibration-proof group on the optical axis is denoted by dIS, and
a distance on the optical axis from the aperture stop to the lens surface of the third lens group closest to the image side in a state where the infinite distance object is in focus is denoted by dStG3r,
Conditional Expression (26) is satisfied, which is represented by
$$0.04 < dIS / dStG 3 r < 0 \text{.45} . \qquad ( 26 )$$

22. The imaging lens according to claim 1,
wherein the second lens group has a negative refractive power.

23. The imaging lens according to claim 1,
wherein the second lens group has a positive refractive power.

24. The imaging lens according to claim 1,
wherein, in a case where a group consisting of a portion of the imaging lens that is closer to the object side than a maximum air spacing on the optical axis between lens surfaces of the imaging lens in a state where the infinite distance object is in focus is defined as a front partial group, the front partial group consists of two positive lenses.

25. The imaging lens according to claim 1,
wherein the number of positive lenses included in the first lens group is four or less.

26. The imaging lens according to claim 1,
wherein the first lens group includes, successively in order from a position closest to the object side to the image side, a positive lens, a positive lens, a positive lens, and a negative lens.

27. The imaging lens according to claim 1,
wherein the third lens group has a negative refractive power.

28. The imaging lens according to claim 1,
wherein the third lens group includes a vibration-proof group that moves in a direction intersecting the optical axis during image shake correction and at least one negative lens disposed closer to the image side than the vibration-proof group, and
in a case where
an Abbe number of the negative lens disposed closer to the image side than the vibration-proof group based on a d line is denoted by νISRn, and
a partial dispersion ratio of the negative lens disposed closer to the image side than the vibration-proof group between a g line and an F line is denoted by θISRn,
the imaging lens includes at least one negative lens that satisfies Conditional Expressions (27) and (28), which are represented by
$$60 < vISRn < 96 , and \qquad ( 27 )$$
$$0.69 < θ ISRn < 0.79 . \qquad ( 28 )$$

29. The imaging lens according to claim 1,
wherein the third lens group includes a vibration-proof group that moves in a direction intersecting the optical axis during image shake correction and a plurality of negative lenses disposed closer to the image side than the vibration-proof group, and
in a case where
an average of refractive indices of all negative lenses disposed closer to the image side than the vibration-proof group at a d line is denoted by NaveISRN,
an average of Abbe numbers of all the negative lenses disposed closer to the image side than the vibration-proof group based on the d line is denoted by νaveISRn, and
an average of partial dispersion ratios of all the negative lenses disposed closer to the image side than the vibration-proof group between a g line and an F line is denoted by θaveISRn,
Conditional Expressions (29), (30), and (31) are satisfied, which are represented by
$$1.49 < NaveISRn < 1.8 , \qquad ( 29 )$$
$$45 < vaveISRn < 75 , and \qquad ( 30 )$$
$$0.5 < θ aveISRn < 0.6 . \qquad ( 31 )$$

30. The imaging lens according to claim 1,
wherein the third lens group includes a vibration-proof group that moves in a direction intersecting the optical axis during image shake correction, and
the third lens group includes two or more cemented lenses each configured by cementing a positive lens and a negative lens in order from the object side, the cemented lenses being disposed closer to the image side than the vibration-proof group.

31. The imaging lens according to claim 1,
wherein, in a case where an average of specific gravities of all lenses in the second lens group is denoted by SG2, Conditional Expression (32) is satisfied, which is represented by
$$2.7 < SG 2 < 4.5 . \qquad ( 32 )$$

32. The imaging lens according to claim 1,
wherein the third lens group includes a vibration-proof group that moves in a direction intersecting the optical axis during image shake correction,
the vibration-proof group includes at least one negative lens, and
in a case where an average of specific gravities of all negative lenses in the vibration-proof group is denoted by SGISn, Conditional Expression (33) is satisfied, which is represented by
$$3. 4 < SGISn < 4.7 . \qquad ( 33 )$$

33. The imaging lens according to claim 1,
wherein the third lens group includes an aspherical lens, and
in a case where
a paraxial curvature radius of a surface of the aspherical lens on the object side is denoted by Rcf,
a paraxial curvature radius of a surface of the aspherical lens on the image side is denoted by Rcr,
a curvature radius at a position of a maximum effective diameter of the surface of the aspherical lens on the object side is denoted by Ryf, and
a curvature radius at a position of a maximum effective diameter of the surface of the aspherical lens on the image side is denoted by Ryr,
Conditional Expression (34) is satisfied, which is represented by
$$0.65 < \vert ( 1 / Rcf - 1 / Rcr ) / ( 1 / Ryf - 1 / Ryr ) \vert < 1.35 . \qquad ( 34 )$$

34. An imaging apparatus comprising:
the imaging lens according to claim 1.
